(19) United States
(12) Patent Application Publication
(10) Pub. No.: US 2006/0194071 A1
(43) Pub. Date: Aug. 31, 2006

(54) Developer carrying member and development apparatus

(75) Inventors: Tetsuya Yano, Atsugi-shi (JP); Takashi Kenmoku, Fujisawa-shi (JP); Chieko Mihara, Isehara-shi (JP); Tatsuki Fukui, Yokohama-shi (JP); Ako Kusakari, Atsugi-shi (JP); Norikazu Fujimoto, Susono-shi (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 11/165,356

(22) Filed: Jun. 24, 2005

(30) Foreign Application Priority Data
Jun. 25, 2004 (JP) 2004-188893

(51) Int. Cl. B32B 27/36; G03G 15/06

(52) U.S. Cl. 428/480; 399/222

(57) ABSTRACT

A developer carrying member which prevents toner from being excessively charged in a development apparatus and maintains a high charge quantity of toner, and which is difficult to cause deposition of toner thereto, and a development apparatus equipped with the developer carrying member are provided. A resin layer containing, as a binder, a resin containing polyhydroxyalkanoate having in the molecule at least one hydroxyalkanoic acid unit including sulfonic acid or a derivative thereof or carboxylic acid or a derivative thereof is formed on a substrate or on the surface of the substrate of the developer carrying member.

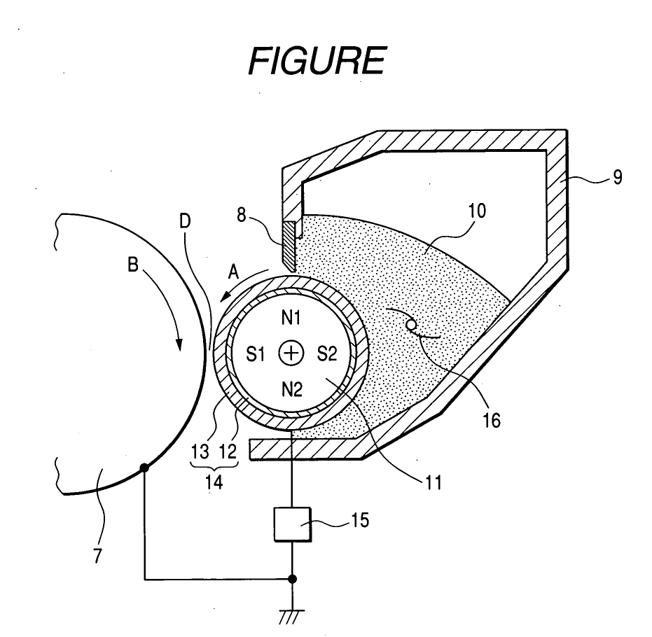

### BACKGROUND OF THE INVENTION

1. Field of the Invention

The present invention relates to a development apparatus and a developer carrying member for use in visualizing an image by developing a latent image formed on an electrostatic latent image bearing member by use of a developer and used in electrophotography, electrostatic recording and magnetic recording and the like.

2. Related Background Art

Recently, biodegradable polymer materials have been widely used as medical materials and environmentally friendly materials and in drug delivery systems. In addition to these, a new function has been further required for such a biodegradable polymer material in recent days, and various studies have been conducted for this purpose.

In particular, a polyhydroxyalkanoate, typically represented by polylactic acid, has been studied for introducing a functional group acceptable for chemical modification into its molecule. There have been some reports on the cases where a carboxyl group and a vinyl group are introduced into chemical compounds.

As a polyhydroxyalkanoate having a carboxyl group in a side chain, polymalic acid is known. The polymers of polymalic acid are known to be classified into α-type and β-type depending upon the polymerization manner. The α-type polymers contain a unit represented by the formula (14): 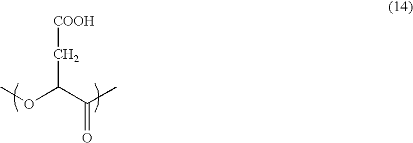
whereas, β-type polymers contain a unit represented by the formula (15):

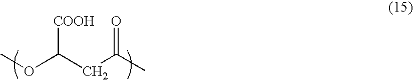

Of them, a β-type polymalic acid and its copolymers are disclosed in U.S. Pat. No. 4,265,247, which discloses a polymer formed by ring opening polymerization of a benzyl ester of β-malolactone represented by the formula (16): 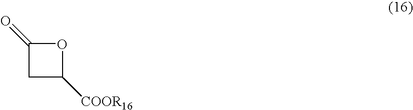
wherein R₁₆ is a benzyl group.

Furthermore, an α-type polymalic acid/glycolic acid copolymer and other copolymers containing a hydroxyalkanoic acid including glycolic acid are disclosed in Japanese Patent Application Laid-Open No. H02-003415, which discloses polymers formed by copolymerization of a six-membered ring diester monomer represented by the formula (17): 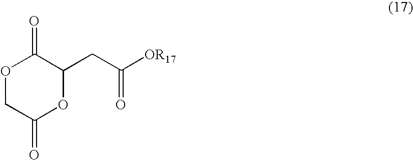
wherein R₁₇ is a lower alkyl group such as a methyl group, ethyl group, n-propyl group, isopropyl group, and t-butyl group, and a benzyl group, and a lactone, which is an ester formed by an intramolecular ring-closing reaction of glycolid, lactide, which are cyclic diesters, and ω-hydroxycarboxylic acid.

Furthermore, Macromolecules 2000, 33(13), 4619 discloses a polyhydroxyalkanoate having a carboxyl group in a side chain. The document discloses that 7-oxo-4-oxepan-carboxylic acid ester is subjected to ring-opening polymerization to produce a polymer having an ester group in a side chain, and that the polymer thus obtained is further subjected to hydrogenolysis to obtain a polymer having a carboxylic acid in a side chain.

As a polyhydroxyalkanoate having a vinyl group in a side chain, Polymeric Materials Science & Engineering 2002, 87, 254 discloses a polymer formed by subjecting α-allyl (δ-valerolactone) to ring opening polymerization.

Similarly, as a polyhydroxyalkanoate having a vinyl group in a side chain, Polymer Preprints 2002, 43(2), 727 discloses a polymer formed by ring-opening polymerization of 3,6-diallyl-1,4-dioxane-2,5-dione, which is a six-membered ring diester monomer.

As exemplified above, some reports inform polymers having new functions applied by introducing a structure for imparting functionality to a polyhydroxyalkanoate into which a functional group acceptable for chemical modification has been introduced. In International Journal of Biological Macromolecules 25 (1999) 265, it is reported that a cyclic dimmer of α-malic acid and glycolic acid are subjected to ring-opening polymerization to obtain a copolymer of α-malic acid and glycolic acid, and the resultant polymer is deprotected to obtain a polyester having a carboxyl group in a side chain, and that when the carboxyl group in a side chain is chemically modified with a tripeptide and the resultant polymer is evaluated for cell adhesion property, good results are obtained.

Among conventional development apparatuses for visualizing an electrostatic latent image, which is formed on the surface of a photosensitive drum serving as an electrostatic latent image bearing member, by use of toner, which is an one-component developer, there is an apparatus for visualizing an electrostatic latent image formed on a photosensitive drum as a toner image by applying positive or negative charge to toner particles by means of friction between adjacent toner particles, friction between a developing sleeve serving as a developer carrying member, and toner particles and friction between a member (developer layer thickness regulating member) for regulating the amount of toner applied onto the developing sleeve and toner particles, and the like, applying the toner thus charged onto the developing sleeve to form an extremely thin layer, transporting the toner to a developing region at which the photosensitive drum and the developing sleeve face each other, and allowing the toner to scatter and attach onto the electrostatic latent image formed on the photosensitive drum surface in the developing region.

A developer carrying member used in the conventional development apparatus as mentioned above is formed by, molding, for example, a metal, an alloy or a metal compound into a cylindrical form and processing the surface of the cylindrical form by means of electrolysis, a blast or a file until a predetermined surface roughness is obtained. On the other hand, lately, to realize fixation of a developer at low temperature required form an energy-saving point of view and formation of a high-definition image, toner particles reduced in diameter have been desired. However, in such a toner particle reduced in diameter, the surface area for each unit weight increases and thus the surface charge is likely to increase, causing a so-called charge-up phenomenon. Due to this phenomenon, toner is tightly adhered onto the developer carrying member, with the result that a developer newly supplied onto the developer carrying member is not easily charged, charging developer particles nonuniformly in amount. To deal with this, in other words, to prevent excessive charging of a developer and tight adhesion of a developer onto a developer carrying member, Japanese Patent Application Laid-Open No. H01-277256 proposes a method of forming, on a developer carrying member, a film (resin layer) of a resin composition containing powder of a conductive substance such as carbon and graphite, a solid lubricant and the like dispersed in a resin. Furthermore, Japanese Patent Application Laid-Open No. H02-304468 proposes a developing sleeve, which is formed by providing a conductive resin layer, which contains fine conductive powder of a solid lubricant and carbon and further spherical particles dispersed in a resin-coating layer, on a metal substrate. Moreover, Japanese Patent Application Laid-Open No. H08-240981 proposes a developing sleeve, which is further improved in abrasion resistance by using conductive spherical particles as the spherical particles to be dispersed in the conductive coating layer, and stabilized in the shape of the surface of the developing sleeve, and simultaneously further improved in chargeability of toner. The developing sleeve further has the surface layer capable of suppressing staining the sleeve with toner and melt-adhesion of toner to the sleeve even when the resin layer serving as the conductive coating layer is slightly worn out.

### SUMMARY OF THE INVENTION

The present invention provides a developer carrying member capable of preventing excessive charging of toner taking place in a development apparatus, holding a charge amount of toner at a high level and suppressing melt-adhesion of toner thereto, and also provides a development apparatus having such a developer carrying member. The present invention further provides a developer carrying member capable of suppressing nonuniform charging of toner on a developer carrying member surface in the case where small-diameter toner particles are used, thereby applying a proper amount of charge to toner, and provide a development apparatus having such a developer carrying member.

More specifically, the present invention is concerned with a developer carrying member for use in a development apparatus which develops a latent image formed on an electrostatic latent image bearing member by means of a developer carried and transported by the developer carrying member, thereby visualizing the latent image. The developer carrying member is characterized by comprising at least a substrate and a resin layer formed on the surface of the substrate, and the resin layer employing a binder resin containing a polyhydroxyalkanoate which is characterized by containing, per molecule, at least one unit represented either by the formula (1): 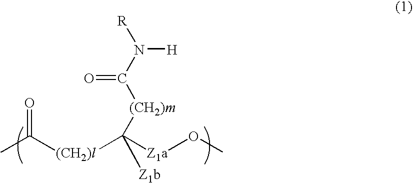
wherein
R represents -A₁-SO₂R₁,
R₁ represents OH, a halogen atom, ONa, OK or OR₁ₐ,
R₁ₐ and A₁ independently represent a group having a substituted or unsubstituted aliphatic hydrocarbon structure, a substituted or unsubstituted aromatic ring structure or a substituted or unsubstituted heterocyclic structure; and
wherein, with respect to l, m, Z₁a and Z₁b,
where l is an integer selected from 2 to 4, nothing is selected as Z₁a or Z₁a is a linear alkylene chain having 1 to 4 carbon atoms, Z₁b is a hydrogen atom, and m is an integer selected from 0 to 8,
where l is 1 and Z₁a is a linear alkylene chain having 1 to 4 carbon atoms, Z₁b is a hydrogen atom, and m is an integer selected from 0 to 8,
where l is 1, and nothing is selected as Z₁a, Z₁b is a hydrogen atom, and m is 0,
where l is 0, Z₁a is a linear alkylene chain having 1 to 4 carbon atoms, the linear alkylene chain may be substituted with a linear or branched alkyl group or with an alkyl group containing a residue having any one of a phenyl structure, a thienyl structure and a cyclohexyl structure at the end, Z₁b is a hydrogen atom or a linear or branched alkyl group, aryl group or aralkyl group that may be substituted with an aryl group, and m is an integer selected from 0 to 8,
where l is 0 and nothing is selected as Z₁a, Z₁b is a hydrogen atom or a linear or branched alkyl group, aryl group or aralkyl group that may be substituted with an aryl group, and m is an integer selected from 0 to 8, and
where a plurality of units are present, R, R₁, R₁ₐ, A₁, Z₁a, Z₁b, l and m independently represent the same as mentioned above for each unit,
or by the formula (5): 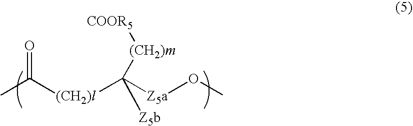
wherein
R₅ represents hydrogen, a group forming a salt, or R₅ₐ, and R₅ₐ represents a linear or branched alkyl group having 1 to 12 carbon atoms or aralkyl group; and wherein, with respect to l, m, Z₅a and Z₅b,
where l is an integer selected from 2 to 4, nothing is selected as Z₅a or Z₅a is a linear alkylene chain having 1 to 4 carbon atoms, Z₅b is a hydrogen atom, and m is an integer selected from 0 to 8,
where l is 1 and Z₅a is a linear alkylene chain having 1 to 4 carbon atoms, Z₅b is a hydrogen atom, and m is an integer selected from 0 to 8,
where l is 1 and nothing is selected as Z₅a, Z₅b is a hydrogen atom, and m is 0,
where l is 0 and Z₅a is a linear alkylene chain having 1 to 4 carbon atoms, the linear alkylene chain may be substituted with a linear or branched alkyl group or with an alkyl group containing a residue having any one of a phenyl structure, a thienyl structure, and a cyclohexyl structure at the end, Z₅b is a hydrogen atom or a linear or branched alkyl group, aryl group or aralkyl group that may be substituted with an aryl group, and m is an integer selected from 0 to 8,
where l is 0 and nothing is selected as Z₅a, Z₅b is a hydrogen atom or a linear or branched alkyl group, aryl group or aralkyl group that may be substituted with an aryl group, and m is an integer selected from 0 to 8, and
where a plurality of units are present, R₅, R₅ₐ, Z₅a, Z₅b, l and m independently represent the same as mentioned above for each unit.

Furthermore, the present invention is directed to a development apparatus for visualizing a latent image by placing a developer contained in a developer container on a developer carrying member, transporting the developer to a development region facing to a latent image bearing member while forming a thin layer of the developer on the developer carrying member by a developer layer thickness regulating member, and developing the latent image on the latent image bearing member by the developer in the developing region. The development apparatus mentioned is characterized in that the developer carrying member is used.

As is explained above, according to the present invention, there is provided a developer carrying member improved in durability compared to a conventional developer carrying member and capable of maintaining a state where a good-quality image can be provided for a long time. Furthermore, according to the present invention, there is provided a developer carrying member stabilizing the properties for positively charging toner, forming a uniform layer of the developer on the developer carrying member, and having a high durability.

### BRIEF DESCRIPTION OF THE DRAWINGS

FIGURE is a sectional view showing a development apparatus using a developer carrying member according to the present invention.

### DESCRIPTION OF THE PREFERRED EMBODIMENTS

The present invention will be now explained in more detail by way of preferable embodiments. The present inventors have intensively studied with a view to solve conventional problems as mentioned above. As a result, they found that a developer carrying member, which is capable of quickly charging a developer and keeping the charge at a high level; nevertheless, rarely staining a developing sleeve with toner, obtaining a large charge amount even in a high humid environment, and causing no excessive charging even in a low humid environment, can be obtained by adding, to a binder resin constituting a resin layer formed on the surface of the developer carrying member, a polyhydroxyalkanoate which is characterized by containing, per molecule, at least one unit represented either by the formula (1): 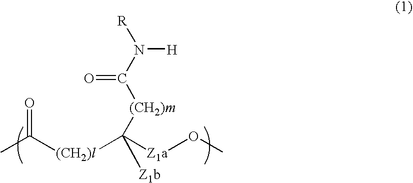
wherein
R represents -A₁-SO₂R₁, R₁ represents OH, a halogen atom, ONa, OK or OR₁ₐ,
R₁ₐ and A₁ independently represent a group having a substituted or unsubstituted aliphatic hydrocarbon structure, a substituted or unsubstituted aromatic ring structure, or a substituted or unsubstituted heterocyclic structure; and
wherein, with respect to l, m, Z₁ₐ and Z_{1b},
where l is an integer selected from 2 to 4, nothing is selected as Z₁ₐ or Z₁ₐ is a linear alkylene chain having 1 to 4 carbon atoms, Z_{1b} is a hydrogen atom, and m is an integer selected from 0 to 8,
where l is 1 and Z₁ₐ is a linear alkylene chain having 1 to 4 carbon atoms, Z_{1b} is a hydrogen atom, and m is an integer selected from 0 to 8,
where l is 1, and nothing is selected as Z₁ₐ, Z_{1b} is a hydrogen atom, and m is 0,
where l is 0, Z₁ₐ is a linear alkylene chain having 1 to 4 carbon atoms, the linear alkylene chain may be substituted with a linear or branched alkyl group or with an alkyl group containing a residue having any one of a phenyl structure, a thienyl structure and a cyclohexyl structure at the end, Z_{1b} is a hydrogen atom or a linear or branched alkyl group, aryl group or aralkyl group that may be substituted with an aryl group, and m is an integer selected from 0 to 8,
where l is 0 and nothing is selected as Z₁ₐ, Z_{1b} is a hydrogen atom or a linear or branched alkyl group, aryl group or aralkyl group that may be substituted with an aryl group, and m is an integer selected from 0 to 8, and
where a plurality of units are present, R, R₁, R₁ₐ, A₁, Z₁ₐ, Z_{1b}, l and m independently represent the same as mentioned above for each unit, or by the formula (5): 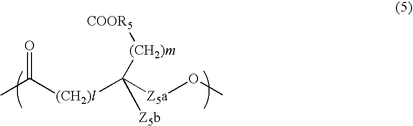
wherein
R₅ represents hydrogen, a group forming a salt, or R₅ₐ, and R₅ₐ represents a linear or branched alkyl group having 1 to 12 carbon atoms or aralkyl group; and wherein, with respect to l, m, Z₅ₐ and Z_{5b},
where l is an integer selected from 2 to 4, nothing is selected as Z₅ₐ or Z₅ₐ is a linear alkylene chain having 1 to 4 carbon atoms, Z_{5b} is a hydrogen atom, and m is an integer selected from 0 to 8,
where l is 1 and Z₅ₐ is a linear alkylene chain having 1 to 4 carbon atoms, Z_{5b} is a hydrogen atom, and m is an integer selected from 0 to 8,
where l is 1 and nothing is selected as Z₅ₐ, Z_{5b} is a hydrogen atom, and m is 0,
where l is 0 and Z₅ₐ is a linear alkylene chain having 1 to 4 carbon atoms, the linear alkylene chain may be substituted with a linear or branched alkyl group or with an alkyl group containing a residue having any one of a phenyl structure, a thienyl structure, and a cyclohexyl structure at the end, Z_{5b} is a hydrogen atom or a linear or branched alkyl group, aryl group or aralkyl group that may be substituted with an aryl group, and m is an integer selected from 0 to 8,
where l is 0 and nothing is selected as Z₅ₐ, Z_{5b} is a hydrogen atom or a linear or branched alkyl group, aryl group or aralkyl group that may be substituted with an aryl group, and m is an integer selected from 0 to 8, and
where a plurality of units are present, R₅, R₅ₐ, Z₅ₐ, Z_{5b}, l and m independently represent the same as mentioned above for each unit. Based on the finding, the present invention was accomplished.

A polyhydroxyalkanoate used in the present invention has a basic skeleton of a biodegradable resin. Because of this, a polyhydroxyalkanoate has distinctively excellent characteristics in that it is applicable to production of various products by the same means of fusion processing and the like as in conventional plastics, and in that it is decomposed by a living organism unlike synthetic polymers derived from petroleum, and becomes part of the substance recycling system of the natural world. Since no combustion treatment is required, a polyhydroxyalkanoate is a very useful plastic material in view of preventing air pollution and global-warming as well as contributing to preservation of the environment.

A polyhydroxyalkanoate, directed by the present invention, containing at least one unit represented by the formula (1), per molecule, is produced by the reaction between a starting polyhydroxyalkanoate containing a unit represented by the formula (11) and at least one type of aminosulfonic acid compound represented by the formula (13). 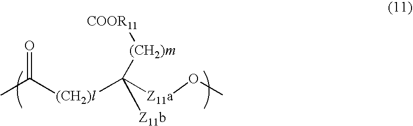
wherein R₁₁ represents hydrogen or a group forming a salt; and
wherein, with respect to l, m, Z₁₁a and Z₁₁b,
where l is an integer selected from 2 to 4, nothing is selected as Z₁₁a or Z₁₁a is a linear alkylene chain having 1 to 4 carbon atoms, Z₁₁b is a hydrogen atom, and m is an integer selected from 0 to 8,
where l is 1 and Z₁₁a is a linear alkylene chain having 1 to 4 carbon atoms, Z₁₁b is a hydrogen atom, and m is an integer selected from 0 to 8,
where l is 1, and nothing is selected as Z₁₁a, Z₁₁b is a hydrogen atom, and m is 0,
where l is 0, Z₁₁a is a linear alkylene chain having 1 to 4 carbon atoms, the linear alkylene chain may be substituted with a linear or branched alkyl group or with an alkyl group containing a residue having any one of a phenyl structure, a thienyl structure and a cyclohexyl structure at the end, Z₁₁b is a hydrogen atom or a linear or branched alkyl group, aryl group or aralkyl group that may be substituted with an aryl group, and m is an integer selected from 0 to 8,
where l is 0 and nothing is selected as Z₁₁a, Z₁₁b is a hydrogen atom or a linear or branched alkyl group, aryl group or aralkyl group that may be substituted with an aryl group, and m is an integer selected from 0 to 8, and
where a plurality of units are present, R11, Z₁₁a, Z₁₁b, l and m independently represent the same as mentioned above for each unit.

More particularly, in a compound represented by the formula (11) for use in the present invention, where l is 0 and Z₁₁a is a linear alkylene chain having 1 to 4 carbon atoms, the linear alkylene chain may be substituted with a linear or branched alkyl group or with an alkyl group containing a residue having any one of a phenyl structure, a thienyl structure and a cyclohexyl structure at the end. For example, mention may be made of a substituted or unsubstituted cyclohexyl structure, a substituted or unsubstituted phenyl structure, substituted or unsubstituted phenoxy structure, substituted or unsubstituted benzoyl structure, substituted or unsubstituted phenylsulfanyl structure, substituted or unsubstituted phenylsulfinyl structure, substituted or unsubstituted phenylsulfonyl structure, substituted or unsubstituted (phenylmethyl)sulfanyl structure, (phenylmethyl)oxy structure, 2-thienyl structure, 2-thienyl sulfanyl structure, and 2-thienylcarbonyl structure.

In a compound represented by the formula (11) for use in the present invention, where l is 0, Z₁₁b is a hydrogen atom or a linear or branched alkyl group, aryl group or aralkyl group that may be substituted with an aryl group. Examples of such a linear or branched alkyl group include a methyl group, ethyl group, propyl group, isopropyl group (2-methylpropyl group), butyl group, 1-methylpropyl group, pentyl group, isopropyl group (3-methylbutyl group), hexyl group, isohexyl group (4-methylpentyl group), and heptyl group. Examples of the aryl group include a phenyl group and methylphenyl group. Examples of the aralkyl group include a phenylmethyl group (benzyl group), phenylethyl group, phenylpropyl group, phenylbutyl group, phenylpentyl group, and methylbenzyl group. In the present invention, in consideration of productivity of a polymer synthesized, Z₁₁b is preferably a methyl group, ethyl group, propyl group, isopropyl group, pentyl group, hexyl group, phenyl group, or phenylmethyl group.
H₂N-A₃-SO₂R₁₃ (13)
wherein R₁₃ is OH, a halogen atom, ONa, OK or OR₁₃ₐ; R₁₃ₐ and A₃ are selected from a substituted or unsubstituted aliphatic hydrocarbon structure, a substituted or unsubstituted aromatic ring structure and a substituted or unsubstituted heterocyclic structure; in the case where a plurality of types of compounds are used together, R₁₃, R₁₃ₐ and A₃ independently represent the same as mentioned above for each compound; More specifically, R₁₃ is OH, a halogen atom, ONa, OK or OR₁₃ₐ; and R₁₃ₐ is a linear or branched alkyl group having 1 to 8 carbon atoms or a substituted or unsubstituted phenyl group.

A₃ represents a linear or branched substituted or unsubstituted alkylene group having 1 to 8 carbon atoms, a substituted or unsubstituted phenylene group, a substituted or unsubstituted naphthalene group or a substituted or unsubstituted heterocyclic structure containing at least one of N, S, and O; when A₃ has a ring structure, an unsubstituted ring may be further condensed. Where a plurality of types of compounds are used together, R₁₃, R₁₃ₐ and A₃ independently represents the same as mentioned above for each compound.

Where A₃ is a straight substituted or unsubstituted alkylene group, a compound represented by the following formula (18) may be mentioned.
H₂N-A₄-SO₂R₁₈ (18)
wherein R₁₈ is OH, a halogen atom, ONa, OK or OR₁₈ₐ; R₁₈ₐ is selected from a linear or branched alkyl group having 1 to 8 carbon atoms or a substituted or unsubstituted phenyl group; A₄ is a linear or branched substituted or unsubstituted alkylene group having 1 to 8 carbon atoms, and may be substituted with an alkyl group or alkoxy group having 1 to 20 carbon atoms; and where a plurality of types of compounds are used together, R₁₈, R₁₈ₐ and A₄ independently represent the same as mentioned above for each compound.

Examples of a compound represented by the formula (18) include 2-aminoethanesulfonic acid (taurine), 3-aminopropanesulfonic acid, 4-aminobutane sulfonic acid, 2-amino-2-methylpropanesulfonic acid, alkaline metal salts and esterified compounds thereof.

A compound represented by the formula (18) is reacted with a polyhydroxyalkanoate containing a unit represented by the formula (11) to produce a polyhydroxyalkanoate containing at least one unit represented by the formula (2) per molecule. 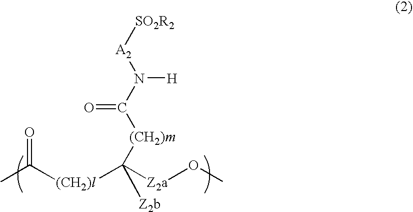
wherein
R₂ is OH, a halogen atom, ONa, OK or OR₂a,
R₂a represents a linear or branched alkyl group having 1 to 8 carbon atoms or a substituted or unsubstituted phenyl group,
A₂ is a linear or branched alkylene group having 1 to 8 carbon atoms; and
wherein, with respect to l, m, Z₂a and Z₂b,
where l is an integer selected from 2 to 4, nothing is selected as Z₂a or Z₂a is a linear alkylene chain having 1 to 4 carbon atoms, Z₂b is a hydrogen atom, and m is an integer selected from 0 to 8,
where l is 1 and Z₂a is a linear alkylene chain having 1 to 4 carbon atoms, Z₂b is a hydrogen atom, and m is an integer selected from 0 to 8,
where l is 1 and nothing is selected as Z₂a, Z₂b is a hydrogen atom, and m is 0,
where l is 0 and Z₂a is a linear alkylene chain having 1 to 4 carbon atoms, the linear alkylene chain may be substituted with a linear or branched alkyl group or with an alkyl group containing a residue having any one of a phenyl structure, a thienyl structure and a cyclohexyl structure at the end, Z₂b is a hydrogen atom or a linear or branched alkyl group, aryl group or aralkyl group that may be substituted with an aryl group, and m is an integer selected from 0 to 8,
where l is 0 and nothing is selected as Z₂a, Z₂b is a hydrogen atom or a linear or branched alkyl group, aryl group or aralkyl group that may be substituted with an aryl group, and m is an integer selected from 0 to 8, and
where a plurality of units are present, R₂, R₂a, A₂, Z₂a, Z₂b, l and m independently represent the same as mentioned above for each unit.

In the case A₃ is a substituted or unsubstituted phenylene group, a compound represented by the formula (19) below may be mentioned. 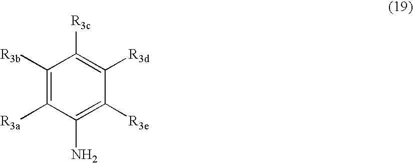
wherein R₃ₐ, R_{3b}, R_{3c}, R_{3d} and R₃ₑ independently represent SO₂R₃f, wherein R_{3f} is OH, a halogen atom, ONa, OK or OR_{3f1}; and R_{3f1} is a linear or branched alkyl group having 1 to 8 carbon atoms or a substituted or unsubstituted phenyl group, hydrogen atom, halogen atom, alkyl group having 1 to 20 carbon atoms, alkoxy group having 1 to 20 carbon atoms, an OH group, an NH₂ group, an NO₂ group, COOR_{3g}, wherein R_{3g} represents any one of an H atom, an Na atom and a K atom, an acetoamide group, an OPh group, an NHPh group, a CF₃ group, a C₂F₅ group or a C₃F₇ group; at least one of these groups is SO₂R_{3f}; and
where a plurality of types of compounds are used together, R₃ₐ, R_{3b}, R_{3c}, R_{3d}, R₃ₑ R_{3f}, R_{3f1} and R_{3g} independently represent the same as mentioned above for each compound.

Examples of a compound represented by the formula (19) include p-aminobenzenesulfonic acid (sulfanyl acid), m-aminobenzenesulfonic acid, o-aminobenzenesulfonic acid, m-toluidine-4-sulfonic acid, sodium o-toluidine-4-sulfonate, p-toluidine-2-sulfonic acid, 4-methoxyaniline-2-sulfonic acid, o-anisidine-5-sulfonic acid, p-anisidine-3-sulfonic acid, 3-nitroaniline-4-sulfonic acid, a sodium salt of 2-nitroaniline-4-sulfonic acid, sodium 4-nitroaniline-2-sulfonate, 1,5-dinitroaniline-4-sulfonic acid, 2-aminophenol-4-hydroxy-5-nitrobenzenesulfonic acid, sodium 2,4-dimethylaniline-5-sulfonate, 2,4-dimethylaniline-6-sulfonic acid, 3,4-dimethylaniline-5-sulfonic acid, 4-isopropylaniline-6-sulfonic acid, 4-trifluoromethylaniline-6-sulfonic acid, 3-carboxy-4-hydroxyaniline-5-sulfonic acid, 4-carboxyaniline-6-sulfonic acid, alkaline salts and esters thereof.

A polyhydroxyalkanoate containing at least one unit represented by the formula (3) per molecule is produced by the reaction of a compound represented by the formula (19) with a polyhydroxyalkanoate containing a unit represented by the formula (11). 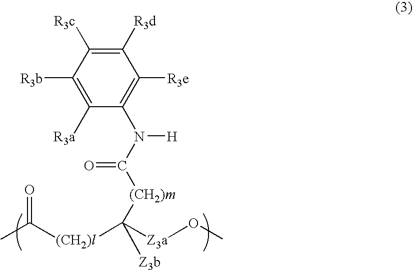
wherein at least one of R₃a, R₃b, R₃c, R₃d and R₃e represents SO₂R₃f, wherein R₃f is OH, a halogen atom, ONa, OK or OR₃f₁, and R₃f₁ is a linear or branched alkyl group having 1 to 8 carbon atoms or a substituted or unsubstituted phenyl group, and the others independently represent a hydrogen atom, a halogen atom, an alkyl group having 1 to 20 carbon atoms, an alkoxy group having 1 to 20 carbon atoms, an OH group, an NH₂ group, an NO₂ group, COOR₃g, wherein R₃g represents an H atom, an Na atom and a K atom, an acetoamide group, an OPh group, an NHPh group, a CF₃ group, a C₂F₅ group or a C₃F₇ group; and wherein, with respect to l, m, Z₃a and Z₃b,
where l is an integer selected from 2 to 4, nothing is selected as Z₃a or Z₃a is a linear alkylene chain having 1 to 4 carbon atoms, Z₃b is a hydrogen atom, and m is an integer selected from 0 to 8,
where l is 1 and Z₃a is a linear alkylene chain having 1 to 4 carbon atoms, Z₃b is a hydrogen atom, and m is an integer selected from 0 to 8,
where l is 1 and nothing is selected as Z₃a, Z₃b is a hydrogen atom and m is 0,
where l is 0, Z₃a is a linear alkylene chain having 1 to 4 carbon atoms, the linear alkylene chain may be substituted with a linear or branched alkyl group or with an alkyl group containing a residue having any one of a phenyl structure, a thienyl structure and a cyclohexyl structure at the end, Z₃b is a hydrogen atom or a linear or branched alkyl group, aryl group or aralkyl group that may be substituted with an aryl group, and m is an integer selected from 0 to 8,
where l is 0 and nothing is selected as Z₃a, Z₃b is a hydrogen atom or a linear or branched alkyl group, aryl group or aralkyl group that may be substituted with an aryl group, and m is an integer selected from 0 to 8, and
where a plurality of units are present, R₃a, R₃b, R₃c, R₃d, R₃e, R₃f, R₃f₁, R₃g, Z₃a, Z₃b, l and m independently represent the same as mentioned above for each unit.

In the case where A₃ is a substituted or unsubstituted naphthalene group, a compound represented by the formula (20A) or (20B) below may be mentioned. 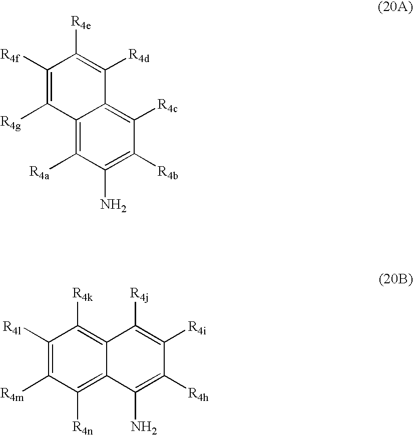
wherein R₄ₐ, R_{4b}, R_{4c}, R_{4d}, R₄ₑ, R_{4f} and R_{4g} in the formula (20A); and R₄ₕ, R₄ᵢ, R₄ⱼ, R₄ₖ R₄ₗ, R₄ₘ and R₄ₙ in the formula (20B) independently represent SO₂R₄ₒ, wherein R₄ₒ is OH, a halogen atom, ONa, OK, or OR₄ₒ₁; and OR₄ₒ₁ is a linear or branched alkyl group having 1 to 8 carbon atoms or a substituted or unsubstituted phenyl group, a hydrogen atom, a halogen atom, an alkyl group having 1 to 20 carbon atoms, an alkoxy group having 1 to 20 carbon atoms, an OH group, an NH₂ group, an NO₂ group, COOR₄ₚ, wherein R₄ₚ represents any one of an H atom, an Na atom and a K atom, an acetoamide group, an OPh group, an NHPh group, a CF₃ group, a C₂F₅ group or a C₃F₇ group; and
wherein at least one of R₄ₐ, R_{4b}, R_{4c}, R_{4d}, R₄ₑ, R_{4f} and R_{4g} in the formula. (20A), is SO₂R₄ₒ, and at least one of R₄ₕ, R₄ᵢ, R₄ⱼ, R₄ₖ R₄ₗ, R₄ₘ and R₄ₙ in the formula (20B) is SO₂R₄ₒ. When a plurality of types of compounds are used together, R₄ₐ, R_{4b}, R_{4c}, R_{4d}, R₄ₑ, R_{4f}, R_{4g}, R₄ₕ, R₄ᵢ, R₄ⱼ, R₄ₖ R₄ₗ, R₄ₘ, R₄ₙ, R₄ₒ, R₄ₒ₁, R₄ₚ and m independently represent the same as mentioned above for each compound. Examples of a compound represented by the formula (20A) or (20B) include sulfonic acids, alkaline metal salts or esters thereof, such as 1-naphthylamine-5-sulfonic acid, 1-naphthylamine-4-sulfonic acid, 1-naphthylamine-8-sulfonic acid, 2-naphthylamine-5-sulfonic acid, 1-naphthylamine-6-sulfonic acid, 1-naphthylamine-7-sulfonic acid, 1-naphthylamine-2-ethoxy-6-sulfonic acid, 1-amino-2-naphthol-4-sulfonic acid, 6-amino-1-naphthol-3-sulfonic acid, sodium 1-amino-8-naphthol-2,4-sulfonate, and sodium 1-amino-8-naphthol-3,6-sulfonate.

A polyhydroxyalkanoate containing at least one unit represented by the formula (4A) per molecule is produced by the reaction of a compound represented by the formula (20A) with a polyhydroxyalkanoate containing a unit represented by the formula (11). 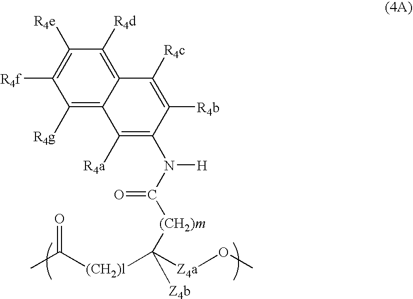
wherein at least one of R₄a, R₄b, R₄c, R₄d, R₄e R₄f, and R₄g represents SO₂R₄o, wherein R₄o is OH, a halogen atom, ONa, OK or OR₄o₁; and R₄o₁ is a linear or branched alkyl group having 1 to 8 carbon atoms or a substituted or unsubstituted phenyl group, and the others independently represent a hydrogen atom, a halogen atom, an alkyl group having 1 to 20 carbon atoms, an alkoxy group having 1 to 20 carbon atoms, an OH group, an NH₂ group, an NO₂ group, COOR₄p, wherein R₄p represents an H atom, an Na atom and a K atom, an acetoamide group, an OPh group, an NHPh group, a CF₃ group, a C₂F₅ group or a C₃F₇ group; wherein, with respect to l, m, Z₄a and Z₄b,
where l is an integer selected from 2 to 4, nothing is selected as Z₄a or Z₄a is a linear alkylene chain having 1 to 4 carbon atoms, Z₄b is a hydrogen atom, and m is an integer selected from 0 to 8,
where l is 1 and Z₄a is a linear alkylene chain having 1 to 4 carbon atoms, Z₄b is a hydrogen atom and m is an integer selected from O to 8,
where l is 1 and nothing is selected as Z₄a, Z₄b is a hydrogen atom and m is 0,
where l is 0 and Z₄a is a linear alkylene chain having 1 to 4 carbon atoms, the linear alkylene chain may be substituted with a linear or branched alkyl group or with an alkyl group containing a residue having any one of a phenyl structure, a thienyl structure and a cyclohexyl structure at the end, Z₄b is a hydrogen atom or a linear or branched alkyl group, aryl group or aralkyl group that may be substituted with an aryl group, and m is an integer selected from 0 to 8,
where l is 0 and nothing is selected as Z₄a, Z₄b is a hydrogen atom or a linear or branched alkyl group, aryl group or aralkyl group that may be substituted with an aryl group, and m is an integer selected from 0 to 8, and
where a plurality of units are present, R₄a, R₄b, R₄c, R₄d, R₄e, R₄f, R₄g, R₄o, OR₄o₁, R₄p, Z₄a, Z₄b, l and m independently represent the same as mentioned above for each unit.

A polyhydroxyalkanoate containing at least one unit represented by the formula (4B) per molecule is produced by the reaction of a compound represented by the formula (20B) with a polyhydroxyalkanoate containing a unit represented by the formula (11). 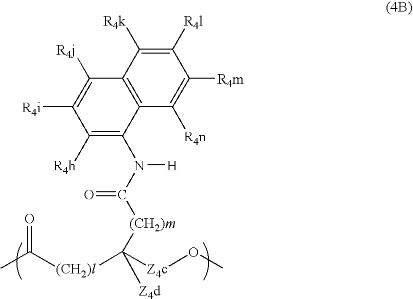
wherein at least one of R₄h, R₄i, R₄j, R₄k, R₄l, R₄m, and R₄n represents SO₂R₄o, wherein R₄o is OH, a halogen atom, ONa, OK or OR₄o1; and R₄o1 is a linear or branched alkyl group having 1 to 8 carbon atoms or a substituted or unsubstituted phenyl group, and the others independently represent a hydrogen atom, a halogen atom, an alkyl group having 1 to 20 carbon atoms, an alkoxy group having 1 to 20 carbon atoms, an OH group, an NH₂ group, an NO₂ group, COOR₄p, wherein R₄p represents an H atom, Na atom and K atom, an acetoamide group, an OPh group, an NHPh group, a CF₃ group, a C₂F₅ group or a C₃F₇ group;
wherein, with respect to l, m, Z₄c and Z₄d,
where l is an integer selected from 2 to 4, nothing is selected as Z₄c or Z₄c is a linear alkylene chain having 1 to 4 carbon atoms, Z₄d is a hydrogen atom, and m is an integer selected from 0 to 8,
where l is 1 and Z₄c is a linear alkylene chain having 1 to 4 carbon atoms, Z₄d is a hydrogen atom, and m is an integer selected from 0 to 8,
where l is 1 and nothing is selected as Z₄c, Z₄d is a hydrogen atom and m is 0,
where l is 0 and Z₄c is a linear alkylene chain having 1 to 4 carbon atoms, the linear alkylene chain may be substituted with a linear or branched alkyl group or with an alkyl group containing a residue having any one of a phenyl structure, a thienyl structure and a cyclohexyl structure at the end, Z₄d is a hydrogen atom or a linear or branched alkyl group, aryl group or aralkyl group that may be substituted with an aryl group, and m is an integer selected from 0 to 8,
where l is 0 and nothing is selected as Z₄c, Z₄d is a hydrogen atom or a linear or branched alkyl group, aryl group or aralkyl group that may be substituted with an aryl group, and m is an integer selected from 0 to 8, and
where a plurality of units are present, R₄h, R₄i, R₄j, R₄k, R₄l, R₄m, and R₄n, R₄o, OR₄o1, R₄p, Z₄c, Z₄d, l and m independently represent the same as mentioned above for each unit.

A polyhydroxyalkanoate containing at least one unit represented by the formula (1) per molecule as an object of the present invention may be a polyhydroxyalkanoate containing at least one set of at least two types units selected from units represented by the formulas (2), (3), (4A) and (4B) per molecule.

In the case where A₃ is a substituted or unsubstituted heterocyclic structure containing at least one of N, S and O, the heterocyclic ring may be any one of a pyridine ring, piperazine ring, furan ring, and thiol ring. Examples of the compound include sulfonic acids such as 2-aminopyridine-6-sulfonic acid, and 2-aminopiperazine-6-sulfonic acid, alkaline metal salts and esters (sulfonates) thereof.

Examples of such sulfonates include substituted or unsubstituted aliphatic hydrocarbon structure, substituted or unsubstituted aromatic ring structure, and substituted or unsubstituted heterocyclic structure. In particular, a linear or branched alkyl group having 1 to 8 carbon atoms and substituted or unsubstituted phenyl group are preferable. In view of easiness of esterification, OCH₃, OC₂H₅, OC₆H₅, OC₃H₇, OC₄H₉, OCH(CH₃)₂, OCH₂C(CH₃)₃, and OC(CH₃)₃ are further preferable.

(Method of Producing Polyhydroxyalkanoate Containing at Least One Unit Represented by the Formula (1) Per Molecule)

Now, the reaction between a polyhydroxyalkanoate containing a unit represented by the formula (11) and an aminosulfonic acid compound represented by the formula (13), according to the present invention will be described in more detail below.

The amount of a compound represented by the formula (13) used in the present invention falls within the range of 0.1 to 50.0 folds by mole relative to a unit represented by the formula (11) of a substance used as a starting material, and preferably within the range of 1.0 to 20.0 folds by mole.

As a method for producing an amide bond from a carboxylic acid and an amine, according to the present invention, a condensation reaction due to thermal dehydration may be mentioned. To perform the reaction in mild conditions so as not to cleave an ester bond of a main polymer chain, an effective method comprises activating a carboxylic acid moiety by an activation agent to form an active acyl intermediate, followed by reacting with an amine. Examples of the activated acyl intermediate include an acid halide, acid anhydride, and activated ester. In particular, a method of forming an amide bond in one step by use of a condensing agent is preferable in view of simplifying a production process.

If necessary, the condensation reaction with an amine may be performed after an acid halide compound is isolated.

Examples of the condensing agent used herein include a phosphoric acid based condensing agent for use in polycondensation of aromatic polyamide, carbodiimide based condensing agent for use in peptide synthesis, and acid chloride based condensing agent. A condensing agent may be appropriately selected depending upon a combination of a compound represented by the formula (13) and a unit represented by the formula (11).

Examples of phosphoric acid based condensing agents include a phosphite based condensing agent, phosphorus chloride based condensing agent, phosphoric acid anhydride based condensing agent, phosphoric ester based condensing agent, and phosphoric amide based condensing agent.

In the reaction of the present invention, a condensing agent such as a phosphite can be used. Examples of the phosphite used herein include triphenyl phosphite, diphenyl phosphite, tri-o-tolyl phosphite, di-o-tolyl phosphite, tri-m-tolyl phosphite, di-m-tolyl phosphate, tri-p-tolyl phosphite, di-p-tolyl phosphite, di-o-chlorophenyl phosphite, tri-o-chlorophenyl phosphite, di-p-chlorophenyl phosphite, trimethyl phosphate, and triethyl phosphite. Of them, triphenyl phosphite is preferably used. To improve solubility and reactivity of a polymer, a metal salt such as lithium chloride and calcium chloride may be added.

Examples of a carbodiimide based condensing agent include dicyclohexylcarbodiimide (DCC), N-ethyl-N′-3-dimethylaminopropylcarbodiimide (EDC=WACI), and diisopropylcarbodiimide (DIPC). DCC or WACI may be used in combination with N-hydroxysuccinimide (HONSu), 1-hydroxybenzotriazol (HOBt), 3-hydroxy-4-oxo-3,4-dihydro-1,2,3-benzotriazine (HOObt), or the like.

The amount of a condensing agent falls within the range of 0.1 to 50 folds by mole, preferable within the range of 1 to 20 folds by mole relative to that of a unit represented by the formula (11).

In a reaction according to the present invention, a solvent may be used if necessary. Examples of the solvent used herein include hydrocarbons such as hexane, cyclohexane and heptane; ketones such as acetone and methyl ethyl ketone; ethers such as dimethyl ether, diethyl ether, and tetrahydrofuran; halogenated hydrocarbons such as dichloromethane, chloroform, carbon tetrachloride, dichloroethane, and trichloroethane; aromatic hydrocarbons such as benzene and toluene; aprotonic polar solvents such as N,N-dimethylformamide, dimethylsulfoxide, dimethylacetoamide, and hexamethylphosphoramide; pyridine derivatives such as pyridine and picoline; and N-methylpyrrolidone. Particularly preferably, pyridine, N-methylpyrrolidone or the like is used. The amount of the solvent used herein may be appropriately determined depending upon types of a starting material and a base, and reaction conditions, etc.

In a method according to the present invention, reaction temperature is not particularly limited; however, usually falls within the range of −20° C. to a boiling point of a solvent. However, the reaction is desirably performed at an optimal temperature suitable for the condensing agent to be used.

In a method according to the present invention, reaction time usually falls within the range from 1 to 48 hours, and particularly preferably, from 1 to 10 hours.

In the present invention, a reaction solution containing a polyhydroxyalkanoate containing at least one unit represented by the formula (1) thus generated, per molecule, can be purified by customary method, e.g., vaporization. Alternatively, the target polyhydroxyalkanoate containing at least one unit represented by the formula (1) per molecule can be recovered by mixing the reaction solution with a homogeneous solvent in which the target polyhydroxyalkanoate is insoluble such as water; an alcohol such as methanol or ethanol; or an ether such as dimethyl ether, diethyl ether, or tetrahydrofuran, thereby reprecipitating the target polyhydroxyalkanoate. The target polyhydroxyalkanoate thus recovered can be isolated and purified, if necessary. The isolation and purification method to be used herein is not particularly limited. For example, use may be made of a reprecipitation method using a solvent incapable of dissolving the polyhydroxyalkanoate containing at least one unit represented by the formula (1) per molecule, a column chromatographic method, and dialysis method.

According to the present invention, there is another production method. In the case where the R moiety of the formula (1) is -A₁-SO₃CH₃, a condensation reaction is performed with an amine and thereafter, methyl esterification of the R moiety of -A₁-SO₃CH₃ may be performed by use of a methyl esterification agent. As a methyl esterification method, use may be made of a methyl esterification method for an aliphatic acid employed in gas chromatographic analysis.

Besides this, a method of using an acid catalyst, such as a hydrochloric acid-methanol method, boron trifluoride-methanol method, and sulfuric acid-methanol method, and a method using a base catalyst such as a sodium methoxide method, tetramethylguanidine method and trimethylsilyldiazomethan method may be mentioned. Of them, trimethylsilyldiazomethane method is preferable since methylation can be performed in mild conditions.

Examples of the solvent to be used in a reaction of the present invention include hydrocarbons such as hexane, cyclohexane, and heptane; alcohols such as methanol and ethanol, halogenated hydrocarbons such as dichloromethane, chloroform, carbon tetrachloride, dichloroethane, and trichloroethane; and aromatic hydrocarbons such as benzene and toluene. In particular, a halogenated hydrocarbon may be preferably used. The amount of the solvent used herein may be appropriately determined depending upon the starting material and reaction conditions. In a method according to the present invention, reaction temperature is not particularly limited; however usually falls within the range of −20 to 30° C. However, it is desirable that the reaction may be performed at an optimal temperature suitable for the condensing agent and reagents to be used.

In the present invention, a polyhydroxyalkanoate containing a unit represented by the formula (H) can be produced by the steps of reacting a polyhydroxyalkanoate having a unit represented by the formula (G) with a base, and reacting the compound obtained in the previous step with a compound represented by the formula (E). 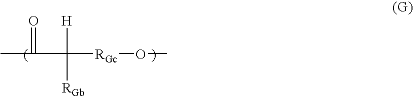
wherein R_{Gc} is a linear alkylene chain having 0 to 4 carbon atoms;
where the linear alkylene chain has 1 to 4 carbon atoms, it may be arbitrarily substituted with a linear or branched alkyl group or an alkyl group having a residue having any one of structures including a phenyl structure, thienyl structure and cyclohexyl structure at the end; R_{Gb} is a hydrogen atom or a linear or branched alkyl group, aryl group or aralkyl group that may be substituted with an aryl group; and where a plurality of units are present, R_{Gb} and R_{Gc} independently represent the same as mentioned above for each unit.

More specifically, in the polyhydroxyalkanoate comprising a unit of substituted hydroxyl acid represented by the formula (G), used in the present invention, where R_{Gc} is a linear alkylene chain having 1 to 4 carbon atoms, the linear alkylene chain may be substituted with a linear or branched alkyl group or an alkyl group having a residue having any one of structures including a phenyl structure, thienyl structure and cyclohexyl structure at the end.

Specific examples include a substituted or unsubstituted cyclohexyl structure, a substituted or unsubstituted phenyl structure, substituted or unsubstituted phenoxy structure, substituted or unsubstituted benzoyl structure, substituted or unsubstituted phenylsulfanyl structure, substituted or unsubstituted phenylsulfinyl structure, substituted or unsubstituted phenylsulfonyl structure, substituted or unsubstituted (phenylmethyl)sulfanyl structure, (phenylmethyl)oxy structure, 2-thienyl structure, 2-thienyl sulfanyl structure, and 2-thienylcarbonyl structure. Furthermore, R_{Gb} is a hydrogen atom or a linear or branched alkyl group, aryl group or aralkyl group that may be substituted with an aryl group. Examples of such a linear or branched alkyl group include a methyl group, ethyl group, propyl group, isopropyl group (2-methylpropyl group), butyl group, 1-methylpropyl group, pentyl group, isopropyl group (3-methylbutyl group), hexyl group, isohexyl group (4-methylpentyl group), and heptyl group. Examples of the aryl group include a phenyl group and methylphenyl group. Examples of the aralkyl group include a phenylmethyl group (benzyl group), phenylethyl group, phenylpropyl group, phenylbutyl group, phenylpentyl group, and methylbenzyl group. In the present invention, in consideration of productivity of polymer synthesis, R_{Gb} is preferably a methyl group, ethyl group, propyl group, isopropyl group, pentyl group, hexyl group, phenyl group, or phenylmethyl group. 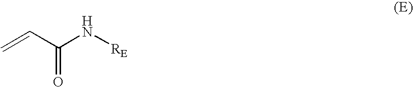
wherein R_{E} represents -A_{E}-SO₂R_{E1} and R_{E1} represents OH, a halogen atom, ONa, OK or OR_{Ea}; R_{Ea} and A_{E} are independently selected from the groups consisting of groups having a substituted or unsubstituted aliphatic hydrocarbon structure, a substituted or unsubstituted aromatic ring structure, or a substituted or unsubstituted heterocyclic structure; and where a plurality of units are present, R_{E}, R_{E1}, R_{Ea}, and A_{E}, independently represent the same as mentioned above for each unit. 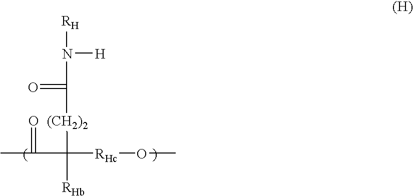
wherein R_{H} represents -A_{H}-SO₂R_{H1}; R_{H1} represents OH, a halogen atom, ONa, OK or OR_{Ha}, R_{Ha} and A_{H} independently represent a group having a substituted or unsubstituted aliphatic hydrocarbon structure, a substituted or unsubstituted aromatic ring structure, or a substituted or unsubstituted heterocyclic structure;
R_{HC} is a linear alkylene chain having 0 to 4 carbon atoms,
where the linear alkylene chain has 1 to 4 carbon atoms, the linear alkylene chain may be substituted with a linear or branched alkyl group or an alkyl group having a residue having any one of structures including a phenyl structure, thienyl structure and cyclohexyl structure at the end;
Furthermore, R_{Hb} is a hydrogen atom or a linear or branched alkyl group, aryl group or aralkyl group that may be substituted with an aryl group; and where a plurality of units are present, R_{H} R_{H1}, R_{Ha}, R_{Hb}, R_{Hc}, and A_{H}, independently represent the same as mentioned above for each unit.

For example, when a polyhydroxyalkanoate having a unit represented by the formula (F) corresponding to the case of the formula (H) where the linear alkylene chain of R_{HC} is not substituted and R_{Hb} is a hydrogen atom, can be produced by the steps of reacting a starting polyhydroxyalkanoate having a unit represented by the formula (A) with a base and reacting the compound obtained in the previous step with a compound represented by the formula (E). 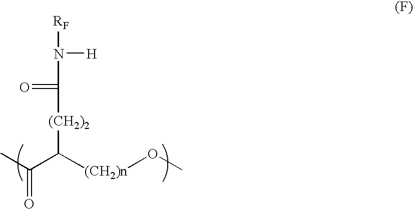
wherein n is an integer selected from 0 to 4; R_{F} represents -A_{F}-SO₂R_{F1}; R_{F1} represents OH, a halogen atom, ONa, OK or OR_{Fa};
R_{Fa} and A_{F} independently represent a group having a substituted or unsubstituted aliphatic hydrocarbon structure, a substituted or unsubstituted aromatic ring structure, or a substituted or unsubstituted heterocyclic structure; and
where a plurality of units are present, R_{F}, R_{F1}, R_{Fa}, A_{F}, and n independently represent the same as mentioned above for each unit. 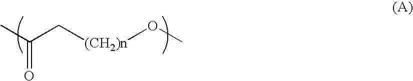
wherein n is an integer selected from 0 to 4; and where a plurality of units are present, n represents the same as mentioned above, each independently for each unit. 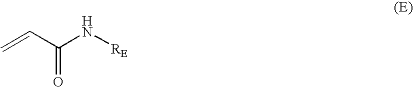
wherein R_{E} represents -A_{E}-SO₂R_{E1}; R_{E1} represents OH, a halogen atom, ONa, OK or OR_{Ea}; R_{Ea} and A_{E} are each independently selected from the groups having a substituted or unsubstituted aliphatic hydrocarbon structure, a substituted or unsubstituted aromatic ring structure, and a substituted or unsubstituted heterocyclic structure; and where a plurality of units are present, R_{E}, R_{E1}, R_{Ea}, A_{E}, and n independently represent the same as mentioned above for each unit.

Examples of a compound represented by the formula (E) include 2-acrylamide-2-methylpropanesulfonic acid and alkali metal salts and ester compounds thereof.

The reaction between a polyhydroxyalkanoate containing a unit represented by the formula (A) and a compound represented by the formula (E) will be described more specifically.

The present invention can be attained by adding a compound represented by the formula (E) to an α-methylene group located next to a carbonyl group in the backbone of a polymer in accordance with the Michael addition reaction. More specifically, the present invention can be attained by reacting, under the reaction conditions of the Michael addition reaction, a polyhydroxyalkanoate containing a unit represented by the formula (A) with a base capable of forming an α-methylene group in the form of an anion, next to a carbonyl group in the polymer backbone of the polyhydroxyalkanoate containing a unit represented by the formula (A) and subsequently reacting the α-methylene group with a compound represented by the formula (E). Furthermore, in the present invention, the amount of a compound represented by the formula (E) used herein is 0.001 to 100 folds by mole, preferably 0.01 to 10 folds by mole relative to that of a unit represented by the formula (A).

The solvent to be used in a reaction according to the present invention is not particularly limited. Any solvent may be used as long as the solvent is non-reactive to the reaction and dissolves a starting material to some extent. Examples of such a solvent include aliphatic hydrocarbons such as hexane, cyclohexane, heptane, ligroin, and petroleum ether; aromatic hydrocarbons such as benzene, toluene and xylene; ethers such as diethyl ether, diisopropyl ether, tetrahydrofuran, dioxane, and dimethoxyethane and diethylene glycol dimethyl ether; and amides such as formamide, N,N-dimethylformamide, N,N′-dimethylacetoamide, N-methyl-2-pyrrolidone, N-methyl pyrrolidinone, and hexamethylphosphorotriamide. Of them, tetrahydrofuran is preferably used.

The reaction is performed in the presence of a base. Example of the base used herein include alkyl lithiums such as methyl lithium and butyl lithium; alkali metal disilazides such as lithium hexamethyl disilazide, sodium hexamethyl disilazide, and potassium hexamethyl disilazide, lithium amides such as lithium diisopropyl amide and lithium dicyclohexyl amide. Of them, lithium diisopropyl amide is preferably used. The amount of a base used in the present invention is 0.001 to 100 folds by mole, preferably 0.01 to 10 folds by mole, relative to that of a unit represented by the formula (A).

In the method of the present invention, reaction temperature is usually −78° C. to 40° C., and preferably −78° C. to 30° C.

In the method of the present invention, reaction time usually falls within the range of 10 minutes to 24 hours, and particularly preferably, 10 minutes to 4 hours.

In a polyhydroxyalkanoate represented by the formula (5) in the present invention, a polyhydroxyalkanoate represented by the formula (21) is produced by oxidizing a double bond moiety of a side chain of a starting polyhydroxyalkanoate represented by the formula (6). 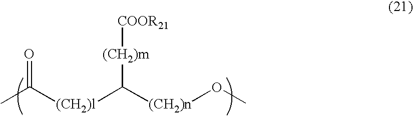
wherein R₂₁ represents hydrogen or a group forming a salt; and
wherein, with respect to l, m and n;
where l is an integer selected from 0 and 2 to 4 and n is an integer selected from 0 to 4, m is an integer selected from 0 to 8;
where l is 1 and n is an integer selected from 1 to ⁴, m is an integer selected from 0 to 8;
and
where a plurality of units are present, R₂₁, l, m, and n independently represent the same as mentioned above for each unit. 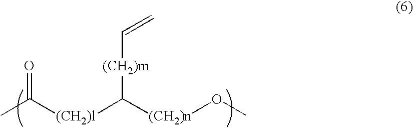
wherein, with respect to l, m and n,
where l is an integer selected from 0 and 2 to 4 and n is an integer selected from 0 to 4, m is an integer selected from 0 to 8,
where l is 1 and n is an integer selected from 1 to 4, m is an integer selected from 0 to 8; and
where a plurality of units are present, l, m, and n independently represent the same as mentioned above for each unit.

Examples of a known method for obtaining carboxylic acid by oxidatively cleaving a carbon-carbon double bond as mentioned above by an oxidizing agent include a method using a permanganate (J. Chem. Soc., Perkin. Trans. 1, 806 (1973)); a method using a dichromate (Org. Synth., 4, 698 (1963); a method using periodate (J. Org. Chem., 46, 19 (1981); and a method using nitric acid (Japanese Patent Application Laid-Open No. S59-190945; and a method using ozone (J. Am. Chem. Soc., 81, 4273 (1959). Furthermore, (Macromolecular chemistry, 4, 289-293 (2001)) reports a method of obtaining carboxylic acid by performing a reaction for cleaving a carbon-carbon double bond at an end of a side chain of a polyhydroxyalkanoate microbiologically produced by use of potassium permanganate as an oxidative agent under acidic conditions. The same method may be used in the present invention.

As a permanganate to be used as an oxidative agent, potassium permanganate is generally used. As the amount of the permanganate used herein, generally one mole equivalent or more, and preferably 2 to 10 mole equivalents relative to one mole of a unit represented by the formula (b) may be used since the oxidative cleavage reaction is a chemical stoichiometry one.

To perform the reaction under acidic conditions, various types pf inorganic and organic acids including sulfuric acid, hydrochloric acid, acetic acid and nitric acid are usually used. However, when an acid such as sulfuric acid, nitric acid or hydrochloric acid is used, an ester bond of a backbone is cleaved, with the result that a molecular weight may possibly decrease. For this reason, acetic acid is preferably used. The amount of the acid used herein usually fall within the range of 0.2 to 2000 mole equivalents, preferably 0.04 to 1000 mole equivalents, relative to a mole of a unit represented by the formula (6). When the amount is less than 0.2 mole equivalents, the resultant yield becomes low; on the other hand, when the amount exceeds 2000 mole equivalents, a side product due to acid decomposition is generated. Either case is not preferable. To facilitate the reaction, a crown ether may be used. This case is effective since the crown ether and a permanganate produce a complex, increasing the reactivity. General examples of such a crown ether include dibenzo-18-crown-6-ether, dicyclo-18-crown-6-ether, and 18-crowm-6-ether. The amount of the crown-ether used herein desirably falls usually within the range of 0.005 to 2.0 mole equivalents, and preferably 0.01 to 1.5 mole equivalents relative to one mole of a permanganate.

A solvent used in the oxidation reaction of the present invention is not particularly limited as long as it is an inert solvent. Example of such a solvent include water, acetone; ethers such as tetrahydrofuran, dioxane; aromatic hydrocarbons such as benzene; aliphatic hydrocarbons such as hexane and heptane; and halogenated hydrocarbons such as methyl chloride, dichloromethane, and chloroform. Of them, halogenated hydrocarbons such as methyl chloride, dichloromethane, and chloroform, and acetone are preferable in consideration of solubility of polyhydroxyalkanoate.

In the oxidation reaction of the present invention, a polyhydroxyalkanoate containing a unit represented by the formula (6), a permanganate, and an acid may be collectively added to a reaction system with a solvent in the beginning to react them, or they may be added successively or intermittently to a reaction system to react them. Alternatively, a permanganate is previously dissolved or suspended in a solvent, and subsequently, and a polyhydroxyalkanoate and an acid may be successively or intermittently added to a reaction system to react them. Or otherwise, a polyhydroxyalkanoate alone is previously dissolved or suspended in a solvent, and subsequently, a permanganate and an acid may be successively or intermittently added to the reaction system to react them. Furthermore, a polyhydroxyalkanoate and an acid are added to a reaction system and subsequently, and a permanganate may be successively and intermittently added in the reaction system to react them; a permanganate and an acid are previously added to a reaction system and a polyhydroxyalkanoate may be successively and intermittently added to the reaction system to react them; or a polyhydroxyalkanoate and a permanganate are previously added to a reaction system and an acid may be successively and intermittently added to the reaction system to react them.

The reaction temperature is generally set at −40 to 40° C., and preferably at −10 to 30° C. The reaction time varies depending upon a stoichiometric ratio of a unit represented by the formula (6) to a permanganate and the reaction temperature; however, it is preferable to generally set at 2 to 48 hours.

In a polyhydroxyalkanoate containing at least one unit represented by the formula (5) per molecule, a polyhydroxyalkanoate containing at least one unit represented by the formula (11) per molecule is produced either by hydrolysis of a side chain ester moiety of a starting polyhydroxyalkanoate containing at least one unit represented by the formula (23) per molecule, in the presence of an acid or an alkali or by a hydrogenolysis method including catalytic reduction. 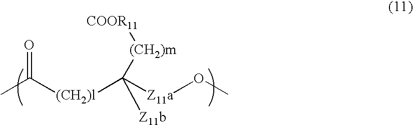
wherein R₁₁ represents hydrogen or a group forming a salt; and
wherein, with respect to l, m, Z₁₁a and Z₁₁b,
where l is an integer selected from 2 to 4, nothing is selected as Z₁₁a, or Z₁₁a is a linear alkylene chain having 1 to 4 carbon atoms, Z₁₁b is a hydrogen atom, and m is an integer selected from 0 to 8;
where l is 1, and Z₁₁a is a linear alkylene chain having 1 to 4 carbon atoms, Z₁₁b is a hydrogen atom and m is an integer selected from 0 to 8;
where l is 1 and nothing is selected as Z₁₁a, Z₁₁b is a hydrogen atom and m is 0;
where l is 0 and Z₁₁a is a linear alkylene chain having 1 to 4 carbon atoms, the linear alkylene chain may be substituted with a linear or branched alkyl group or with an alkyl group containing a residue having any one of a phenyl structure, a thienyl structure and a cyclohexyl structure at the end, Z₁₁b is a hydrogen atom or a linear or branched alkyl group, aryl group or aralkyl group that may be substituted with an aryl group, and m is an integer selected from 0 to 8;
where l is 0 and nothing is selected as Z₁₁a, Z₁₁b is a hydrogen atom or a linear or branched alkyl group, aryl group or aralkyl group that may be substituted with an aryl group, and m is an integer selected from 0 to 8; and
where a plurality of units are present, R₁₁, Z₁₁a, Z₁₁b, l and m independently represent the same as mentioned above for each unit. 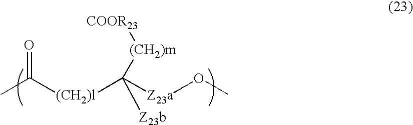
wherein R₂₃ is a linear or branched alkyl group having 1 to 12 carbon atoms or aralkyl group; and
wherein, with respect to l, m, Z₂₃a and Z₂₃b,
where l is an integer selected from 2 to 4, nothing is selected as Z₂₃a, or Z₂₃a is a linear alkylene chain having 1 to 4 carbon atoms, Z₂₃b is a hydrogen atom, and m is an integer selected from 0 to 8;
where l is 1, and Z₂₃a is a linear alkylene chain having 1 to 4 carbon atoms, Z₂₃b is a hydrogen atom, and m is an integer selected from 0 to 8;
where l is 1 and nothing is selected as Z₂₃a, Z₂₃b is a hydrogen atom and m is 0;
where l is 0 and Z₂₃a is a linear alkylene chain having 1 to 4 carbon atoms, the linear alkylene chain may be substituted with a linear or branched alkyl group or with an alkyl group containing a residue having any one of a phenyl structure, a thienyl structure and a cyclohexyl structure at the end, Z₂₃b is a hydrogen atom or a linear or branched alkyl group, aryl group or aralkyl-group that may be substituted with an aryl group, and m is an integer selected from 0 to 8;
where l is 0 and nothing is selected as Z₂₃a, Z₂₃b is a hydrogen atom or a linear or branched alkyl group, aryl group or aralkyl group that may be substituted with an aryl group, and m is an integer selected from 0 to 8; and
where a plurality of units are present, R₂₃, Z₂₃a, Z₂₃b, l and m independently represent the same as mentioned above for each unit.

To explain more specifically, in a compound represented by the formula (23) for use in the present invention, where l is 0 and Z₂₃a is a linear alkylene chain having 1 to 4 carbon atoms, the linear alkylene chain may be substituted with a linear or branched alkyl group or with an alkyl group containing a residue having any one of a phenyl structure, a thienyl structure and a cyclohexyl structure at the end. Specific examples include a substituted or unsubstituted cyclohexyl structure, a substituted or unsubstituted phenyl structure, substituted or unsubstituted phenoxy structure, substituted or unsubstituted benzoyl structure, substituted or unsubstituted phenylsulfanyl structure, substituted or unsubstituted phenylsulfinyl structure, substituted or unsubstituted phenylsulfonyl structure, substituted or unsubstituted (phenylmethyl)sulfanyl structure, (phenylmethyl)oxy structure, 2-thienyl structure, 2-thienyl sulfanyl structure, and 2-thienylcarbonyl structure. Furthermore, in a compound represented by the formula (23) for use in the present invention, where l is 0, Z₂₃b is a hydrogen atom or a linear or branched alkyl group, aryl group or aralkyl group that may be substituted with an aryl group. Specific examples of such a linear or branched alkyl group include a methyl group, ethyl group, propyl group, isopropyl group (2-methylpropyl group), butyl group, 1-methylpropyl group, pentyl group, isopropyl group (3-methylbutyl group), hexyl group, isohexyl group (4-methylpentyl group), and heptyl group. Examples of the aryl group include a phenyl group and methylphenyl group. Examples of the aralkyl group include a phenylmethyl group (benzyl group), phenylethyl group, phenylpropyl group, phenylbutyl group, phenylpentyl group, and methylbenzyl group. In the present invention, in consideration of productivity of polymer synthesis, Z₂₃b is preferably a methyl group, ethyl group, propyl group, isopropyl group, pentyl group, hexyl group, phenyl group, or phenylmethyl group.

In the case of a hydrolysis method in the presence of an acid or an alkali, hydrolysis may be performed in an aqueous solution, or a solvent such as a hydrophilic organic solvent, for example, methanol, ethanol, tetrahydrofuran, dioxane, dimethylformamide, or dimethyl sulfoxide, by using an aqueous solution of an inorganic acid such as hydrochloric acid, sulfuric acid, nitric acid or phosphoric acid; an organic acid such as trifluoroacetate, trichloroacetate, p-toluene sulfonate, or methane sulfonate; an aqueous caustic alkali such as sodium hydroxide, or potassium hydroxide; an aqueous solution of an alkali carbonate such as sodium carbonate or potassium carbonate; or an alcohol solution of a metal alkoxide such as sodium methoxide or sodium ethoxide. The reaction temperature may be set at generally 0 to 40° C. and preferably 0 to 30° C. The reaction time may be set at generally 0.5 to 48 hours. Note that when hydrolysis is performed by use of an acid or an alkali, a case where an ester bond of a backbone is cleaved, leading to a reduction of a molecular weight, is often observed.

When a carboxylic acid is obtained by use of a hydrogenolysis method including catalytic reduction, the hydrogenolysis method is performed as follows. First, catalytic reduction is performed in an appropriate solvent at a temperature from −20° C. to a boiling point of the solvent used, preferably at a temperature within 0 to 50° C., in the presence of a reducing catalyst, by applying hydrogen under normal pressure or under increased pressure. Examples of the solvent to be used include water, methanol, ethanol, propanol, hexafluoroisopropanol, ethyl acetate, diethyl ether, tetrahydrofuran, dioxane, benzene, toluene, dimethylformamide, pyridine, and N-methylpyrrolidone. Alternatively, these may be used in the form of admixture. Examples of the reducing catalyst include palladium, platinum, and rhodium, each being used singly or in the immobilized form on a carrier, and Raney nickel. The reaction time is preferably set at generally 0.5 to 72 hours. A reaction solution containing a polyhydroxyalkanoate containing at least one unit represented by the formula (11) per molecule thus produced is filtrated to remove the catalyst and then the solvent is removed by distillation or the like to recover a polymer in crude form. The obtained polyhydroxyalkanoate containing at least one unit represented by the formula (11) per molecule may be isolated and purified if necessary. Examples of a method of isolating and purifying the polyhydroxyalkanoate include, but not particularly limited to, a reprecipitation method using a solvent incapable of dissolving a polyhydroxyalkanoate containing at least one unit represented by the formula (11) per molecule, a column chromatographic method, and a dialysis method. However, even in the case where a catalytic reduction is used, an ester bond of the backbone may also be possibly cleaved. Therefore, in some cases, reduction of a molecular weight may be observed.

In a polyhydroxyalkanoate containing at least one unit represented by the formula (5) per molecule, a polyhydroxyalkanoate containing at least one unit represented by the formula (23) per molecule is produced by esterifying a starting polyhydroxyalkanoate containing at least one unit represented by the formula (11) per molecule by an esterification agent. 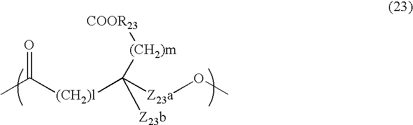
wherein R₂₃ is a linear or branched alkyl group having 1 to 12 carbon atoms or aralkyl group;
wherein, with respect to l, m, Z₂₃a and Z₂₃b,
where l is an integer selected from 2 to 4, nothing is selected as Z₂₃a, or Z₂₃a is a linear alkylene chain having 1 to 4 carbon atoms, Z₂₃b is a hydrogen atom, and m is an integer selected from 0 to 8;
where l is 1, and Z₂₃a is a linear alkylene chain having 1 to 4 carbon atoms, Z₂₃b is a hydrogen atom, and m is an integer selected from 0 to 8;
where l is 1 and nothing is selected as Z₂₃a, Z₂₃b is a hydrogen atom and m is 0;
where l is 0 and Z₂₃a is a linear alkylene chain having 1 to 4 carbon atoms, the linear alkylene chain may be substituted with a linear or branched alkyl group or with an alkyl group containing a residue having any one of a phenyl structure, a thienyl structure and a cyclohexyl structure at the end, Z₂₃b is a hydrogen atom or a linear or branched alkyl group, aryl group or aralkyl group that may be substituted with an aryl group, and m is an integer selected from 0 to 8;
where l is 0 and nothing is selected as Z₂₃a, Z₂₃b is a hydrogen atom or a linear or branched alkyl group, aryl group or aralkyl group that may be substituted with an aryl group, and m is an integer selected from 0 to 8; and
where a plurality of units are present, R₂₃, Z₂₃a, Z₂₃b, l and m independently represent the same as mentioned above for each unit. 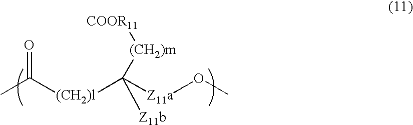
wherein R₁₁ represents hydrogen or a group forming a salt; and
wherein, with respect to l, m, Z₁₁a and Z₁₁b,
where l is an integer selected from 2 to 4, nothing is selected as Z₁₁a, or Z₁₁a is a linear alkylene chain having 1 to 4 carbon atoms, Z₁₁b is a hydrogen atom; m is an integer selected from 0 to 8;
where l is 1, and Z₁₁a is a linear alkylene chain having 1 to 4 carbon atoms, Z₁₁b is a hydrogen atom and m is an integer selected from 0 to 8;
where l is 1 and nothing is selected as Z₁₁a, Z₁₁b is a hydrogen atom and m is 0;
where l is 0 and Z₁₁a is a linear alkylene chain having 1 to 4 carbon atoms, the linear alkylene chain may be substituted with a linear or branched alkyl group or with an alkyl group containing a residue having any one of a phenyl structure, a thienyl structure and a cyclohexyl structure at the end, Z₁₁b is a hydrogen atom or a linear or branched alkyl group, aryl group or aralkyl group that may be substituted with an aryl group, and m is an integer selected from 0 to 8;
where l is 0 and nothing is selected as Z₁₁a, Z₁₁b is a hydrogen atom or a linear or branched alkyl group, aryl group or aralkyl group that may be substituted with an aryl group, and m is an integer selected from 0 to 8; and
where a plurality of units are present, R₁₁, Z₁₁a, Z₁₁b, l and m independently represent the same as mentioned above for each unit.

To explain more specifically, in a compound represented by the formula (11) for use in the present invention, where l is 0 and Z₁₁a is a linear alkylene chain having 1 to 4 carbon atoms, the linear alkylene chain may be substituted with a linear or branched alkyl group or with an alkyl group containing a residue having any one of a phenyl structure, a thienyl structure and a cyclohexyl structure at the end. Specific examples include a substituted or unsubstituted cyclohexyl structure, a substituted or unsubstituted phenyl structure, substituted or unsubstituted phenoxy structure, substituted or unsubstituted benzoyl structure, substituted or unsubstituted phenylsulfanyl structure, substituted or unsubstituted phenylsulfinyl structure, substituted or unsubstituted phenylsulfonyl structure, substituted or unsubstituted (phenylmethyl)sulfanyl structure, (phenylmethyl)oxy structure, 2-thienyl structure, 2-thienyl sulfanyl structure, and 2-thienylcarbonyl structure. Furthermore, in a compound represented by the formula (11) for use in the present invention, where l is 0, Z₁₁b is a hydrogen atom or a linear or branched alkyl group, aryl group or aralkyl group that may be substituted with an aryl group. Specific examples of such a linear or branched alkyl group include a methyl group, ethyl group, propyl group, isopropyl group (2-methylpropyl group), butyl group, 1-methylpropyl group, pentyl group, isopropyl group (3-methylbutyl group), hexyl group, isohexyl group (4-methylpentyl group), and heptyl group. Examples of the aryl group include a phenyl group and methylphenyl group. Examples of the aralkyl group include a phenylmethyl group (benzyl group), phenylethyl group, phenylpropyl group, phenylbutyl group, phenylpentyl group, and methylbenzyl group. In the present invention, in consideration of productivity of polymer synthesis, Z₁₁b is preferably a methyl group, ethyl group, propyl group, isopropyl group, pentyl group, hexyl group, phenyl group, or phenylmethyl group.

As the esterification agent to be used, diazomethane and a DMF dialkyl acetal may be used. Examples of such diazomethane and a DMF dialkylacetal include trimethylsilyldiazomethane, DMF dimethyl acetal, DMF diethyl acetal, DMF dipropyl acetal, DMF diisopropyl acetal, DMF-n-butyl acetal, DMF-tert-butyl acetal, and DMF dineopentyl acetal, which are readily react with a target compound and provide its ester. A polyhydroalkanoate can be esterified by a reaction with, for example, an alcohol such as methanol, ethanol, propanol, isopropyl alcohol, butyl alcohol, sec-butyl alcohol, tert-butyl alcohol, pentyl alcohol, neopentyl alcohol, hexyl alcohol, heptyl alcohol, octyl alcohol, nonyl alcohol, decyl alcohol, or lauryl alcohol; or a sugar such as D-glucose, D-fructose, or any other sugar, by use of an acid catalyst or a condensing agent such as DCC.

In the present invention, a polyhydroxyalkanoate containing a unit represented by the formula (J) can be obtained by the steps of reacting a polyhydroxyalkanoate having a unit represented by the formula (G) with a base and reacting the compound obtained in the previous step with a compound represented by the formula (K). 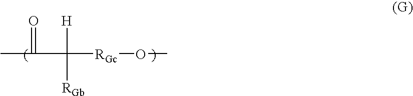
wherein R_{Gc} is a linear alkylene chain having 0 to 4 carbon atoms; where the linear alkylene chain is one having 1 to 4 carbon atoms, it may be arbitrarily substituted with a linear or branched alkyl group or an alkyl group having a residue having any one of structures including a phenyl structure, thienyl structure and cyclohexyl structure at the end; R_{Gb} is a hydrogen atom or a linear or branched alkyl group, aryl group or aralkyl group that may be substituted with an aryl group; where a plurality of units are present, R_{Gb} and R_{Gc} independently represent the same as mentioned above for each unit.
X(CH₂)mCOOR_{K} (K)
where m is an integer selected from 0 to 8; X is a halogen atom; and Rₖ is a linear or branched alkyl group or aralkyl group having 1 to 12 carbon atoms. 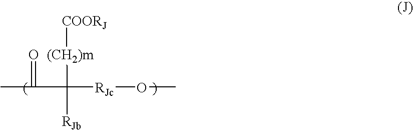
where m is an integer selected from 0 to 8; R_{J} is a linear or branched alkyl group having 1 to 12 carbon atoms or an aralkyl group; R_{Jc} is an linear alkylene chain having 0 to 4 carbon atoms; where the linear alkylene chain has 1 to 4 carbon atoms, the linear alkylene chain may be arbitrarily substituted with a linear or branched alkyl group or an alkyl group having a residue having any one of structures including a phenyl structure, thienyl structure and cyclohexyl structure at the end; R_{Jb} is a hydrogen atom or a linear or branched alkyl group, aryl group or aralkyl group that may be substituted with an aryl group; and where a plurality of units are present, R_{J}, R_{Jb}, R_{Jc} and m independently represent the same as mentioned above for each unit.

More specifically, in a compound represented by the formula (G) for use in the present invention, where R_{Gc} is a linear alkylene chain having 1 to 4 carbon atoms, it may be arbitrarily substituted with a linear or branched alkyl group or an alkyl group having a residue having any one of structures including a phenyl structure, thienyl structure and cyclohexyl structure at the end. Specific examples include a substituted or unsubstituted cyclohexyl structure, a substituted or unsubstituted phenyl structure, substituted or unsubstituted phenoxy structure, substituted or unsubstituted benzoyl structure, substituted or unsubstituted phenylsulfanyl structure, substituted or unsubstituted phenylsulfinyl structure, substituted or unsubstituted phenylsulfonyl structure, substituted or unsubstituted (phenylmethyl)sulfanyl structure, (phenylmethyl)oxy structure, 2-thienyl structure, 2-thienyl sulfanyl structure, and 2-thienylcarbonyl structure.

Furthermore, in a compound represented by the formula (G) for use in the present invention, R_{Gb} is a hydrogen atom or a linear or branched alkyl group, aryl group or aralkyl group that may be substituted with an aryl group. Specific examples of such a linear or branched alkyl group include a methyl group, ethyl group, propyl group, isopropyl group (2-methylpropyl group), butyl group, 1-methylpropyl group, pentyl group, isopropyl group (3-methylbutyl group), hexyl group, isohexyl group (4-methylpentyl group), and heptyl group. Examples of the aryl group include a phenyl group and methylphenyl group. Examples of the aralkyl group include a phenylmethyl group (benzyl group), phenylethyl group, phenylpropyl group, phenylbutyl group, phenylpentyl group, and methylbenzyl group. In the present invention, in consideration of productivity of polymer synthesis, G_{Gb} is preferably a methyl group, ethyl group, propyl group, isopropyl group, pentyl group, hexyl group, phenyl group, or phenylmethyl group.

For example, a polyhydroxyalkanoate having a unit represented by the formula (C) which is the case where the alkylene chain is not substituted and R_{Jb} is a hydrogen atom in the formula (J), can be produced by the steps of reacting a starting polyhydroxyalkanoate having a unit represented by the formula (A) with a base and reacting the compound obtained in the previous step with a compound represented by the formula (B). 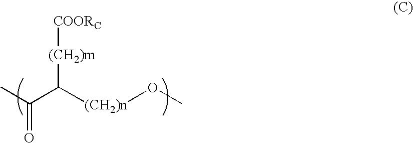
where n is an integer selected from 0 to 4; m is an integer selected from 0 to 8; and R_{c} represents a linear or branched alkyl group having 1 to 12 carbon atoms or aralkyl group; where a plurality of units are present, R_{c}, m and n independently represent the same as mentioned above for each unit. 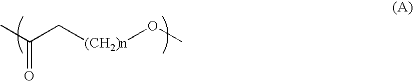
where n is an integer selected from 0 to 4; and where a plurality of units are present, n independently represents the same as mentioned above for each unit.
X(CH₂)mCOOR_{B} (B)
where m is an integer selected from 0 to 8; X is a halogen atom; and R_{B} is a linear or branched alkyl group having 1 to 12 carbon atoms or aralkyl group.

Examples of a compound represented by the formula (B) include methyl chloroformate, ethyl chloroformate, propyl chloroformate, isopropyl chloroformate, butyl chloroformate, cyclohexyl chloroformate, and benzyl chloroformate, methyl bromoformate, ethyl bromoformate, propyl bromoformate, isopropyl bromoformate, butyl bromoformate, cyclohexyl bromoformate, benzyl bromoformate, methyl chloroacetate, ethyl chloroacetate, propyl chloroacetate, isopropyl chloroacetate, butyl chloroacetate, cyclohexyl chloroacetate, benzyl chloroacetate, methyl bromoacetate, ethyl bromoacetate, propyl bromoacetate, isopropyl bromoacetate, butyl bromoacetate, cyclohexyl bromoacetate, benzyl bromoacetate, methyl 3-chloropropionate, ethyl 3-chloropropionate, propyl 3-chloropropionate, isopropyl 3-chloropropionate, butyl 3-chloropropionate, cyclohexyl 3-chloropropionate, benzyl 3-chloropropionate, methyl 3-bromopropionate, ethyl 3-bromopropionate, propyl 3-bromopropionate, isopropyl 3-bromopropionate, butyl 3-bromopropionate, cyclohexyl 3-bromopropionate, benzyl 3-bromopropionate, methyl 4-chlorobutyrate, ethyl 4-chlorobutyrate, propyl 4-chlorobutyrate, isopropyl 4-chlorobutyrate, butyl 4-chlorobutyrate, cyclohexyl 4-chlorobutyrate, benzyl 4-chlorobutyrate, methyl 4-bromobutyrate, ethyl 4-bromobutyrate, propyl 4-bromobutyrate, isopropyl 4-bromobutyrate, butyl 4-bromobutyrate, cyclohexyl 4-bromobutyrate, benzyl 4-bromobutyrate, methyl 5-chlorovalerate, ethyl 5-chlorovalerate, propyl 5-chlorovalerate, isopropyl 5-chlorovalerate, butyl 5-chlorovalerate, cyclohexyl 5-chlorovalerate, benzyl 5-chlorovalerate, methyl 5-bromovalerate, ethyl 5-bromovalerate, propyl 5-bromovalerate, isopropyl 5-bromovalerate, butyl 5-bromovalerate, cyclohexyl 5-bromovalerate, benzyl 5-bromovalerate, methyl 6-chlorohexanoate, ethyl 6-chlorohexanoate, propyl 6-chlorohexanoate, isopropyl 6-chlorohexanoate, butyl 6-chlorohexanoate, cyclohexyl 6-chlorohexanoate, benzyl 6-chlorohexanoate, methyl 6-bromohexanoate, ethyl 6-bromohexanoate, propyl 6-bromohexanoate, isopropyl 6-bromohexanoate, butyl 6-bromohexanoate, cyclohexyl 6-bromohexanoate, benzyl 6-bromohexanoate, methyl 7-chloroheptanoate, ethyl 7-chloroheptanoate, propyl 7-chloroheptanoate, isopropyl 7-chloroheptanoate, butyl 7-chloroheptanoate, cyclohexyl 7-chloroheptanoate, benzyl 7-chloroheptanoate, methyl 7-bromoheptanoate, ethyl 7-bromoheptanoate, propyl 7-bromoheptanoate, isopropyl 7-bromoheptanoate, butyl 7-bromoheptanoate, cyclohexyl 7-bromoheptanoate, benzyl 7-bromoheptanoate, methyl 8-chlorooctanoate, ethyl 8-chlorooctanoate, propyl 8-chlorooctanoate, isopropyl 8-chlorooctanoate, butyl 8-chlorooctanoate, cyclohexyl 8-chlorooctanoate, benzyl 8-chlorooctanoate, methyl 8-bromooctanoate, ethyl 8-bromooctanoate, propyl 8-bromooctanoate, isopropyl 8-bromooctanoate, butyl 8-bromooctanoate, cyclohexyl 8-bromooctanoate, benzyl 8-bromooctanoate, methyl 9-chlorononanoate, ethyl 9-chlorononanoate, propyl 9-chlorononanoate, isopropyl 9-chlorononanoate, butyl 9-chlorononanoate, cyclohexyl 9-chlorononanoate, benzyl 9-chlorononanoate, methyl 9-bromononanoate, ethyl 9-bromononanoate, propyl 9-bromononanoate, isopropyl 9-bromononanoate, butyl 9-bromononanoate, cyclohexyl 9-bromononanoate, and benzyl 9-bromononanoate.

The reaction between a polyhydroalkanoate containing a unit represented by the formula (A) and a compound represented by the formula (B) of the present invention will be described more specifically.

The present invention can be attained by adding a compound represented by the formula (B) to an α-methylene group located next to a carbonyl group in the backbone of a polymer in accordance with an addition reaction. More specifically, under the conditions for the addition reaction, a polyhydroxyalkanoate containing a unit represented by the formula (A) is reacted with a base capable of forming an α-methylene group, which is located next to a carbonyl group in the polymer backbone of the polyhydroxyalkanoate containing a unit represented by the formula (A), in the form of anion, and subsequently reacted with a compound represented by the formula (B). Furthermore, in the present invention, the amount of a compound represented by the formula (B) used herein is 0.001 to 100 folds by mole, and preferably 0.01 to 10 folds by mole relative to the unit represented by the formula (A).

The solvent to be used in the reaction according to the present invention is a non-reactive solvent, which is not particularly limited as long as it dissolves a starting material to some extent. Examples of such a solvent include aliphatic hydrocarbons such as hexane, cyclohexane, heptane, ligroin, and petroleum ether; aromatic hydrocarbons such as benzene, toluene and xylene; ethers such as diethyl ether, diisopropyl ether, tetrahydrofuran, dioxane, and dimethoxyethane and diethylene glycol dimethyl ether; amides such as formamide, N,N-dimethyl formamide, N,N′-dimethyl acetoamide, N-methyl-2-pyrrolidone, N-methylpyrrolidinone, and hexamethylphosphorotriamide. Of them, tetrahydrofuran is preferably used.

The reaction is performed in the presence of a base. Example of the base used herein include alkyl lithiums such as methyl lithium and butyl lithium; alkali metal disilazides such as lithium hexamethyl disilazide, sodium hexamethyl disilazide, and potassium hexamethyl disilazide, lithium amides such as lithium diisopropyl amide and lithium dicyclohexyl amide. Of them, lithium diisopropyl amide is preferably used. The amount of a base used in the present invention is 0.001 to 100 folds by mole, and preferably 0.01 to 10 folds by mole relative to the amount of a unit represented by the formula (A).

In the method of the present invention, the reaction temperature is set at usually −78° C. to 40° C., and preferably −78° C. to 30° C.

In the method of the present invention, reaction time usually falls within the range of 10 minutes to 24 hours, and particularly preferably, 10 minutes to 4 hours.

A polyhydroxyalkanoate having a unit represented by the formula (C) can be produced by the method mentioned above.

Furthermore, a polyhydroxyalkanoate having a unit represented by the formula (G) for use in the present invention may optionally use a polymer produced by a known method. Examples of such a polymer include microbial polyhydroxyalkanoate represented by poly-3-hydroxybutyrate and poly-3-hydroxyvalvarate. For example, Japanese Patent Publication Nos. H07-014352 and H08-019227 disclose a method of producing a copolymer of 3-hydroxy butyrate and 3-hydroxyvalvarate. Furthermore, Japanese Patent Application Laid-Open Nos. H05-093049 and H07-265065 disclose a method of producing a copolymer of a 3-hydroxybutyrate and a 3-hydroxyhexanoate. Moreover, Japanese Patent No. 2642937 discloses a method of producing a copolymer containing a 3-hydroxyalkanoate having 6 to 12 carbon atoms (from 3-hydroxyhexanoate to 3-hydroxyundecanate). Japanese Patent Application Laid-Open No. 2002-306190 discloses a method of producing a homopolymer of a poly-3-hydroxybutyrate. In the present invention, a polyhydroxyalkanoate can be produced by the same method as mentioned above. Other microbial polyhydroxyalkanoates can be produced by methods disclosed in International Journal of Biological Macromolecules 12 (1990) 92, and Japanese Patent Application Laid-Open Nos. 2001-288256 and 2003-319792, etc.

A polyhydroxyalkanoate comprising a unit of a substituted α-hydroxy acid represented by the formula (G) wherein R_{GC} is a linear alkylene chain having no carbon atom (nothing is selected as R_{GC}), can be synthesized by a known method. More specifically, a polyester can be produced directly from the substituted α-hydroxy acid. Alternatively, such a polyhydroxyalkanoate can be produced by converting, before a polymerization step, the substituted α-hydroxy acid into a derivative having a high polymerization activity, and subjecting the derivative to a ring-opening polymerization.

(A Method of Producing a Polyhydroxyalkanoate Comprising a Unit of Substituted α-Hydroxy Acid from Substituted α-Hydroxy Acid)

A polyhydroxyalkanoate comprising a unit of substituted α-hydroxy acid is obtained by performing condensation polymerization while refluxing the substituted α-hydroxy acid and a polymerization catalyst in an organic solvent to remove water generated in a polymerization step out of the reaction system.

(A) Polymerization Catalyst

Examples of a polymerization catalyst for use in the condensation polymerization of a substituted α-hydroxy acid include metals such as tin powder and zinc powder; metal oxides such as tin oxide, zinc oxide, magnesium oxide, titanium oxide, and aluminum oxide; metal halides such as tin (II) chloride, tin (IV) chloride, tin (II) bromide, tin (IV) bromide, zinc chloride, magnesium chloride, and aluminum chloride; tetraphenyl tin, tin octylate, and p-toluene sulfonic acid. The amount of a polymerization catalyst to be used is 0.001 to 10% by weight, and preferably 0.01 to 5% by weight 25, relative to that of a substituted α-hydroxy acid.

(B) Polymerization Solvent

In condensation polymerization of a substituted α-hydroxy acid, as a polymerization solvent, a solvent capable of being separated easily from water is preferably used. Examples of such a polymerization solvent include toluene, xylene, mesitylene, 1,2,3,5-tetramethylbenzene, chlorobenzene, 1,2-dichlorobenzene, 1,3-dichlorobenzene, bromobenzene, 1,2-dibromobenzene, 1,3-dibromobenzene, iodebenzene, 1,2-diiodobenzene, diphenylether, and dibenzylether. These solvents may be used in the form of admixture. A polymerization solvent is preferably used in such an amount that provides a concentration of 5 to 50% by weight in terms of a substituted α-hydroxy acid.

(C) Polymerization Conditions

In condensation polymerization of a substituted α-hydroxy acid, the temperature of polymerization is set at 50 to 200° C., and preferably 110 to 180° C. in consideration of a polymer generation rate and a thermal decomposition rate of the produced polymer. The condensation polymerization reaction is generally performed at a distillation temperature of an organic solvent under normal pressure. When an organic solvent having a high-boiling point is used, the condensation polymerization may be performed under reduced pressure. Condensation polymerization of a substituted α-hydroxy acid is preferably performed in an inert gas atmosphere or while replacing the atmosphere of a reaction apparatus with an inert gas or bubbling with an inert gas. The water generated in the polymerization reaction process is appropriately removed from the reaction apparatus. The number average molecular weight of a polyester obtained by polymerization varies depending upon the conditions including the type of a polymerization solvent, the type and amount of a polymerization catalyst, polymerization temperature, and polymerization time. Taking the reaction of the following step into consideration, the number average molecular weight of the polyester obtained is preferably from 1000 to 1,000,000 in terms of polystyrene.

(Method of Producing a Polyhydroxyalkanoate Comprising a Unit of Substituted α-Hydroxy Acid from a Cyclic Dimer of Substituted α-Hydroxy Acid)

A cyclic diester is formed from two molecules of substituted α-hydroxy acid by removing water to prepare a cyclic dimer lactide, as a derivative of substituted α-hydroxy acid. Thereafter, the cyclic dimer lactide is subjected to ring opening polymerization to form a polyester. Since the polymerization rate of the ring-opening polymerization is generally high, polyester can be produced with a high polymerization degree. A cyclic acid diesterification method by removing water from two molecules of substituted α-hydroxyl acid is, for example, performed by use of a reaction apparatus equipped with DeanStarktrap. In this method, substituted α-hydroxy acid and a condensation catalyst such as p-toluene sulfonic acid are subjected to azeotropic dehydration performed in toluene under a nitrogen atmosphere for 30 hours, while appropriately removing water accumulated in DeanStarktrap. As a result, a cyclic dimer lactide can be obtained in a high yield. Alternatively, a desired polyester can be obtained by adding a polymerization catalyst to a cyclic dimer lactide and subjected to ring-opening polymerization under an inert gas atmosphere.

(A) Polymerization Catalyst

Examples of a polymerization catalyst for use in the ring-opening polymerization of cyclic dimer lactide include metals such as tin powder and zinc powder; metal oxides such as tin oxide, zinc oxide, magnesium oxide, titanium oxide, and aluminum oxide; metal halides such as tin (II) chloride, tin (IV) chloride, tin (II) bromide, tin (IV) bromide, zinc chloride, magnesium chloride, and aluminum chloride; tetraphenyl tin, and tin octylate. Of them, tin and a tin compound are particularly preferable since they have an excellent catalytic activity. A polymerization catalyst is used in an amount of 0.001 to 10% by weight, and preferably 0.01 to 5% by weight relative to that of a cyclic dimer lactide.

(B) Polymerization Conditions

In ring-opening polymerization of cyclic dimer lactide, the temperature of polymerization is set at 100 to 200° C., and preferably 120 to 180° C. in consideration of a polymer generation rate and a thermal decomposition rate of the produced polymer. The ring-opening polymerization reaction is generally performed under an inert gas atmosphere. As such an inert gas, nitrogen gas and argon gas may be used. The number average molecular weight of a polyester obtained by polymerization varies depending upon the conditions including the type and amount of a polymerization solvent, polymerization temperature, and polymerization time. In consideration of the reaction of the following step, the number average molecular of a polyhydroxyalkanoate comprising a unit of substituted α-hydroxy acid to be used in the present invention is preferably from 1,000 to 1,000,000 in terms of polystyrene.

A polyhydroxyalkanoate containing at least one unit represented by the formula (6) of the present invention can be produced by polymerizing an intramolecular cyclic compound of ω-hydroxycarbonic acid represented by the formula (8) in the presence of a catalyst. 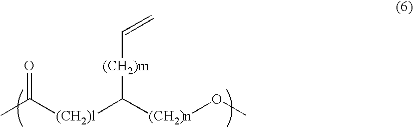
wherein, with respect to l, m and n,
where l is an integer selected from 0 and 2 to 4, and n is an integer selected from 0 to 4, m is an integer selected from 0 to 8;
where l is 1 and n is an integer selected from 1 to 4, m is an integer selected from 0 to 8; and
where, a plurality of units are present, l, m and n, each represent the same as mentioned above independently for each unit. 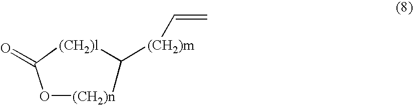
wherein, with respect to l, m and n,
where l is an integer selected from 0 and 2 to 4, and n is an integer selected from 0 to 4, m is an integer selected from 0 to 8;
where l is 1 and n is an integer selected from 1 to 4, m is an integer selected from 0 to 8; and
where a plurality of types of compounds are used together, l, m and n, independently represent the same as mentioned above for each compound.

In producing a polyhydroxyalkanoate containing a unit represented by the formula (6) by use of an intramolecular cyclic compound of ω-hydroxycarbonic acid represented by the formula (8), the polymerization method is not particularly limited and, for example, a solution polymerization method, slurry polymerization method, and mass polymerization method may be used. When a polymerization solvent is used, the solvent is not particularly limited. Examples of such a solvent include inert solvents such as aliphatic and cyclic hydrocarbons having 5 to 18 carbon atoms and aromatic hydrocarbons having 6 to 20 carbon atoms, tetrahydrofuran, chloroform, orthodichlorobenzene and dioxane.

In the present invention, a known catalyst for use in ring opening polymerization may be used as a catalyst for use in the polymerization. Examples of such a catalyst include tin (II) chloride, tin (IV) chloride, stannous fluoride, stannous acetate, stannous stearate, stannous octanoate, stannous oxide, stannic oxide, and other tin salts. Other examples of such a catalyst include triethoxyaluminum, tri-n-propxy-aluminum, tri-iso-propoxyaluminum, tri-n-butoxyaluminum, tri-iso-butoxyaluminum, aluminum chloride, di-iso-propylzinc, dimethylzinc, diethylzinc, zinc chloride, tetra-n-propoxytitanium, tetra-n-butoxytitanium, tetra-t-butoxytitanium, antimony trifluoride, lead oxide, lead stearate, titanium tetrachloride, boron trifluoride, boron trifluoride-ether complex, triethylamine, and tributylamine.

The amount of such a catalyst falls within the range of 0.0001 to 10% by weight, and preferably 0.001 to 5% by weight based on the total amount of a 1.0 monomer compound.

In the present invention, a known polymerization initiator can be used in initiating ring-opening polymerization. Examples of such a polymerization initiator include aliphatic alcohols, which may be mono, di or polyalcohol and may be saturated or unsaturated. Specific examples of such an alcohol used herein include mono alcohols such as methanol, ethanol, propanol, butanol, pentanol, hexanol, heptanol, nonanol, decanol, lauryl alcohol, myristyl alcohol, cetylalcohol, stearylalcohol, and p-tert-butylbenzyl alcohol; dialcohols such as ethylene glycol, butanediol, hexanediol, nonandiol, and tetramethylene glycol; polyalcohols such as glycerol, sorbitol, xylitol, ribitol, and erythritol; methyl lactate; and ethyl lactate. The proportion of such an aliphatic alcohol slightly varies depending upon the conditions such as types of alcohol used; however, it is usually 0.01 to 10% by weight based on the total amount of a monomer.

In the present invention, a ring-opening polymerization reaction may be performed at a temperature ranging from 25 to 200° C., preferably 50 to 200° C. and more preferably 100 to 180° C.

In the present invention, the ring-opening polymerization reaction may be performed in an inert gaseous atmosphere such as a nitrogen or argon atmosphere or under reduced or increased pressure. During the reaction, a catalyst and an alcohol may be added successively.

Furthermore, in the present invention, a second component or the like may be co-polymerized in order to vary physical properties such as mechanical properties and decomposition properties in various ways. To describe more specifically a cyclic diester of α-hydroxy carboxylic acid and an intramolecular cyclic compound of ω-hydroxy carboxylic acid, lactone, may be co-polymerized. Examples of such a cyclic diester of α-hydroxy carboxylic acid include intramolecular cyclic diesters such as glycolic acid, lactic acid, α-hydroxybutyric acid, α-hydroxyisobutyric acid, α-hydroxyvaleric acid, α-hydroxyisovaleric acid, α-hydroxy-α-methylbutyric acid, α-hydroxycaproic acid, α-hydroxyisocaproic acid, α-hydroxy-β-methylvaleric acid, α-hydroxyheptanoic acid, mandelic acid, and β-phenyllactic acid. Those having an asymmetric carbon atom may take L-form, D-form, raceme-form or meso-form. Furthermore, a cyclic diester may be formed of different types of α-oxyacid molecules. Specific examples of such a cyclic diester include a cyclic diester between glycolic acid and lactic acid, that is, 3-methyl-2,5-diketo-1,4-dioxane. Examples of a lactone, which is an intramolecular cyclic compound of ω-hydroxy carboxylic acid, include, but not limited to, β-propiolactone, β-butyrolactone, β-isovalerolactone, β-caprolactone, β-isocaprolactone, β-methyl-β-valerolactone, γ-butyrolactone, γ-valerolactone, δ-valerolactone, ε-caprolactone, 11-oxydecanoiclactone, p-dioxane, and 1,5-dioxepane-2-one.

The number average molecular weight of a polyhydroalkanoate obtained by polymerization varies depending upon various conditions such as the type and amount of a polymerization catalyst, polymerization temperature and polymerization time; however, preferably falls in the range of 1,000 to 1,000,000.

A polyhydroxyalkanoate containing at least one unit represented by the formula (10) of the present invention can be produced by polymerizing an intramolecular cyclic compound of ω-hydroxy carboxylic acid represented by the formula (9) in the presence of a catalyst. 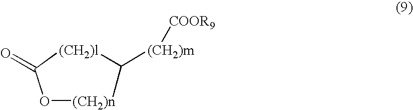
wherein, R₉ represents a linear or branched alkyl group having 1 to 12 carbon atoms or aralkyl group; and
wherein, with respect to l, m and n,
where l is an integer selected from 0 and 2 to 4, and n is an integer selected from 0 to 4, m is an integer selected from 0 to 8;
where l is 1 and n is an integer selected from 1 to 4, m is an integer selected from 0 to 8;
where l is 1 and n is 0, m is 0; and
where a plurality of types of compounds are used together, l, m and n, independently represent the same as mentioned above for each compound. 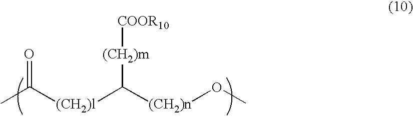
wherein, R₁₀ represents a linear or branched alkyl group having 1 to 12 carbon atoms or aralkyl group; and
wherein, with respect to l, m and n,
where l is an integer selected from 0 and 2 to 4, and n is an integer selected from 0 to 4, m is an integer selected from 0 to 8;
where l is 1 and n is an integer selected from 1 to 4, m is an integer selected from 0 to 8;
where l is 1 and n is 0, m is 0; and
where a plurality of units are present, R₁₀, l, m and n independently represent the same as mentioned above for each unit.

In producing a polyhydroxyalkanoate containing a unit represented by the formula (10) using an intramolecular cyclic compound of a ω-hydroxy carboxylic acid represented by the formula (9), a polymerization method is not particularly limited, for example, a solution polymerization method, slurry polymerization method, and mass polymerization method may be used. Furthermore, when a polymerization solvent is used, the solvent is not particularly limited. Examples of such a solvent include inert solvents such as aliphatic and cyclic hydrocarbons having 5 to 18 carbon atoms and aromatic hydrocarbons having 6 to 20 carbon atoms, tetrahydrofuran, chloroform, orthodichlorobenzene and dioxane.

In the present invention, a known catalyst for ring opening polymerization may be used as a catalyst for use in the polymerization. Examples of such a catalyst include tin (II) chloride, tin (IV) chloride, stannous fluoride, stannous acetate, stannous stearate, stannous octanoate, stannous oxide, stannic oxide, and other tin salts. Other examples of such a catalyst include triethoxyaluminum, tri-n-propxy-aluminum, tri-iso-propoxyaluminum, tri-n-butoxyaluminum, tri-iso-butoxyaluminum, aluminum chloride, di-iso-propylzinc, dimethylzinc, diethylzinc, zinc chloride, tetra-n-propoxytitanium, tetra-n-butoxytitanium, tetra-t-butoxytitanium, antimony trifluoride, lead oxide, lead stearate, titanium tetrachloride, boron trifluoride, boron trifluoride-ether complex, triethylamine, and tributylamine.

The amount of such a catalyst to be used falls within the range of 0.0001 to 10% by weight, and preferably 0.001 to 5% by weight based on the total amount of a monomer compound.

In the present invention, a known polymerization initiator can be used in initiating ring-opening polymerization. Examples of such a polymerization initiator include aliphatic alcohols, which may be mono, di or polyalcohol and may be saturated or unsaturated. Examples of such an alcohol used herein include mono alcohols such as methanol, ethanol, propanol, butanol, pentanol, hexanol, heptanol, nonanol, decanol, lauryl alcohol, myristyl alcohol, cetylalcohol, stearylalcohol, p-tert-butylbenzyl alcohol; dialcohols such as ethylene glycol, butanediol, hexanediol, nonandiol, and tetramethylene glycol; polyalcohols such as glycerol, sorbitol, xylitol, ribitol, and erythritol; methyl lactate; and ethyl lactate. The proportion of such an aliphatic alcohol varies depending upon the conditions such as type of alcohol used; however, it is usually 0.01 to 10% by weight based on the total amount of a monomer.

In the present invention, a ring-opening polymerization reaction may be performed at a temperature ranging from 25 to 200° C., preferably 50 to 200° C. and more preferably 100 to 180° C.

In the present invention, the ring-opening polymerization reaction may be performed in an inert gaseous atmosphere such as a nitrogen or argon atmosphere or under reduced or increased pressure. During the reaction, a catalyst or an alcohol may be added successively.

Furthermore, in the present invention, a second component or the like may be co-polymerized in order to vary physical properties such as mechanical properties and decomposition properties in various ways. To describe more specifically a cyclic diester of α-hydroxy carboxylic acid and an intramolecular cyclic compound of ω-hydroxy carboxylic acid, lactone, may be co-polymerized. Examples of such a cyclic diester of α-hydroxy carboxylic acid include intramolecular cyclic diesters such as glycolic acid lactic acid, α-hydroxybutyric acid, α-hydroxyisobutyric acid, α-hydroxyvaleric acid, α-hydroxyisovaleric acid, α-hydroxy-α-methylbutyric acid, α-hydroxycaproic acid, α-hydroxyisocaproic acid, α-hydroxy-β-methylvaleric acid, α-hydroxyheptanoic acid, mandelic acid, and β-phenyllactic acid. Those having an asymmetric carbon atom may take L-form, D-form, raceme-form or meso-form. Furthermore, a cyclic diester may be formed of different types of α-oxyacid molecules. Specific examples of such a cyclic diester include a cyclic diester between glycolic acid and lactic acid, that is, 3-methyl-2,5-diketo-1,4-dioxane. Examples of a lactone, which is an intramolecular cyclic compound of ω-hydroxy carboxylic acid, include, but not limited to, β-propiolactone, β-butyrolactone, β-isovalerolactone, β-caprolactone, β-isocaprolactone, β-methyl-β-valerolactone, γ-butyrolactone, γ-valerolactone, δ-valerolactone, ε-caprolactone, 11-oxydecanoiclactone, p-dioxane, and 1,5-dioxepane-2-one.

The number average molecular weight of a polyhydroalkanoate obtained by polymerization varies depending upon various conditions such as the type and amount of polymerization catalyst, polymerization temperature and polymerization time; however, preferably falls in the range of 1,000 to 1,000,000.

The molecular weight of a polyhydroxyalkanoate of the present invention can be measured in terms of relative molecular weight or absolute molecular weight, and simply by, for example, gel permeation chromatography (GPC). To explain more specifically, in the GPC, a polyhydroxyalkanoate is dissolved in an appropriate solvent capable of dissolving the polyhydroxyalkanaote and the molecular weight of the polyhydroxyalkanoate is determined in its mobile phase. Any detector, such as a differential refraction indicator (RI) or an ultraviolet (UV) detector may be used in accordance with the polyhydroxyalkanoate to be determined. The molecular weight may be obtained in a relative value to a sample (polystyrene, polymethylmethacrylate etc.). A solvent may be selected from those capable of dissolving a polymer such as dimethylformamide (DMF), dimethylsulfoxide (DMSO), chloroform, tetrahydrofuran (THF), toluene, and hexafluoroisopropanol (HFIP). In the case of a polar solvent, the molecular weight can be measured by adding a salt.

In the present invention, a polyhydroxyalkanoate having a ratio of the weight average molecular weight (Mw) to the number average molecular weight (Mn), that is, a ratio of Mw/Mn, within the range of 1 to 10, may preferably be used.

The polyhydroxyalkanoate polymer produced by the method of the present invention include either one of a unit having a sulfonic acid group or a derivative thereof and a unit having a carboxyl group or a derivative thereof. Such a structure of the polymer facilitates localization of intramolecular electrons at an end of the unit, so that the electric properties of the polyhydroxyalkanoate may possibly differ significantly from that of a conventional one. By virtue of the localization of electrons, behavior of the polyhydroxyalkanoate of the present invention to a solvent also differs from that of a conventional one. For example, the polyhydroxyalkanoate of the present invention becomes soluble in a polar solvent such as dimethylformamide (DMF). Furthermore, the polyhydroxyalkanoate is excellent in the thermal properties, in particular, a glass transition temperature, which can increase significantly due to a hydrogen bond, and is therefore applicable in a wide variety of usage.

The polyhydroxyalkanoate (PHA) used in the present invention preferably contains a monomer unit represented by the formula (1) or (5) in a unit ratio of not less than 0.2% to 0.4% or less and a number average molecular weight of 1,000 to 1,000,000, and more preferably 1,000 to 200,000. When the ratio of a unit represented by the formula (1) or (5) is less than 0.2%, the PHA is likely to decrease in performance for charging toner positively. On the other hand, when the ratio of a unit represented by the formula (1) or (5) is greater than 40%, it is not preferable since environmental stability such as humidity resistance and film-coating property deteriorate. Furthermore, when the number average molecular weight of PHA used herein is less than 1,000, meaning that the amount of low-molecular weight components exceeds, toner is likely to adhere or fix onto a sleeve, decreasing the charge-application property of a resin layer. On the other hand, when the number average molecular weight is larger than 1,000,000, compatibility with an another type of resin forming the resin layer deteriorates with the result that toner tends not to be stably charged due to environmental change or with the passage of time. On the other hand, when the molecular weight of PHA is excessively large, the viscosity of a resin in a solvent increases, causing defective coating. When pigments are added, they cause defective dispersion. As a result, a resin-coating layer is not uniformly formed in terms of composition, charging toner unstably. In addition, the surface roughness of the resin-coating layer is not stabilized, reducing the abrasion resistance.

It is also preferable that the PHA used in the present invention further contains a unit represented by the formula (7) besides the above mentioned units. 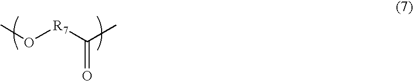
wherein R₇ represents a linear or branched alkylene group having 1 to 11 carbon atoms, or an alkylidene group having 1 to 5 carbon atoms that may be substituted with an alkyleneoxyalkylene group where each alkylene group has 1 to 2 carbon atoms or, if desired, an aryl group; and wherein a plurality of units are present, R₇ represents the same meaning as mentioned above, independently for each unit.

Note that, since a glass transition point of a binder resin for toner is generally and often about 50 to 70° C., it is preferable that PHA for use in coating is appropriately selected such that the resultant resin-coating layer has a glass transition temperature higher than that of toner in order to avoid adhesion of toner onto the surface of the resin-coating layer formed on a substrate.

Next, another structure of a developer carrying member having a resin layer formed of the aforementioned components according to the present invention will be explained below.

The developer carrying member is used in a development apparatus for developing a latent image formed on an electrostatic latent image bearing member by a developer carried and transported by the developer carrying member, thereby visualizing the latent image. Examples of such a developer carrying member include a developing sleeve, a developing roller, and the like. Of them, a developing sleeve may be particularly suitably used.

The developer carrying member of the present invention has a resin layer, which is formed of the aforementioned materials, on the surface of a substrate. Examples of an applicable substrate for use in the developer carrying member include a columnar member, a cylindrical member, or a belt-form member formed of a metal, resin, rubber or a composite thereof. Of them, a cylindrical member (cylindrical tube) is particularly preferably used. The cylindrical tube used preferably is formed by molding a nonmagnetic metal or alloy such as aluminum, stainless steel or brass into a cylinder, followed by polishing or grinding it. Such a metal cylindrical tube is accurately molded and processed in order to improve uniformity of an image. For example, the straightness of the metal cylindrical tube in the longitudinal direction may be preferably 30 μm or less, more preferably 20 μm or less. The interval between the developer carrying member (sleeve) and a photosensitive drum, more specifically, the interval between the sleeve and the vertical plane of the photosensitive drum generated when the sleeve is rotated while pressing the photosensitive drum against the vertical plane via spacers equal in size, may preferably differ within the range of 30 μm or less, and more preferably 20 μm or less.

Furthermore, in the developer carrying member according to the present invention, a resin layer is formed so as to cover the surface of the substrate mentioned above. A binder resin for use in forming the resin layer contains a polyhydroxyalkanoate characterized by containing, per molecule, at least one unit represented either by the formula (1): 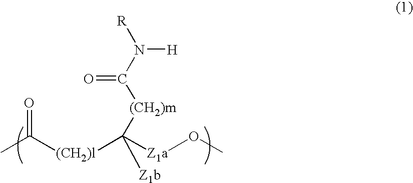
wherein
R represents -A₁-SO₂R₁,
R₁ represents OH, a halogen atom, ONa, OK or OR₁ₐ,
R₁ₐ and A₁ independently represent a group having a substituted or unsubstituted aliphatic hydrocarbon structure, a substituted or unsubstituted aromatic ring structure, or a substituted or unsubstituted heterocyclic structure; and
wherein, with respect to l, m, Z₁a and Z₁b,
where l is an integer selected from 2 to 4, nothing is selected as Z₁a or Z₁a is a linear alkylene chain having 1 to 4 carbon atoms, Z₁b is a hydrogen atom, and m is an integer selected from 0 to 8,
where l is 1 and Z₁a is a linear alkylene chain having 1 to 4 carbon atoms, Z₁b is a hydrogen atom, and m is an integer selected from 0 to 8,
where l is 1, and nothing is selected as Z₁a, Z₁b is a hydrogen atom, and m is 0,
where l is 0, Z₁a is a linear alkylene chain having 1 to 4 carbon atoms, the linear alkylene chain may be substituted with a linear or branched alkyl group or with an alkyl group containing a residue having any one of a phenyl structure, a thienyl structure and a cyclohexyl structure at the end, Z₁b is a hydrogen atom or a linear or branched alkyl group, aryl group or aralkyl group that may be substituted with an aryl group, and m is an integer selected from 0 to 8,
where l is 0 and nothing is selected as Z₁a, Z₁b is a hydrogen atom or a linear or branched alkyl group, aryl group or aralkyl group that may be substituted with an aryl group, and m is an integer selected from 0 to 8, and
where a plurality of units are present, R, R₁, R₁ₐ, A₁, Z₁a, Z₁b, l and m independently represent the same as mentioned above for each unit,
or by the formula (5): 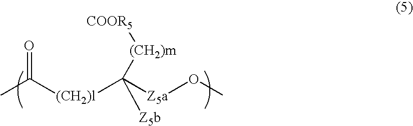
wherein
R₅ represents hydrogen, a group forming a salt, or R₅a; R₅a represents a linear or branched alkyl group having 1 to 12 carbon atoms or aralkyl group; and wherein, with respect to l, m, Z₅a and Z₅b,
where l is an integer selected from 2 to 4, nothing is selected as Z₅a or Z₅a is a linear alkylene chain having 1 to 4 carbon atoms, Z₅b is a hydrogen atom, and m is an integer selected from 0 to 8,
where l is 1 and Z₅a is a linear alkylene chain having 1 to 4 carbon atoms, Z₅b is a hydrogen atom, and m is an integer selected from 0 to 8,
where l is 1 and nothing is selected as Z₅a, Z₅b is a hydrogen atom, and m is 0,
where l is 0 and Z₅a is a linear alkylene chain having 1 to 4 carbon atoms, the linear alkylene chain may be substituted with a linear or branched alkyl group or with an alkyl group containing a residue having any one of a phenyl structure, a thienyl structure, and a cyclohexyl structure at the end, Z₅b is a hydrogen atom or a linear or branched alkyl group, aryl group or aralkyl group that may be substituted with an aryl group, and m is an integer selected from 0 to 8,
where l is 0 and nothing is selected as Z₅a, Z₅b is a hydrogen atom or a linear or branched alkyl group, aryl group or aralkyl group that may be substituted with an aryl group, and m is an integer selected from 0 to 8, and
where a plurality of units are present, R₅, R₅ₐ, Z₅a, Z₅b, l and m independently represent the same as mentioned above for each unit.

In this case, if necessary, another known resin may be contained in the copolymer (the aforementioned polyhydroxyalkanaote). Examples of such a resin used herein include thermoplastic resins such as a styrene based resin, vinyl based resin, polyethersulfonic acid resins, polycarbonate resin, polyphenylene oxide resins, polyamide resin, fluororesin, cellulose based resin, and acrylic resin; and thermo- or photo-setting resins such as a polyester resin, alkyd resin, polyurethane resin, urea resin, and silicone resin. Of them, use is more preferably made of demolding-type resins such as a silicone resin and fluororesin, and resins excellent in mechanical properties such as a polyether sulfone, polycarbonate, polyphenylene oxide, styrene based resin and acrylic resin.

Furthermore, fine conductive powder and/or a solid lubricant agent are preferably added to the resin layer to be applied on a base-body surface constituting a developer carrying member according to the present invention to render the resin layer conductive. The lubricant agent (lubricant substance) serves as a frictional electrification-imparting agent. The effects of the present invention can be increased by forming a resin layer having the lubricant substance dispersed therein, on the base-body surface. Examples of such a lubricant substance include solid lubricants including aliphatic metal salts such as graphite, molybdic sulfide, boron nitride, mica, graphite fluoride, silver-niobium selenide, calcium chloride-graphite, talc and zinc stearate. Of them, graphite is particularly preferably used since it will not affect the conductive properties of the coating resin layer. The number average particle size of the solid lubricant agent is preferably about 0.2 to 20 μm, and more preferably, 1 to 15 μm.

When the addition amount of the aforementioned solid lubricant agent falls within the range of 10 to 120 parts by weight based on a binder resin as being 100 parts by weight, particularly preferable results can be given. To explain more specifically, when the addition amount exceeds 120 parts by weight, the strength of a coating resin layer and charge amount of toner tend to decrease. On the other hand, when the addition amount is less than 10 parts by weight, the surface of the resin layer constituting a developer carrying member of the present invention tend to lose the effect of preventing adhesion of toner onto the surface of the resin layer if used for a long time.

In the present invention, to control volume resistivity of the resin layer to be formed on the base-body surface, fine conductive particles may be dispersed in the binder resin in addition to a solid lubricant agent. The fine conductive particles used herein may preferably has an average diameter of 20 μm or less, more preferably 10 μm or less. Furthermore, to avoid formation of projections and depressions on the surface, fine conductive particles having an average diameter of 1 μm or less are preferably used.

Examples of such fine conductive particles to be used in the present invention include carbon black such as furnace black, lamp black, thermal black, acetylene black and channel black; metal oxides such as titanium oxide, tin oxide, zinc oxide, molybdenum oxide, potassium titanate, antimony oxide, and indium oxide; metals such as aluminum, copper, silver, and nickel; and inorganic fillers such as graphite, metal fiber and carbon fiber. The addition amount of the fine conductive particles particularly preferably falls within the range of 100 parts or less by weight based on the binder resin being 100 parts by weight. To explain more specifically, when the addition amount exceeds 100 parts by weight, the coating strength of the resin layer and the charge amount of toner tend to decrease.

A preferable constitution of the resin layer of the developer carrying member of the present invention resides in that particles having a number average diameter of 0.3 to 30 μm, responsible for forming projections and depressions in the surface of a coating resin layer, are dispersed in the resin layer in addition to the aforementioned additional substance, thereby stabilizing the surface roughness of the developer carrying member and contributing to optimization of the amount of toner provided on the developer carrying member. By virtue of this, the copolymer (the aforementioned polyhydroxyalkanaote) can sufficiently produce the effect of imparting frictional electrification. The particles are effective in maintaining uniform surface roughness of the resin-layer surface of a developer carrying member, making small the change in the surface roughness of the resin layer even if the resin layer surface is worn out, and simultaneously in suppressing staining with toner and melt-adhesion of toner.

The particles for forming projections and depressions on the resin-layer surface coated on the substrate surface constituting the developer carrying member of the present invention are preferably have a number average diameter of 0.3 to 30 μm, and preferably 2 to 20 μm. Particles having a number average diameter of less than 0.3 μm is not preferable because the effect of imparting uniform roughness to the surface and the electrification are not sufficient, with the result that a developer is not quickly and uniformly charged; at the same time, charge-up due to worn-out of the resin layer, and staining and melt-adhesion of toner are generated, leading to a significant ghost and reduction of image density. On the other hand, particles having a number average diameter beyond 30 μm are not preferable, either. This is because the surface roughness of the resin layer becomes excessively large, preventing sufficient charge of toner; at the same time, the mechanical strength of the resin layer tends to decrease.

In the present invention, the particles for forming projections and depressions in the resin-layer surface desirably have spherical form. The spherical form used herein refers to particles having the ratio of the major axis to the minor axis in the range of about 1.0 to 1.5. In the present invention, the particles preferably have the ratio of the major axis to the minor axis in the range of 1.0 to 1.2. When the ratio of the major axis to the minor axis exceeds 1.5, the surface roughness of the resin layer is likely to be nonuniform. Therefore, this case is not preferable in view of quick and uniform toner charging and the strength of the conductive resin layer.

It is further preferable that a true density of the spherical particles is 3 g/cm³ or less, preferably 2.7 g/cm³ or less, and more preferably 0.9 to 2.3 g/cm³. When a true density of the spherical particles exceeds 3 g/cm³, the dispersion properties of the spherical particles in the resin layer tend to become insufficient, with the result that the resin-layer surface cannot be formed with a uniform roughness. In addition to this, the storage stability of paint tends to deteriorate. Also in this case, it becomes difficult to obtain frictional electrification imparted surface having a uniform roughness. Furthermore, in the case where a true density of the spherical particles is less than 0.9 g/cm³, the dispersion properties and storage stability of the spherical particles in the resin layer tend to be insufficient.

As the spherical particles to be used in the present invention, known spherical particles may be used. Examples of such spherical resin particles include spherical metal oxide particles and spherical carbonaceous particles. The spherical resin particles may be formed by suspension polymerization, dispersion polymerization or the like. Of them, spherical resin particles are preferably used because the surface of the developer carrying member can be obtained with a suitable surface roughness in a uniform state in a lesser addition amount. Examples of such spherical particles include acrylic resin particles formed of polyacrylic resin, polymethacrylic resin, etc.; polyamide resin particles formed of nylon resin, etc.; polyolefin resin particles formed of polyethylene resin and polypropylene resin, etc.; silicone resin particles, phenol resin particles, polyurethane resin particles, styrene resin particles and benzoguanamine particles. The resin particles obtained by a pulverization method may be subjected to thermal or physical rounding processing before use.

Furthermore, an inorganic substance may be adhered or fixed onto the surface of the spherical particles thus obtained before use. Examples of such an inorganic substance include oxides such as SiO₂, SrTiO₃, CeO₂, CrO, Al₂O₃, ZnO and MgO; nitrides such as Si₃N₄; carbides such as SiC; sulfates such as CaSO₄, BaSO₄, and CaCO₃; and carbonates. Such fine inorganic powder may be subjected to organic treatment with a coupling agent before use.

For the purpose of improving adhesiveness with a binder resin or imparting hydrophobic properties to particles, fine inorganic particles treated with a coupling agent are preferably used. Examples of the coupling agent used herein include a silane coupling agent, titanium coupling anent, and zircoaluminate coupling agent. More specifically, examples of the silane coupling agent include hexamethyldisilane, trimethylsilane, trimethylchlorosilane, trimethylethoxysilane, dimethyldichlorosilane, methyltrichlorosilane, allyldimethylchlorosilane, allylphenyldichlorosilane, benzyldimethylchlorosilane, bromomethyldimethylchorosilane, α-chloroethyltrichlorosilane, β-chloroethyltrichlorosilane, chloromethyldimethylchlorosilane, triorganosilylmercaptane, trimethylsilylmercaptane, triorganosilylacrylate, vinyldimethylacetoxysilane, dimethyldiethoxysilane, dimethyldimethoxysilane, diphenyldiethoxysilane, hexamethyldisiloxane, 1,3-divinyltetramethyldisiloxane, 1,3-diphenyltetramethyldisiloxane and dimethylpolysiloxane having 2 to 12 siloxane units per molecule and a hydroxyl group bonded to a silicone atom in each of the terminal units. If use is made of the spherical resin particles on the surface of which fine inorganic particles treated with such a coupling agent are adhered or fixed, the spherical particles can be dispersed sufficiently in the resin, improving uniformity of the resultant resin-layer surface, staining resistance, electrification performance, and abrasion resistance of toner.

It is more preferable that the spherical particles having aforementioned constitution for use in the present invention have conductivity. More specifically, the spherical particles having conductivity, since charge is rarely accumulated on the surface of the particles due to its conductivity, can reduce adhesion of toner on the surface of a developing sleeve, and improve electrification performance of toner. As the conductivity of the spherical particles desired by the present invention, a volume resistivity value of the particles is preferably 10⁶ Ω·cm or less, more preferably 10⁻³ to 1 ⁶ Ω·cm. To explain more specifically, when the volume resistivity value exceeds 10⁶ Ω·cm, the spherical particles are exposed on the surface of the resin layer due to abrasion, rendering the particles partly insulative. As a result, staining and melt-adhesion of toner easily start from the insulative portion and thus, quick and uniform electrification may not be rarely performed.

Examples of a method for obtaining conductive spherical particles suitably used in the present invention include, but not limited to, the following ones. A particularly preferable method for obtaining conductive spherical particles used in the present invention comprises baking spherical resin particles or mesocarbon microbeads to form carbide and/or graphite particles, which are spherical carbon particles low in concentration and having a good conductivity. Examples of a resin material for use in spherical resin particles include phenol resin, naphthalene resin, furan resin, xylene resin, divinylbenzene polymer, styrene-divinylbenzene copolymer, and polyacrylonitrile. Furthermore, the mesocarbon microbeads can be manufactured generally by washing out spherical crystal generated during the step of heating and baking middle pitch, with a large amount of tar, middle oil and a solvent such as quinoline.

A more preferable method of obtaining conductive spherical particles comprises applying bulk merophase pitch on the surface of spherical resin particles, which are formed of phenol resin, naphthalene resin, furan resin, xylene resin, divinylbenzene polymer, styrene-divinylbenzene copolymer, or polyacrylonitrile, by a mechanochemical method, and subjecting the coated particles to a heat treatment performed under an oxidative atmosphere, followed by baking to obtain conductive spherical carbon particles formed of carbide and/or graphite.

In any one of the aforementioned methods, conductivity of the conductive spherical carbon particles can be controlled to some extent by varying the baking conditions. Therefore, the conductive spherical carbon particles thus obtained can be preferably used as the spherical particles having conductivity in the present invention. Furthermore, the spherical carbon particles obtained in the aforementioned methods may be plated with a conductive metal and/or a metal oxide such that a true density of the conductive spherical particles does not exceed 3 g/cm³, if necessarily, to improve its conductivity.

An another method for obtaining conductive spherical particles suitably used in the present invention comprises mechanically blending, with core spherical resin particles, fine conductive particles smaller in diameter than the core particles, in an appropriate blending ratio, thereby adhering the fine conductive particles to the periphery of the core particles by means of the van der Waals force and electrostatic force, and increasing temperature locally by, for example, application of the mechanical stress, to soften the surface of the core particles, thereby coating the surface of the core particles with the fine conductive particles in the form of film. In this way, the spherical resin particles having a conductivity can be obtained.

As the core particles, spherical resin particles formed of an organic compound and having a small true density are preferably used. Examples of a resin used as the resin particles include PMMA, acrylic resin, polybutadiene resin, polystyrene resin, polyethylene, polypropylene, polybutadiene, copolymers of these mentioned, benzoguanamine resin, phenol resin, polyamide resin, nylon fluoro resin, silicone resin, epoxy resin and polyester resin. The fine conductive resin particles (small particles) to be used in forming a film on the surface of the core particles (mother particles) preferably have a diameter ⅛ as small as that of mother particles in order to uniformly form fine conductive particle film.

As a method for obtaining conductive spherical particles to be used in the present invention, mention may be made of a method comprising uniformly dispersing fine conductive particles in spherical resin particles to obtain the conductive spherical particles having fine conductive particles dispersed therein. Example of a method for dispersing the fine conductive particles in the spherical resin particles include a method comprising kneading a binder resin with the fine conductive particles, thereby dispersing the fine conductive particles, cooling them to solidify, pulverizing into particles having a predetermined diameter, rounding them by mechanical treatment and thermal treatment to obtain the fine conductive spherical particles; or a method comprising adding a polymerization initiating agent, the fine conductive particles and other additives to polymerizable monomers and dispersing the mixture uniformly by a dispersing machine to form a polymerizable monomer composition, suspending the composition in an aqueous phase containing a dispersion stabilizer so as to disperse into particles of a predetermined diameter, and performing polymerization, thereby obtaining spherical particles having the fine conductive particles dispersed therein.

In the conductive spherical particles having fine conductive particles dispersed therein and obtained in any one of the aforementioned methods, the conductivity is further improved before use by mechanically blending the conductive spherical particles with fine conductive particles smaller in diameter than the aforementioned core particles, in an appropriate blending ratio, thereby adhering the fine conductive particles around the conductive spherical particles by means of the van der Waals force and electrostatic force, and increasing temperature locally by, for example, application of the mechanical stress, to soften the surface of the conductive spherical particles, thereby coating the surface of the conductive spherical particles with the fine conductive particles in the form of film.

In the present invention, the average diameter of particles was measured by attaching 100 μm apertures (50 μm apertures for particles with a diameter of 3.0 μm or less) to a multisizer, Type II (Trade name, manufactured by Beckman Coulter, Inc.). The average diameter of conductive particles was measured by attaching a liquid module to a particle-size distribution measuring device LS-130 (trade name, manufactured by Beckman Coulter, Inc.).

As a material adding to a resin layer forming the surface of the developer carrying member according to the present invention to impart conductivity thereto, known fine conductive particles are generally mentioned. Examples of such fine conductive particles include powder of metals such as copper, nickel, silver and aluminum and alloys thereof; fine conductive powders of metal oxides such as antimony oxide, indium oxide, tin oxide and titanium oxide, and fine conductive powder of a carbonaceous materials such as carbon fiber, carbon black and graphite. The addition amount of the fine conductive powder varies depending upon the developing system. For example, when a single-component insulative developer is used by a jumping developing method, the fine conductive powder is preferably added such that the volume resistant value of the conductive resin layer is 10³ Ω·cm or less. Carbon black, especially, conductive amorphous carbon, is preferably used since, due to excellent electric conductivity, it can impart conductivity by a smaller addition amount than other substances, and arbitrary resistivity can be obtained more or less by controlling the addition amount.

Next, a developer to be carried on the surface of the developer carrying member of the present invention having the aforementioned structure will be explained. Toner composing the developer formed by melting and kneading a binder resin, mold-releasing agent, a charge controlling agent, and a coloring agent, solidifying, pulverizing, and sizing. Therefore, toner is colored resin fine powder having a uniform particle size distribution. As the binder resin to be used in toner, use may be generally made of a known resin. Examples of such a known resin include monomers of styrene and monomer of substituted styrene such as α-methylstyrene, and p-chlorostyrene; styrene based copolymers such as styrene-propylene copolymer, styrene-vinyltoluene copolymer, styrene-ethyl acrylate copolymer, styrene-butyl acrylate copolymer, styrene-octyl acrylate copolymer, styrene-dimethylaminoethyl copolymer, styrene-methyl methacrylate copolymer, styrene-ethyl methacrylate copolymer, styrene-butyl methacrylate copolymer, styrene-dimethylaminoethyl methacrylate copolymer, styrene-vinylmethyl ether copolymer, styrene-vinylmethyl ketone copolymer, styrene-butadiene copolymer, styrene-isoprene copolymer, styrene-maleic acid copolymer, and styrene-maleic acid ester copolymer; and polymethylmethacylate, polybutylmethacylate, polyvinyl acetate, polyethylene, polypropylene polyvinylbutyral, polyacrylic resin, rosin, denatured rosin, tempel resin, phenol resin, aliphatic or alicyclic hydrocarbon resins, and aromatic petroleum resins. They can be used singly or in the form of admixture.

Furthermore, toner may contain a pigment as mentioned above as a coloring agent. Examples of such a pigment used herein include carbon black, nigrosin dye, lamp black, Sudan black SM, first yellow G, benzidine yellow, pigment yellow, indo first orange, Irgazin red, paranitroaniline red, toluidine red, carmine FB, permanent Bordeaux FRR, pigment orange R, lithol red 2G, lake red C, rhodamine FB, rhodamine B lake, methyl violet B lake, phthalocyanine blue, pigment blue, brilliant green B, phthalocyanine green, oil yellow GG, Zapon first yellow CGG, Kayaset Y963, Kayaset YG, Zabon first orange RR, oil scarlet, orazole brown B, Zabon first scarlet CG, and oilpink OP.

To prepare magnetic toner, magnetic particles may be contained to toner. As such magnetic particles, mention may be made of a substance that can be magnetized in a magnetic field, including powders of ferromagnetic metals such as iron, cobalt, and nickel, and alloys or compounds of magnetite, hematite, and ferrite. The content of these magnetic powders is preferably 15 to 70% by weight based on the weight of toner.

To improve releasability and fixability during fixation, toner may contain waxes. Examples of such waxes include paraffin wax and derivatives thereof, microcrystalline wax and derivatives thereof, Fischer-Tropsch wax and derivatives thereof, polyolefin wax and derivatives thereof, carnauba wax and derivatives thereof. These derivatives include oxides, block copolymers with a vinyl monomer and graft-modified substances. Other than this, use may be made of alcohols, aliphatic acids, acid amides, esters, ketones, cured castor oil and derivatives thereof, vegetable waxes, animal waxes, mineral waxes, petrolactam, and the like.

Furthermore, if necessary, a charge control agent may be added to toner. The charge control agents are classified into negative charge control agents and positive charge control agents. As the substance for maintaining a toner negatively charged, the following substances may be mentioned. Effective negative charge control agents include organic metal complexes and chelate compounds. Examples of such metal complexes include monoazo metal complexes, acetylacetone metal complexes, aromatic hydroxy carboxylic acid, and aromatic dicarboxylic acid. As other substances for a control agent, use may be also made of aromatic hydroxycarboxylic acids, aromatic mono- and poly-carboxylic acids, and metal salts, anhydrides, esters thereof, and phenol derivatives such as bisphenol, etc.

Examples of the substance for making a toner positively charged include modified substances with nigrosine and modified nigrosine with an fatty acid metal salt or the like, quaternary ammonium salts such as benzyl tributyl ammonium-1-hydroxy-4-naphtosulfonate, and tetrabutylammonium tetrafluoroborate, and analogues thereof including onium salts such as phosphonium salts, and lake (metallo-organic) pigments (as an agent for forming a lake pigment, phosphotungstic acid, phosphomolybdic acid, phosphotungsto-molybdic acid, tannic acid, lauric acid, gallic acid, ferricyanide and ferrocyanide); metal salts of a higher fatty acid; diorganotin oxides such as dibutyltin oxide, dioctyltin oxide and dicyclohexyltin oxide; diorganotin borates such as dibutyltin borate, dioctyltin borate, dicyclohexyltin borate; guanidine compounds; and imidazole compounds.

To improve flowability, if necessary, fine powder such as fine inorganic powder may be added to toner. Examples of such fine powder used herein include fine silica powder; and fine inorganic powders of metal oxides such as alumina, titania, germanium oxide and zirconium oxide; carbides such as silicone carbide and titanium carbide, and nitrides such as silicone nitride and germanium nitride. Furthermore, these fine powders may be treated with organic substances such as an organic silicone compound and a titanium coupling agent before use. Examples of such an organic silicone compound used herein include hexamethyldisilazane, trimethylsilane, trimethylchlorosilane, trimethylethoxysilane, dimethyldichlorosilane, methyltrichlorosilane, allyldimethylchlorosilane, allylphenyldichlorosilane, benzyldimethylchlorosilane, brommethyldimethylchlorosilane, α-chloroethyltrichlorosilane, β-chloroethyltrichlorosilane, chloromethyldimethylchlorosilane, triorganosilylmercaptane, trimethylsilylmercaptane, triorganosilylacrylate, vinyldimethylacetoxysilane, dimethylethoxysilane, dimethyldimethoxysilane, diphenyldiethoxysilane, hexamethyldisiloxane, 1,3-divinyltetramethyldisiloxane, 1,3-diphenyltetramethyldisiloxane and dimethylpolysiloxane having 2 to 12 siloxane units per molecule and a hydroxyl group bonded to Si of each of the terminal units.

Furthermore, crude fine powder may be treated with a silane coupling agent containing nitrogen before use. The fine powder thus treated is effective in the case of a positoner. Examples of such a treatment agent (coupling agent) include aminopropyltrimethoxysilane, aminopropyltriethoxysilane, dimethylaminopropyltrimethoxysilane, diethylaminopropyltrimethoxysilane, dipropylaminopropyltrimethoxysilane, dibutylaminopropyltrimethoxysilane, monobutylaminopropyltrimethoxysilane, dioctylaminopropyltrimethoxysilane, dibutylaminopropyldimethoxysilane, dibutylaminopropylmonomethoxysilane, dimethylaminophenyltrimethoxysilane, trimethoxysilyl-γ-propylphenylamine, trimethoxysilyl-γ-propylbenzylamine, trimethoxysilyl-γ-propylpiperidine, trimethoxysilyl-γ-propylmorpholine, and trimethoxysilyl-γ-propylimidazole.

As a method of treating fine inorganic powder with such a silane coupling agent as mentioned above, there are 1) spray method, 2) organic solvent method, and 3) aqueous solution method. A treatment by the spray method is performed by stirring a pigment, spraying an aqueous solution and a solvent solution of a coupling agent to the pigment thus stirred, followed by removing water or the solvent by a dehydration step performed at about 120 to 130° C. A treatment by the organic solvent method is performed by dissolving a coupling agent in an organic solvent (e.g., alcohol, benzene or halogenated hydrocarbon) containing a small amount of water and a hydrolysis catalyst, soaking a pigment in the resultant solvent solution, performing solid liquid separation by means of filtration or compression, followed by dehydrating at about 120 to 130° C. The aqueous solution method is performed by hydrolyzing a coupling agent of about 0.5% in water having a predetermined pH value or in a water-organic solvent, soaking a pigment in the resultant solution, performing the same solid liquid separation, and subjecting a dehydration step.

In other organic treatment methods, fine powder treated with silicone oil can be used. Silicone oil to be used herein is preferably has a viscosity (at 25° C.) of about 0.5 to 10,000 mm²/s, more preferably, 1 to 1,000 mm²/s. Examples of such silicone oil include methylhydrodienesilicone oil, dimethylsilicone oil, phenylmethylsilicone oil, chlorophenylmethylsilicone oil, alkyl-modified silicone oil, fatty acid modified silicone oil, polyoxyalkylene modified silicone oil, and fluorine-modified silicone oil. Besides these, silicone oil having a nitrogen atom at the side chain may be used.

In the case of a positoner, the positoner treated with an organic substance such as silicone oil is preferably used. The treatment with silicone oil is easily performed, for example, as follows. A pigment is vigorously stirred while heating if necessary, and silicone oil or a solution thereof is sprayed directly or in a vaporized state to the pigment as mentioned above. Alternatively, a slurry of a pigment is prepared, and silicone oil or a solution thereof is added dropwise while stirring the slurry. These silicone oils may be used singly or in the form of admixture of two or more types, or used in combination or after applying various treatments. Alternatively, they may be used together with a silane coupling treatment.

Toner formed in the aforementioned manner is preferably subjected to rounding treatment and surface smoothing treatment of the particles since the performance of transferring toner particles is improved. The rounding treatment and surface smoothing treatment are performed in an apparatus having a stirring vane or blade and a liner or casing. These treatments are performed by a method of mechanically smoothing the surface of toner particles and rounding toner particles while the particles are allowed to pass through a small slit formed between a blade and a liner, a method of rounding toner particles by suspending them in hot water, or a method of rounding toner particles by exposing them to hot air flow.

Spherical toners are formed by, for example, a method comprising suspending in water a mixture containing monomers, which is a raw material for a binder resin of a toner, as a main ingredient and polymerizing the monomers. As a general method comprises evenly dissolving or dispersing a polymerizable monomer, colorant, and polymerization initiator, and further, adding a crosslinking agent, charge control agent, releasing agent and other additives as needed to prepare a polymerizable monomer composition, and dispersing the polymerizable monomer composition in a continuous layer, for example, a water phase, containing a dispersion stabilizer, by use of an appropriate stirrer until particles have an appropriate particle diameter, followed by performing a polymerization reaction, to obtain toner composed of toner particles having a desired particle diameter.

Next, an example of a development apparatus according to the present invention in which the developer carrying member of the present invention capable of exhibiting excellent effects as mentioned above is installed, will be explained with reference to the drawings.

The development apparatus according to the present invention is used for visualizing a latent image formed on a latent image bearing member by means of a developer in a developing region by supplying a developer contained in a developer container onto on the developer carrying member, and transporting the developer to the developing region which faces the latent image bearing member while forming a thin layer of the developer by a developer thickness regulating member on the developer carrying member. The development apparatus of the present invention has such a developer carrying member.

FIGURE shows a schematic view showing a structure of a development apparatus of the present invention. In FIGURE, an electrostatic latent image bearing member for carrying an electrostatic latent image formed in a known process, for example, an eletrophotographic conductor drum 7, is rotated in the direction shown by arrow B. A developing sleeve 14, which is a developer carrying member having a resin layer 13 formed in the outer periphery of a cylindrical substrate 12, carries magnetic toner 10, which is a single component magnetic developer, supplied by a hopper 9 and rotates in the direction shown by arrow A to transport the magnetic toner 10 to a developing section D (developing region), at which the developing sleeve 14 and the photosensitive drum 7 face each other. In the developing sleeve 14, a magnet 11 is arranged for magnetically attracting and holding the magnetic toner 10 on the developing sleeve 14. Such magnetic toner 10 carried on the developing sleeve 14 is charged by friction with the developing sleeve 14. The latent image formed on the photosensitive drum 7 can be developed by the magnetic toner 10 thus charged.

Furthermore, in the development apparatus shown in FIGURE, to regulate the layer thickness of the magnetic toner 10 fed to the developing section D, a regulation blade 8 is provided. The regulation blade 8 is a developer layer thickness regulating member formed of a ferromagnetic metal and hanged on the hopper 9 downward so as to face the developing sleeve 14, with a gap width of about 200 to 300 μm from the surface of the developing sleeve 14. As a result, magnetic fluxes from a magnetic pole N1 of the magnet 11 placed within the developing sleeve 14 are converged to the regulating blade 8, thereby forming the thin layer of the magnetic toner 10 on the developing sleeve 14. Note that a nonmagnetic blade may be used as the regulating blade 8. The magnetic toner 10 in the hopper 9 is stirred by a stirrer 16.

In the present invention, the thickness of the thin layer of the magnetic toner 10 formed on the developing sleeve 14 as mentioned above is preferred to be further thinner than the lowermost size of the gap between the developing sleeve 14 and the photosensitive drum 7 in the developing section D. The present invention is particularly effective to apply to a development apparatus having a system in which an electrostatic latent image is developed by such a toner thin layer, namely, a non-contact type development apparatus. Needless to say, the present invention can be applied to a development apparatus having the toner layer thicker than the lowermost size of the gap between the developing sleeve 14 and the photoconductive drum 7, namely, a contact type development apparatus. The non-contact type development apparatus will be described below as an example for the brevity's sake.

In the developing sleeve 14 having the aforementioned structure and suitably used in the present invention, a developing bias voltage is applied by a power source 15 to scatter the magnetic toner 10 carried on the surface of the developing sleeve 14. When direct current voltage is used as the developing bias voltage, the voltage corresponding the difference between the potential of an image portion of an electrostatic latent image (the region to be visualized by adhesion of the magnetic toner 10) and the background portion thereof is preferably applied to the developing sleeve 14. On the other hand, to improve the density or the tone of a developed image, alternating bias voltage is applied to the developing sleeve 14 to form a vibration electric field whose direction is alternately inverted, in the developing section D. In this case, alternating bias voltage to which a direct current voltage component having a value corresponding to the difference in potential between the image portion and the background portion is superimposed, may be preferably applied to the developing sleeve 14.

It is preferable that in a so-called normal developing where a latent image is visualized by adhering toner to the high potential portion of the electrostatic latent image having high and low potential portions, toner charged with an opposite polarity to that of the latent image is used, on the other hand, in a so-called inverted development where a latent image is visualized by adhering toner to the low potential portion of the electrostatic latent image toner charged with the same polarity as that of the electrostatic latent image is used. Note that terms of high potential and low potential are based on absolute values. In either case, the magnetic toner 10 is charged with a polarity useful for developing an electrostatic latent image, by means of friction with the developing sleeve 14. Silica added to the magnetic toner 10 is charged by means of friction with the developing sleeve 14. Reference numeral 16 represents a stirrer.

### EXAMPLE

Hereinafter, the present invention is described in detail by means of Examples. “Part(s).” in Preparation Examples and Examples all means “part(s) by weight”. First, methods of producing polyhydroxyalkanoate used in the Examples are described below (Preparation Examples A to 2P).

### Preparation Example A-1

[synthesis of polyhydroxyalkanoate using 3,6-di(3-butenyl)-1,4-dioxane-2,5-dione and L-lactide]

A polymerization ampoule was charged with 0.11 g (0.5 mmol) of 3,6-di(3-butenyl)-1,4-dioxane-2,5-dione, 0.65 g (4.5 mmol) of L-lactide and 2 ml of a 0.01 M solution of tin octylate (tin 2-ethylhexanoate) in toluene and 2 ml of a 0.01 M p-tert-butylbenzyl alcohol toluene solution. After drying under reduced pressure for 1 hour and replacing the inside air with nitrogen, heat sealing was conducted under reduced pressure and the system was heated to 150° C. to conduct ring-opening polymerization. After 1 hour, the reaction was terminated and the system was cooled. The obtained polymer was dissolved in chloroform and re-precipitated in methanol in an amount 10 times the amount of chloroform needed for dissolving the polymer. The precipitate was collected and dried under reduced pressure to give 0.63 g of a polymer.

To identify the structure of the obtained polymer, NMR analysis was conducted under the following conditions.

<Measuring Instrument>

FT-NMR: Bruker DPX400 (commercial name)

resonance frequency: ¹H=400 MHz

<Measuring Condition>

measured nuclides: ¹H

solvent used: TMS/CDCl₃

measured temperature: room temperature

As a result, the polymer was confirmed to be a polyhydroxyalkanoate copolymer containing units represented by the following formula (24) as monomer units. The ratio of the monomer units was confirmed to be 9% by mole of unit A and 91% by mole of unit B.

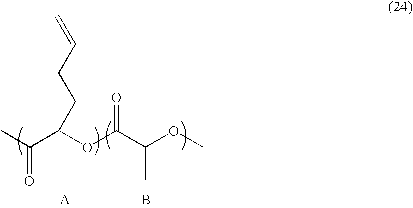

The average molecular weight of the obtained polyhydroxyalkanoate was evaluated by gel permeation chromatography (GPC: HLC-8220 (commercial name) available from Tosoh Corporation, column: TSK-GEL Super HM-H (commercial name) available from Tosoh Corporation, solvent: chloroform, converted to polystyrene). As a result, the number average molecular weight was Mn=18200, and the weight average molecular weight was Mw=24000.

### Preparation Example A-2

Oxidation reaction of polyhydroxyalkanoate containing units represented by the formula (24) synthesized in Preparation Example A-1

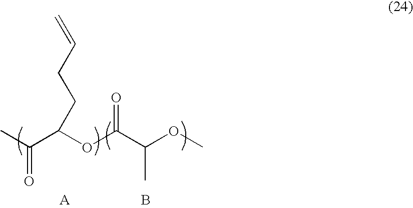

0.50 g of the polyhydroxyalkanoate copolymer containing units represented by the formula (24) (A: 9% by mole, B: 91% by mole) obtained in Preparation Example A-1 was put in a round-bottomed flask, and 30 ml of acetone was added thereto to dissolve the copolymer. The flask was put in an ice bath, and to the flask were added 5 ml of acetic acid and 0.47 g of 18-crown-6-ether, followed by stirring. Thereto was then gradually added 0.38 g of potassium permanganate in the ice bath, followed by stirring in the ice bath for 2 hours, and additional stirring was conducted at room temperature for 18 hours. After completion of the reaction, 60 ml of ethyl acetate was added and 45 ml of water was further added. Sodium bisulfite was then added thereto until peracid was removed. The pH of the solution was then adjusted to pH 1 using 1.0N hydrochloric acid. The organic layer was extracted and washed with 1.0N hydrochloric acid three times. After recovering the organic layer, the solvent was removed to recover a crude polymer. Washing was then conducted with 50 ml of water and 50 ml of methanol, and further with 50 ml of water three times to recover a polymer. The polymer was then dissolved in 3 ml of THF and re-precipitated in methanol in an amount 50 times the amount of THF needed for dissolving the polymer. The precipitate was collected and dried under reduced pressure to give 0.44 g of a polymer.

To identify the structure of the obtained polymer, NMR analysis was conducted under the same conditions as in Preparation Example A-1, and the polymer was confirmed to be a polyhydroxyalkanoate containing units represented by the following formula (25) as monomer units.

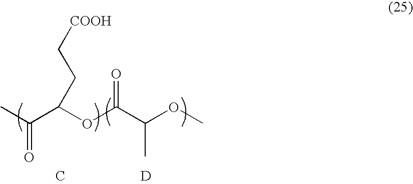

The average molecular weight of the obtained polyhydroxyalkanoate was evaluated by gel permeation chromatography (GPC: HLC-8220 (commercial name) available from Tosoh Corporation, column: TSK-GEL Super HM-H (commercial name) available from Tosoh Corporation, solvent: chloroform, converted to polystyrene). As a result, the number average molecular weight was Mn=13200 and the weight average molecular weight was Mw=18200.

Further, the units of the obtained polyhydroxyalkanoate were calculated by converting carboxyl groups at side chain terminals of polyhydroxyalkanoate to methyl ester using trimethylsilyldiazomethane.

30 mg of the intended polyhydroxyalkanoate was put in a 100 ml round-bottomed flask, and 2.1 ml of chloroform and 0.7 ml of methanol were added thereto to dissolve it. Thereto was added 0.5 ml of a 2 mol/L hexane solution of trimethylsilyldiazomethane and stirring was conducted at room temperature for 1 hour. After completion of the reaction, the solvent was removed to recover the polymer. After washing with 50 ml of methanol, the polymer was recovered. Drying was conducted under reduced pressure to give 31 mg of polyhydroxyalkanoate.

NMR analysis was conducted by using the same procedure as in Preparation Example A-1. As a result, regarding the unit ratio of the polyhydroxyalkanoate containing units represented by the formula (25), the polymer was confirmed to be a copolymer containing 8% by mole of unit C and 92% by mole of unit D.

### Preparation Example A-3

Condensation reaction of polyhydroxyalkanoate containing units represented by the formula (25) synthesized in Preparation Example A-2 and 2-aminobenzenesulfonic acid

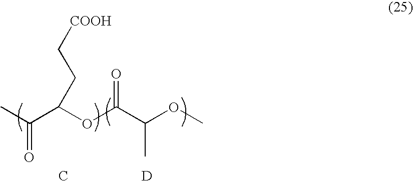

In a 100 ml three-neck flask were placed in a nitrogen atmosphere 0.40 g of the polyhydroxyalkanoate copolymer containing units represented by the formula (25) (C: 8% by mole, D: 92% by mole) obtained in Preparation Example A-2 and 0.36 g of 2-aminobenzenesulfonic acid. After adding 15.0 ml of pyridine thereto and stirring, 1.09 ml of triphenyl phosphite was added thereto, followed by heating at 120° C. for 6 hours. After completion of the reaction, the resultant was re-precipitated in 150 ml of ethanol and recovered. The obtained polymer was washed by using 1N hydrochloric acid for 1 day and then washed by stirring in water for 1 day, followed by drying under reduced pressure to give 0.32 g of a polymer.

To determine the structure of the obtained polymer, analysis was conducted by ¹H-NMR (FT-NMR: Bruker DPX400 (commercial name); resonance frequency: 400 MHz; measured nuclides: ¹H; solvent used: DMSO-d₆; measured temperature: room temperature) and Fourier transform infrared absorption (FT-IR) spectrum (Nicolet AVATAR360FT-IR (commercial name)). As a result of the IR measurement, the 1695 cm⁻¹ peak attributable to carboxylic acid was decreased, and a new peak attributable to amide groups was found at 1658 cm⁻¹.

From the result of ¹H-NMR, the obtained polymer was confirmed to be polyhydroxyalkanoate containing units represented by the following formula (26) as monomer units, because the peak attributable to the aromatic ring in the 2-aminobenzenesulfonic acid structure was shifted.

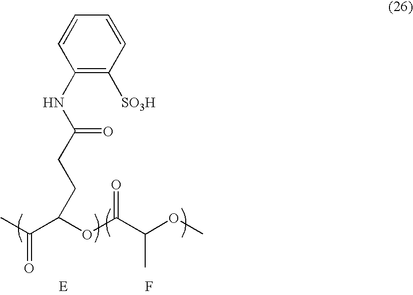

Regarding the unit ratio of the polyhydroxyalkanoate containing units represented by the formula (26), the polymer was confirmed to be a copolymer containing 8% by mole of unit E and 92% by mole of unit F.

The average molecular weight of the obtained polymer was evaluated by gel permeation chromatography (GPC: HLC-8120 (commercial name) available from Tosoh Corporation, column: PLgel 5μ MIXED-C (commercial name) available from Polymer Laboratories, solvent: DMF/LiBr 0.1% (w/v), converted to polystyrene). As a result, the number average molecular weight was Mn=11300 and the weight average molecular weight was Mw=16000.

### Preparation Example A-4

Esterification reaction of polyhydroxyalkanoate containing units represented by the formula (26) synthesized in Preparation Example A-3

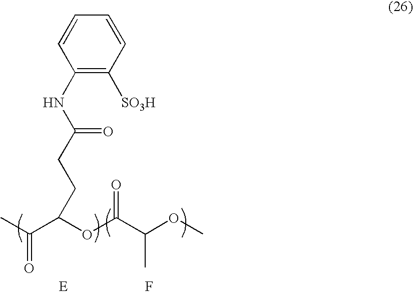

0.30 g of the polyhydroxyalkanoate copolymer containing units represented by the formula (26) (E: 8% by mole, F: 92% by mole) obtained in Preparation Example A-3 was put in a round-bottomed flask, and 21.0 ml of chloroform and 7.0 ml of methanol were added thereto to dissolve the copolymer, and the mixture was cooled to 0° C. Thereto was added 1.35 ml of a 2 mol/L hexane solution of trimethylsilyldiazomethane (available from Sigma-Aldrich Corporation), and stirring was conducted for 4 hours. After completion of the reaction, the solvent was removed by an evaporator to recover a polymer.

Further, 21.0 ml of chloroform and 7.0 ml of methanol were added thereto to re-dissolve the polymer and the solvent was removed by an evaporator. This procedure was repeated three times. The polymer recovered at this stage was dried under reduced pressure to give 0.30 g of a polymer.

To determine the structure of the obtained polymer, analysis was conducted by ¹H-NMR (FT-NMR: Bruker DPX400 (commercial name); resonance frequency: 400 MHz; measured nuclides: ¹H; solvent used: DMSO-d₆; measured temperature: room temperature). From the result of ¹H-NMR, the obtained polymer was confirmed to be polyhydroxyalkanoate containing units represented by the following formula (27) as monomer units, because a peak attributable to methyl sulfonate was found at 3 to 4 ppm.

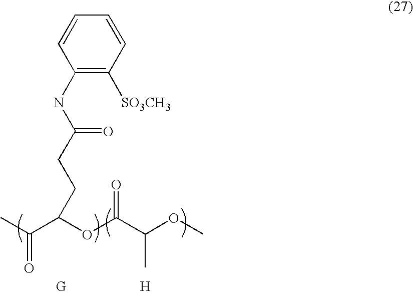

Regarding the unit ratio of the polyhydroxyalkanoate containing units represented by the formula (27), the polymer was confirmed to be a copolymer containing 8% by mole of unit G and 92% by mole of unit H.

No peak attributable to sulfonic acid was found by acid value titration using Automatic Potentiometric Titrator AT510 (commercial name, made by Kyoto Electronics Manufacturing Co., Ltd.), which also proved that sulfonic acid was converted to methyl sulfonate.

The average molecular weight of the obtained polymer was evaluated by gel permeation chromatography (GPC: HLC-8120 (commercial name) available from Tosoh Corporation, column: PLgel 5μ MIXED-C (commercial name) available from Polymer Laboratories, solvent: DMF/LiBr 0.1% (w/v), converted to polystyrene). As a result, the number average molecular weight was Mn=10900 and the weight average molecular weight was Mw=15600.

The scales of these procedures were increased to produce a large amount of polyhydroxyalkanoate containing units represented by the formula (27), which was named as copolymer (A).

### Preparation Example B-1

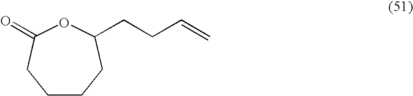 [synthesis of polyhydroxyalkanoate using 7-(3-butenyl)-2-oxepanone represented by the formula (51) and L-lactide]

A polymerization ampoule was charged with 0.34 g (2.0 mmol) of 7-(3-butenyl)-2-oxepanone, 1.15 g (8.0 mmol) of L-lactide, 20 μl of a 2M di-iso-propylzinc toluene solution and 8 ml of a 0.01M p-tert-butylbenzyl alcohol toluene solution. After drying under reduced pressure for 1 hour and replacing the inside air with nitrogen, heat sealing was conducted under reduced pressure and the system was heated to 150° C. to conduct ring-opening polymerization. After 10 hour, the reaction was terminated and the system was cooled. The obtained polymer was dissolved in chloroform and re-precipitated in methanol in an amount 10 times the amount of chloroform needed for dissolving the polymer. The precipitate was collected and dried under reduced pressure to give 1.05 g of a polymer.

To identify the structure of the obtained polymer, NMR analysis was conducted under the same conditions as in Preparation Example A-1, and the polymer was confirmed to be a polyhydroxyalkanoate copolymer containing units represented by the following formula (52) as monomer units. The ratio of the monomer units was confirmed to be 8% by mole of unit A and 92% by mole of unit B.

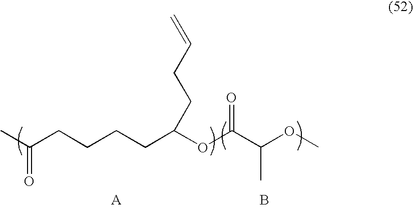

The average molecular weight of the obtained polyhydroxyalkanoate was evaluated by gel permeation chromatography (GPC: HLC-8220 (commercial name) available from Tosoh Corporation, column: TSK-GEL Super HM-H (commercial name) available from Tosoh Corporation, solvent: chloroform, converted to polystyrene). As a result, the number average molecular weight was Mn=43500, and the weight average molecular weight was Mw=67400.

### Preparation Example B-2

Oxidation reaction of polyhydroxyalkanoate containing units represented by the formula (52) synthesized in Preparation Example B-1

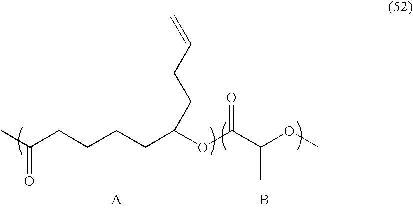

0.50 g of the polyhydroxyalkanoate copolymer containing units represented by the formula (52) (A: 8% by mole, B: 92% by mole) obtained in Preparation Example B-1 was put in a round-bottomed flask, and 30 ml of acetone was added thereto to dissolve the copolymer. The flask was put in an ice bath, and to the flask were added 5 ml of acetic acid and 0.40 g of 18-crown-6-ether, followed by stirring. Thereto was then gradually added 0.32 g of potassium permanganate in the ice bath, followed by stirring in the ice bath for 2 hours, and additional stirring was conducted at room temperature for 18 hours. After completion of the reaction, 60 ml of ethyl acetate was added and 45 ml of water was further added. Sodium bisulfite was then added thereto until peracid was removed. The pH of the solution was then adjusted to pH 1 using 1.0N hydrochloric acid. The organic layer was extracted and washed with 1.0N hydrochloric acid three times. After recovering the organic layer, the solvent was removed to recover a crude polymer. Washing was then conducted with 50 ml of water and 50 ml of methanol, and further with 50 ml of water three times to recover a polymer. The polymer was then dissolved in THF and re-precipitated in methanol in an amount 50 times the amount of THF needed for dissolving the polymer. The precipitate was collected and dried under reduced pressure to give 0.44 g of a polymer.

To identify the structure of the obtained polymer, NMR analysis was conducted under the same conditions as in Preparation Example A-1, and the polymer was confirmed to be a polyhydroxyalkanoate containing units represented by the following formula (53) as monomer units.

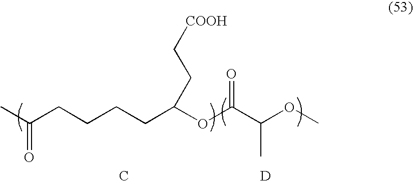

The average molecular weight of the obtained polyhydroxyalkanoate was evaluated by gel permeation chromatography (GPC: HLC-8220 (commercial name) available from Tosoh Corporation, column: TSK-GEL Super HM-H (commercial name) available from Tosoh Corporation, solvent: chloroform, converted to polystyrene). As a result, the number average molecular weight was Mn=37500 and the weight average molecular weight was Mw=59600.

Further, the units of the obtained polyhydroxyalkanoate were calculated by converting carboxyl groups at side chain terminals of polyhydroxyalkanoate to methyl ester using trimethylsilyldiazomethane.

30 mg of the intended polyhydroxyalkanoate was put in a 100 ml round-bottomed flask, and 2.1 ml of chloroform and 0.7 ml of methanol were added thereto to dissolve it. Thereto was added 0.5 ml of a 2 mol/L hexane solution of trimethylsilyldiazomethane and stirring was conducted at room temperature for 1 hour. After completion of the reaction, the solvent was removed to recover the polymer. After washing the polymer with 50 ml of methanol, the polymer was recovered. Drying was conducted under reduced pressure to give 28 mg of polyhydroxyalkanoate.

NMR analysis was conducted by using the same procedure as in Preparation Example A-1. As a result, regarding the unit ratio of the polyhydroxyalkanoate containing units represented by the formula (53), the polymer was confirmed to be a copolymer containing 8% by mole of unit C and 92% by mole of unit D.

### Preparation Example B-3

Condensation reaction of polyhydroxyalkanoate containing units represented by the formula (53) synthesized in Preparation Example B-2 and 2-amino-2-methylpropanesulfonic acid

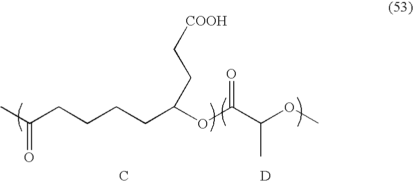

In a 100 ml three-neck flask were placed in a nitrogen atmosphere 0.40 g of the polyhydroxyalkanoate copolymer containing units represented by the formula (53) (C: 8% by mole, D: 92% by mole) obtained in Preparation Example B-2 and 0.30 g of 2-amino-2-methylpropanesulfonic acid. After adding 15.0 ml of pyridine thereto and stirring, 1.03 ml of triphenyl phosphite was added thereto, followed by heating at 120° C. for 6 hours. After completion of the reaction, the resultant was re-precipitated in 150 ml of ethanol and recovered. The obtained polymer was washed by using 1N hydrochloric acid for 1 day and then washed by stirring in water for 1 day, followed by drying under reduced pressure to give 0.32 g of a polymer.

To determine the structure of the obtained polymer, analysis was conducted by ¹H-NMR (FT-NMR: Bruker DPX400 (commercial name); resonance frequency: 400 MHz; measured nuclides: ¹H; solvent used: DMSO-d₆; measured temperature: room temperature) and Fourier transform infrared absorption (FT-IR) spectrum (Nicolet AVATAR360FT-IR (commercial name)). As a result of the IR measurement, the 1695 cm⁻¹ peak attributable to carboxylic acid was decreased, and a new peak attributable to amide groups was found at 1668 cm⁻¹.

From the result of ¹H-NMR, the obtained polymer was confirmed to be polyhydroxyalkanoate containing units represented by the following formula (54) as monomer units, because the peak attributable to methylene in the 2-amino-2-methylpropanesulfonic acid structure was shifted.

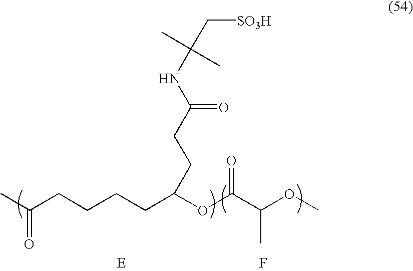

Regarding the unit ratio of the polyhydroxyalkanoate containing units represented by the formula (54), the polymer was confirmed to be a copolymer containing 8% by mole of unit E and 92% by mole of unit F.

The average molecular weight of the obtained polymer was evaluated by gel permeation chromatography (GPC: HLC-8120 (commercial name) available from Tosoh Corporation, column: PLgel 5μ MIXED-C (commercial name) available from Polymer Laboratories, solvent: DMF/LiBr 0.1% (w/v), converted to polystyrene). As a result, the number average molecular weight was Mn=37500 and the weight average molecular weight was Mw=59600.

The scales of these procedures were increased to produce a large amount of polyhydroxyalkanoate containing units represented by the formula (54), which was named as copolymer (B).

### Preparation Example C-1

[synthesis of polyhydroxyalkanoate using 7-oxo-4-oxepane carboxylic acid phenylmethyl ester represented by the formula (89) and L-lactide]

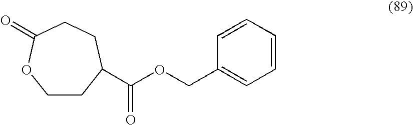

A polymerization ampoule was charged with 2.48 g (10.0 mmol) of 7-oxo-4-oxepane carboxylic acid phenylmethyl ester represented by the formula (89), 7.21 g (50.0 mmol) of L-lactide and 2.4 ml of a 0.1 M tin octylate (tin 2-ethylhexanoate)toluene solution and 2.4 ml of a 0.1 M of p-tert-butylbenzyl alcohol toluene solution. After drying under reduced pressure for 1 hour and replacing the inside air with nitrogen, heat sealing was conducted under reduced pressure and the system was heated to 150° C. to conduct ring-opening polymerization. After 12 hours, the reaction was terminated and the system was cooled. The obtained polymer was dissolved in chloroform and re-precipitated in methanol in an amount 10 times the amount of chloroform needed for dissolving the polymer. The precipitate was collected and dried under reduced pressure to give 7.08 g of a polymer.

To identify the structure of the obtained polymer, NMR analysis was conducted under the same conditions as in Preparation Example A-1, and the polymer was confirmed to be a polyhydroxyalkanoate copolymer containing units represented by the following formula (90) as monomer units. The ratio of the monomer units was confirmed to be 8% by mole of unit A and 92% by mole of unit B.

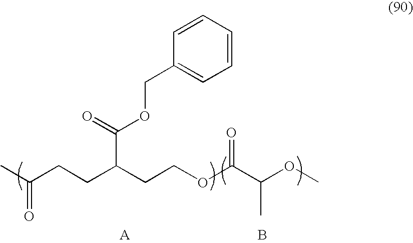

The average molecular weight of the obtained polyhydroxyalkanoate was evaluated by gel permeation chromatography (GPC: HLC-8220 (commercial name) available from Tosoh Corporation, column: TSK-GEL Super HM-H (commercial name) available from Tosoh Corporation, solvent: chloroform, converted to polystyrene). As a result, the number average molecular weight was Mn=10300, and the weight average molecular weight was Mw=14800.

### Preparation Example C-2

In 500 ml of a mixed solvent of dioxane-ethanol (75:25) was dissolved 5.00 g of the polyhydroxyalkanoate copolymer containing units represented by the formula (90) obtained in Preparation Example C-1. Thereto was added 1.10 g of a 5% palladium/carbon catalyst and the reaction system was filled with hydrogen and stirring was conducted at room temperature for 1 day. After completion of the reaction, filtration was conducted using a membrane filter of 0.25 μm to remove the catalyst and the reaction solution was recovered. The solution was concentrated and then dissolved in chloroform, followed by re-precipitation in methanol in an amount 10 times the amount of chloroform. The obtained polymer was recovered and dried under reduced pressure to give 3.70 g of a polymer.

To identify the structure of the obtained polymer, NMR analysis was conducted under the same conditions as in Preparation Example A-1, and the polymer was confirmed to be a polyhydroxyalkanoate copolymer containing units represented by the following formula (91) as monomer units. The ratio of the monomer units was confirmed to be 8% by mole of unit C and 92% by mole of unit D.

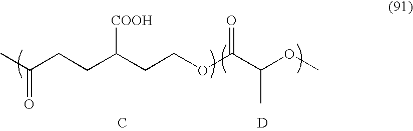

The average molecular weight of the obtained polyhydroxyalkanoate was evaluated by gel permeation chromatography (GPC: HLC-8220 (commercial name) available from Tosoh Corporation, column: TSK-GEL Super HM-H (commercial name) available from Tosoh Corporation, solvent: chloroform, converted to polystyrene). As a result, the number average molecular weight was Mn=9500 and the weight average molecular weight was Mw=12900.

### Preparation Example C-3

Condensation reaction of polyhydroxyalkanoate containing units represented by the formula (91) synthesized in Preparation Example C-2 and 1-naphthylamine-8-sulfonic acid

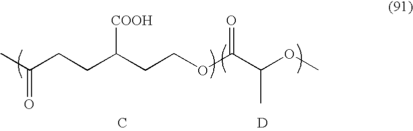

In a 100 ml three-neck flask were placed in a nitrogen atmosphere 0.40 g of the polyhydroxyalkanoate copolymer containing units represented by the formula (91) (C: 8% by mole, D: 92% by mole) obtained in Preparation Example C-2 and 0.45 g of 1-naphthylamine-8-sulfonic acid. After adding 15.0 ml of pyridine thereto and stirring, 1.06 ml of triphenyl phosphite was added thereto, followed by heating at 120° C. for 6 hours. After completion of the reaction, the resultant was re-precipitated in 150 ml of ethanol and recovered. The obtained polymer was washed by using 1N hydrochloric acid for 1 day and then washed by stirring in water for 1 day, followed by drying under reduced pressure to give 0.33 g of a polymer.

To determine the structure of the obtained polymer, analysis was conducted by ¹H-NMR (FT-NMR: Bruker DPX400 (commercial name); resonance frequency: 400 MHz; measured nuclides: ¹H; solvent used: DMSO-d₆; measured temperature: room temperature) and Fourier transform infrared absorption (FT-IR) spectrum (Nicolet AVATAR360FT-IR (commercial name)). As a result of the IR measurement, the 1695 cm⁻¹ peak attributable to carboxylic acid was decreased, and a new peak attributable to amide groups was found at 1658 cm⁻¹.

From the result of ¹H-NMR, the obtained polymer was confirmed to be polyhydroxyalkanoate containing units represented by the following formula (92) as monomer units, because the peak attributable to the aromatic ring in the 1-naphthylamine-8-sulfonic acid structure was shifted.

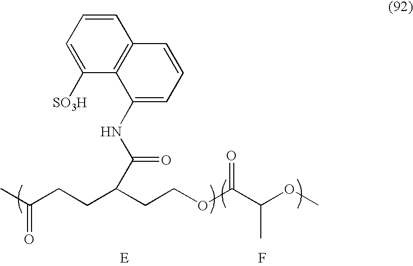

Regarding the unit ratio of the polyhydroxyalkanoate containing units represented by the formula (92), the polymer was confirmed to be a copolymer containing 8% by mole of unit E and 92% by mole of unit F.

The average molecular weight of the obtained polymer was evaluated by gel permeation chromatography (GPC: HLC-8120 (commercial name) available from Tosoh Corporation, column: PLgel 5μ MIXED-C (commercial name) available from Polymer Laboratories, solvent: DMF/LiBr 0.1% (w/v), converted to polystyrene). As a result, the number average molecular weight was Mn=8200 and the weight average molecular weight was Mw=12400.

### Preparation Example C-4

Esterification reaction of polyhydroxyalkanoate containing units represented by the formula (92) synthesized in Preparation Example C-3

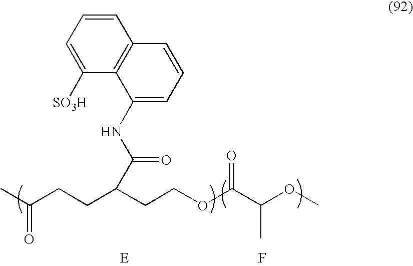

0.30 g of the polyhydroxyalkanoate copolymer containing units represented by the formula (92) (E: 8% by mole, F: 92% by mole) obtained in Preparation Example C-3 was put in a round-bottomed flask, and 21.0 ml of chloroform and 7.0 ml of methanol were added thereto to dissolve the copolymer, and the mixture was cooled to 0° C. Thereto was added 1.34 ml of a 2 mol/L hexane solution of trimethylsilyldiazomethane (available from Sigma-Aldrich Corporation), and stirring was conducted for 4 hours. After completion of the reaction, the solvent was removed by an evaporator to recover a polymer.

Further, 21.0 ml of chloroform and 7.0 ml of methanol were added thereto to re-dissolve the polymer and the solvent was removed by an evaporator. This procedure was repeated three times.

The polymer recovered at this stage was dried under reduced pressure to give 0.30 g of a polymer.

To determine the structure of the obtained polymer, analysis was conducted by ¹H-NMR (FT-NMR: Bruker DPX400 (commercial name); resonance frequency: 400 MHz; measured nuclides: ¹H; solvent used: DMSO-d₆; measured temperature: room temperature). From the result of ¹H-NMR, the obtained polymer was confirmed to be polyhydroxyalkanoate containing units represented by the following formula (93) as monomer units, because a peak attributable to methyl sulfonate was found at 3 to 4 ppm.

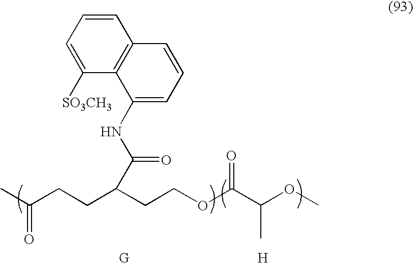

Regarding the unit ratio of the polyhydroxyalkanoate containing units represented by the formula (93), the polymer was confirmed to be a copolymer containing 8% by mole of unit G and 92% by mole of unit H.

No peak attributable to sulfonic acid was found by acid value titration using Automatic Potentiometric Titrator AT510 (commercial name, made by Kyoto Electronics Manufacturing Co., Ltd.), which also proved that sulfonic acid was converted to methyl sulfonate.

The average molecular weight of the obtained polymer was evaluated by gel permeation chromatography (GPC: HLC-8120 (commercial name) available from Tosoh Corporation, column: PLgel 5μ MIXED-C (commercial name) available from Polymer Laboratories, solvent: DMF/LiBr 0.1% (w/v), converted to polystyrene). As a result, the number average molecular weight was Mn=7500 and the weight average molecular weight was Mw=11400.

The scales of these procedures were increased to produce a large amount of polyhydroxyalkanoate containing units represented by the formula (93), which was named as copolymer (C).

### Preparation Example D-1

[synthesis of polyhydroxyalkanoate using tetrahydro-3-(2-propenyl)-2H-pyran-2-one and mandelide]

A polymerization ampoule was charged with 0.28 g (2.0 mmol) of tetrahydro-3-(2-propenyl)-2H-pyran-2-one, 2.68 g (10 mmol) of mandelide, 4.8 ml of a 0.01 M tin octylate (tin 2-ethylhexanoate)toluene solution and 4.8 ml of a 0.01 M p-tert-butylbenzyl alcohol toluene solution. After drying under reduced pressure for 1 hour and replacing the inside air with nitrogen, heat sealing was conducted under reduced pressure and the system was heated to 150° C. to conduct ring-opening polymerization. After 10 hours, the reaction was terminated and the system was cooled. The obtained polymer was dissolved in chloroform and re-precipitated in methanol in an amount 10 times the amount of chloroform needed for dissolving the polymer. The precipitate was collected and dried under reduced pressure to give 2.06 g of a polymer.

To identify the structure of the obtained polymer, NMR analysis was conducted under the same conditions as in Preparation Example A-1, and the polymer was confirmed to be a polyhydroxyalkanoate copolymer containing units represented by the following formula (73) as monomer units. The ratio of the monomer units was confirmed to be 12% by mole of unit A and 88% by mole of unit B.

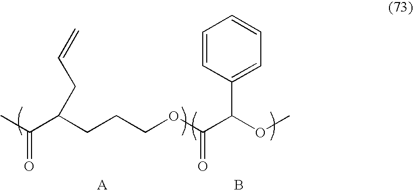

The average molecular weight of the obtained polyhydroxyalkanoate was evaluated by gel permeation chromatography (GPC: HLC-8220 (commercial name) available from Tosoh Corporation, column: TSK-GEL Super HM-H (commercial name) available from Tosoh Corporation, solvent: chloroform, converted to polystyrene). As a result, the number average molecular weight was Mn=48000, and the weight average molecular weight was Mw=97200.

### Preparation Example D-2

Oxidation reaction of polyhydroxyalkanoate containing units represented by the formula (73) synthesized in Preparation Example D-1

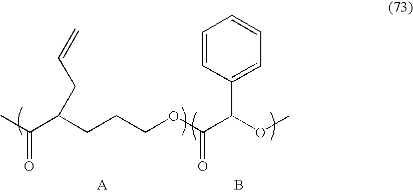

0.50 g of the polyhydroxyalkanoate copolymer containing units represented by the formula (73) (A: 12% by mole, B: 88% by mole) obtained in Preparation Example D-1 was put in a round-bottomed flask, and 30 ml of acetone was added thereto to dissolve the copolymer. The flask was put in an ice bath, and to the flask were added 5 ml of acetic acid and 0.35 g of 18-crown-6-ether, followed by stirring. Thereto was then gradually added 0.28 g of potassium permanganate in the ice bath, followed by stirring in the ice bath for 2 hours, and additional stirring was conducted at room temperature for 18 hours. After completion of the reaction, 60 ml of ethyl acetate was added and 45 ml of water was further added. Sodium bisulfite was then added thereto until peracid was removed. The pH of the solution was then adjusted to pH 1 using 1.0N hydrochloric acid. The organic layer was extracted and washed with 1.0N hydrochloric acid three times. After recovering the organic layer, the solvent was removed to recover a crude polymer. Washing was then conducted with 50 ml of water and 50 ml of methanol, and further with 50 ml of water three times to recover a polymer. The polymer was then dissolved in 3 ml of THF and re-precipitated in methanol in an amount 50 times the amount of THF needed for dissolving the polymer. The precipitate was collected and dried under reduced pressure to give 0.44 g of a polymer.

To identify the structure of the obtained polymer, NMR analysis was conducted under the same conditions as in Preparation Example A-1, and the polymer was confirmed to be polyhydroxyalkanoate containing units represented by the following formula (74) as monomer units.

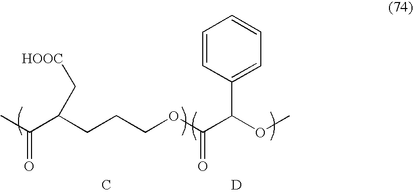

The average molecular weight of the obtained polyhydroxyalkanoate was evaluated by gel permeation chromatography (GPC: HLC-8220 (commercial name) available from Tosoh Corporation, column: TSK-GEL Super HM-H (commercial name) available from Tosoh Corporation, solvent: chloroform, converted to polystyrene). As a result, the number average molecular weight was Mn=38600 and the weight average molecular weight was Mw=69100.

Further, the units of the obtained polyhydroxyalkanoate were calculated by converting carboxyl groups at side chain terminals of polyhydroxyalkanoate to methyl ester using trimethylsilyldiazomethane.

30 mg of the intended polyhydroxyalkanoate was put in a 100 ml round-bottomed flask, and 2.1 ml of chloroform and 0.7 ml of methanol were added thereto to dissolve it. Thereto was added 0.5 ml of a 2 mol/L hexane solution of trimethylsilyldiazomethane and stirring was conducted at room temperature for 1 hour. After completion of the reaction, the solvent was removed to recover the polymer. After washing the polymer with 50 ml of methanol, the polymer was recovered. Drying was conducted under reduced pressure to give 28 mg of polyhydroxyalkanoate.

NMR analysis was conducted by using the same procedure as in Preparation Example A-1. As a result, regarding the unit ratio of the polyhydroxyalkanoate containing units represented by the formula (74), the polymer was confirmed to be a copolymer containing 11% by mole of unit C and 89% by mole of unit D.

The scales of these procedures were increased to produce a large amount of polyhydroxyalkanoate containing units represented by the formula (74), which was named as copolymer (D).

### Preparation Example E-1

[synthesis of polyhydroxyalkanoate using 3-(9-decenyl)-2-oxetanone represented by the formula (65) and L-lactide]

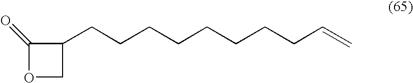

A polymerization ampoule was charged with 0.36 g (2.0 mmol) of 3-(9-decenyl)-2-oxetanone represented by the formula (65), 1.44 g (10.0 mmol) of L-lactide and 4.8 ml of a 0.01 M of tin octylate (tin 2-ethylhexanoate)toluene solution and 4.8 ml of a 0.01 M p-tert-butylbenzyl alcohol toluene solution. After drying under reduced pressure for 1 hour and replacing the inside air with nitrogen, heat sealing was conducted under reduced pressure and the system was heated to 150° C. to conduct ring-opening polymerization. After 12 hours, the reaction was terminated and the system was cooled. The obtained polymer was dissolved in chloroform and re-precipitated in methanol in an amount 10 times the amount of chloroform needed for dissolving the polymer. The precipitate was collected and dried under reduced pressure to give 0.75 g of a polymer.

To identify the structure of the obtained polymer, NMR analysis was conducted under the same conditions as in Preparation Example A-1, and the polymer was confirmed to be a polyhydroxyalkanoate copolymer containing units represented by the following formula (66) as monomer units. The ratio of the monomer units was confirmed to be 4% by mole of unit A and 96% by mole of unit B.

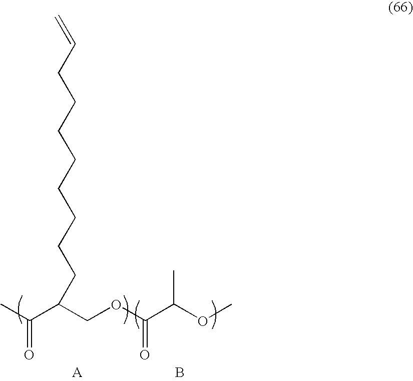

### Preparation Example E-2

Oxidation reaction of polyhydroxyalkanoate containing units represented by the formula (66) synthesized in Preparation Example E-1

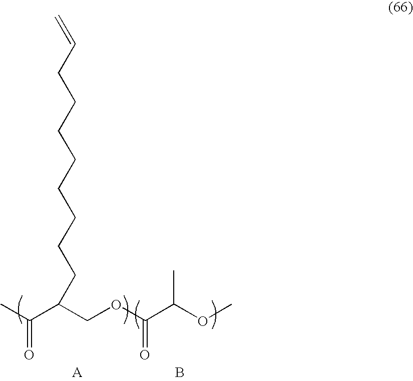

0.50 g of the polyhydroxyalkanoate copolymer containing units represented by the formula (66) (A: 4% by mole, B: 96% by mole) obtained in Preparation Example E-1 was put in a round-bottomed flask, and 30 ml of acetone was added thereto to dissolve the copolymer. The flask was put in an ice bath, and to the flask were added 5 ml of acetic acid and 0.21 g of 18-crown-6-ether, followed by stirring. Thereto was then gradually added 0.17 g of potassium permanganate in the ice bath, followed by stirring in the ice bath for 2 hours, and additional stirring was conducted at room temperature for 18 hours. After completion of the reaction, 60 ml of ethyl acetate was added and 45 ml of water was further added. Sodium bisulfite was then added thereto until peracid was removed. The pH of the solution was then adjusted to pH 1 using 1.0N hydrochloric acid. The organic layer was extracted and washed with 1.0N hydrochloric acid three times. After recovering the organic layer, the solvent was removed to recover a crude polymer. Washing was then conducted with 50 ml of water and 50 ml of methanol, and further with 50 ml of water three times to recover a polymer. The polymer was then dissolved in 3 ml of THF and re-precipitated in methanol in an amount 50 times the amount of THF needed for dissolving the polymer. The precipitate was collected and dried under reduced pressure to give 0.44 g of a polymer.

To identify the structure of the obtained polymer, NMR analysis was conducted under the same conditions as in Preparation Example A-1, and the polymer was confirmed to be polyhydroxyalkanoate containing units represented by the following formula (67) as monomer units.

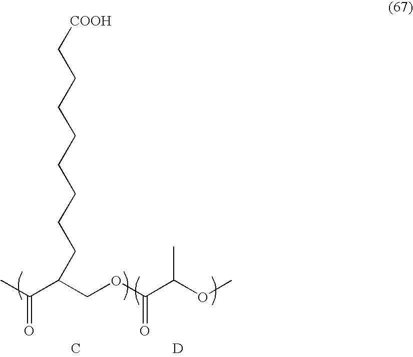

The average molecular weight of the obtained polyhydroxyalkanoate was evaluated by gel permeation chromatography (GPC: HLC-8220 (commercial name) available from Tosoh Corporation, column: TSK-GEL Super. HM-H (commercial name) available from Tosoh Corporation, solvent: chloroform, converted to polystyrene) As a result, the number average molecular weight was Mn=13100 and the weight average molecular weight was Mw=19100.

Further, the units of the obtained polyhydroxyalkanoate were calculated by converting carboxyl groups at side chain terminals of polyhydroxyalkanoate to methyl ester using trimethylsilyldiazomethane.

30 mg of the intended polyhydroxyalkanoate was put in a 100 ml round-bottomed flask, and 2.1 ml of chloroform and 0.7 ml of methanol were added thereto to dissolve it. Thereto was added 0.5 ml of a 2 mol/L hexane solution of trimethylsilyldiazomethane and stirring was conducted at room temperature for 1 hour. After completion of the reaction, the solvent was removed to recover the polymer. After washing the polymer with 50 ml of methanol, the polymer was recovered. Drying was conducted under reduced pressure to give 29 mg of polyhydroxyalkanoate.

NMR analysis was conducted by using the same procedure as in Preparation Example A-1. As a result, regarding the unit ratio of the polyhydroxyalkanoate containing units represented by the formula (67), the polymer was confirmed to be a copolymer containing 4% by mole of unit C and 96% by mole of unit D.

The scales of these procedures were increased to produce a large amount of polyhydroxyalkanoate containing units represented by the formula (67), which was named as copolymer (E).

### Preparation Example F-1

[synthesis of polyhydroxyalkanoate using 3-(2-propenyl)-2-oxepanone represented by the formula (76) and L-lactide]

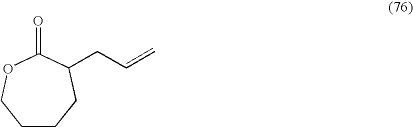

A polymerization ampoule was charged with 0.31 g (2.0 mmol) of 3-(2-propenyl)-2-oxepanone represented by the formula (76), 1.44 g (10.0 mmol) of L-lactide, 4.8 ml of a 0.01 M tin octylate (tin 2-ethylhexanoate)toluene solution and 4.8 ml of a 0.01 M p-tert-butylbenzyl alcohol toluene solution. After drying under reduced pressure for 1 hour and replacing the inside air with nitrogen, heat sealing was conducted under reduced pressure and the system was heated to 150° C. to conduct ring-opening polymerization. After 10 hours, the reaction was terminated and the system was cooled. The obtained polymer was dissolved in chloroform and re-precipitated in methanol in an amount 10 times the amount of chloroform needed for dissolving the polymer. The precipitate was collected and dried under reduced pressure to give 1.32 g of a polymer.

To identify the structure of the obtained polymer, NMR analysis was conducted under the same conditions as in Preparation Example A-1, and the polymer was confirmed to be a polyhydroxyalkanoate copolymer containing units represented by the following formula (77) as monomer units. The ratio of the monomer units was confirmed to be 10% by mole of unit A and 90% by mole of unit B.

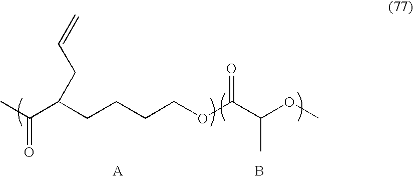

The average molecular weight of the obtained polyhydroxyalkanoate was evaluated by gel permeation chromatography (GPC: HLC-8220 (commercial name) available from Tosoh Corporation, column: TSK-GEL Super HM-H (commercial name) available from Tosoh Corporation, solvent: chloroform, converted to polystyrene). As a result, the number average molecular weight was Mn=132000 and the weight average molecular weight was Mw=220400.

### Preparation Example F-2

Oxidation reaction of polyhydroxyalkanoate containing units represented by the formula (77) synthesized in Preparation Example F-1

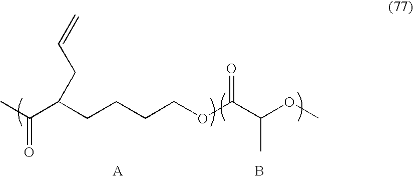

0.50 g of the polyhydroxyalkanoate copolymer containing units represented by the formula (77) (A: 9% by mole, B: 91% by mole) obtained in Preparation Example F-1 was put in a round-bottomed flask, and 30 ml of acetone was added thereto to dissolve the copolymer. The flask was put in an ice bath, and to the flask were added 5 ml of acetic acid and 0.45 g of 18-crown-6-ether, followed by stirring. Thereto was then gradually added 0.36 g of potassium permanganate in the ice bath, followed by stirring in the ice bath for 2 hours, and additional stirring was conducted at room temperature for 18 hours. After completion of the reaction, 60 ml of ethyl acetate was added and 45 ml of water was further added. Sodium bisulfite was then added thereto until peracid was removed. The pH of the solution was then adjusted to pH 1 using 1.0N hydrochloric acid. The organic layer was extracted and washed with 1.0N hydrochloric acid three times. After recovering the organic layer, the solvent was removed to recover a crude polymer. Washing was then conducted with 50 ml of water and 50 ml of methanol, and further with 50 ml of water three times to recover a polymer. The polymer was then dissolved in 3 ml of THF and re-precipitated in methanol in an amount 50 times the amount of THF needed for dissolving the polymer. The precipitate was collected and dried under reduced pressure to give 0.44 g of a polymer.

To identify the structure of the obtained polymer, NMR analysis was conducted under the same conditions as in Preparation Example A-1, and the polymer was confirmed to be polyhydroxyalkanoate containing units represented by the following formula (78) as monomer units.

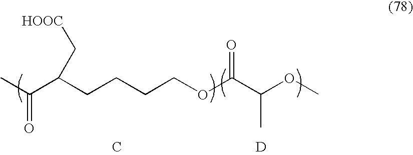

The average molecular weight of the obtained polyhydroxyalkanoate was evaluated by gel permeation chromatography (GPC: HLC-8220 (commercial name) available from Tosoh Corporation, column: TSK-GEL Super HM-H (commercial name) available from Tosoh Corporation, solvent: chloroform, converted to polystyrene). As a result, the number average molecular weight was Mn=115400 and the weight average molecular weight was Mw=202000.

Further, the units of the obtained polyhydroxyalkanoate were calculated by converting carboxyl groups at side chain terminals of polyhydroxyalkanoate to methyl ester using trimethylsilyldiazomethane.

30 mg of the intended polyhydroxyalkanoate was put in a 100 ml round-bottomed flask, and 2.1 ml of chloroform and 0.7 ml of methanol were added thereto to dissolve it. Thereto was added 0.5 ml of a 2 mol/L hexane solution of trimethylsilyldiazomethane and stirring was conducted at room temperature for 1 hour. After completion of the reaction, the solvent was removed to recover the polymer. After washing the polymer with 50 ml of methanol, the polymer was recovered. Drying was conducted under reduced pressure to give 28 mg of polyhydroxyalkanoate.

NMR analysis was conducted by using the same procedure as in Preparation Example A-1. As a result, regarding the unit ratio of the polyhydroxyalkanoate containing units represented by the formula (78), the polymer was confirmed to be a copolymer containing 9% by mole of unit C and 91% by mole of unit D.

The scales of these procedures were increased to produce a large amount of polyhydroxyalkanoate containing units represented by the formula (78), which was named as copolymer (F).

### Preparation Example 2A-1

[synthesis of L-3-(2-benzyloxycarbonyl)ethyl-1,4-dioxane-2,5-dione represented by the formula (79)]

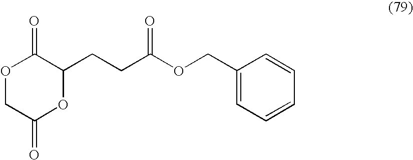

In 200 ml of 80% sulfuric acid was dissolved 20 g of L-glutamic acid. With maintaining the temperature at 70° C., 500 g of benzyl alcohol was added thereto to allow a reaction to give a crude product containing a compound represented by the formula (80) in which a carboxyl group at the γ-position is protected. To 1400 ml of 1N sulfuric acid was added 100 g of the crude product, and with stirring the mixture at 0 to 5° C., 100 ml of an aqueous solution containing 45.2 g of sodium nitrite was added thereto dropwise over about 3 hours and stirring was continued for 30 minutes. Thereto was further added dropwise 30 ml of an aqueous solution containing 9.4 g of sodium nitrite over about 30 minutes and the mixture was allowed to stand at room temperature overnight. Extraction was conducted with ether and the extract was dried over sodium sulfate and concentrated. The resulting crude crystal was purified by silica gel column chromatography and by recrystallization to give a compound represented by the formula (81). In 300 ml ether were dissolved 20 g of the obtained compound and 17.4 g of bromoacetyl chloride, and the mixture was cooled to 5° C. or lower, and thereto was added dropwise 50 ml of an ether solution containing 9.5 g (1.1 times the molar quantity) of triethylamine over 30 minutes. The reaction mixture was further stirred at room temperature for 6 hours and filtrated, and 50 ml of water was added to the filtrate, followed by stirring for 30 minutes. Water was added thereto several times to separate the mixture and the ether layer was dried by adding sodium sulfate, followed by concentration to give 28.3 g of a compound represented by the formula (82). The yield was 94%.

A solution containing 10 g of the compound represented by the formula (82) in 50 ml DMF was added dropwise to a solution containing 3.6 g of sodium hydrogen carbonate in 950 ml DMF (heterogeneous solution) at room temperature over about 8 hours. The mixture was then allowed to react at the same temperature for 12 hours and filtrated. DMF was concentrated and the residue was washed with 50 ml of isopropanol. After filtration, the obtained white powder was dissolved in 200 ml of acetone, and insoluble substances were removed by filtration and the filtrate was concentrated. The residue was washed with a small amount of isopropanol, filtrated and thoroughly dried. The white powder was sublimed and recrystallized in 400 ml of isopropanol to give 1.9 g of L-3-(2-benzyloxycarbonyl)ethyl-1,4-dioxane-2,5-dione represented by the formula (79) (yield 24%).

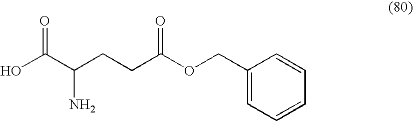

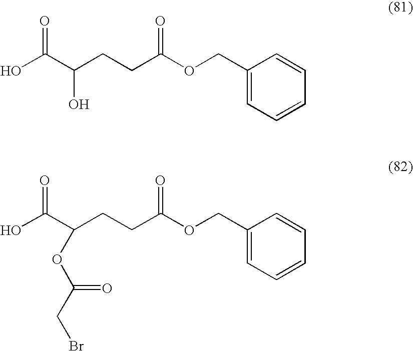

### Preparation Example 2A-2

[Synthesis of polyester using L-3-(2-benzyloxycarbonyl)ethyl-1,4-dioxane-2,5-dione represented by the formula (79) and phenyllactide(3,6-bis(phenylmethyl)-1,4-dioxane-2,5-dione)]

A polymerization ampoule was charged with 0.56 g (2.0 mmol) of L-3-(2-benzyloxycarbonyl)ethyl-1,4-dioxane-2,5-dione represented by the formula (79) synthesized in Preparation Example 2A-1, 2.96 g (10.0 mmol) of phenyllactide, 4.8 ml of a 0.01 M tin octylate (tin 2-ethylhexanoate)toluene solution and 4.8 ml of a 0.01 M p-tert-butylbenzyl alcohol toluene solution. After drying under reduced pressure for 1 hour and replacing the inside air with nitrogen, heat sealing was conducted under reduced pressure and the system was heated to 180° C. to conduct ring-opening polymerization. After 2 hours, the reaction was terminated and the system was cooled. The obtained polymer was dissolved in chloroform and re-precipitated in methanol in an amount 10 times the amount of chloroform needed for dissolving the polymer. The precipitate was collected and dried under reduced pressure to give 2.98 g of a polymer. To identify the structure of the obtained polymer, NMR analysis was conducted under the same conditions as in Preparation Example A-1, and the polymer was confirmed to be a polyhydroxyalkanoate copolymer containing units represented by the following formula (83) as monomer units. The ratio of the monomer units was confirmed to be 12% by mole of unit A and 88% by mole of unit B.

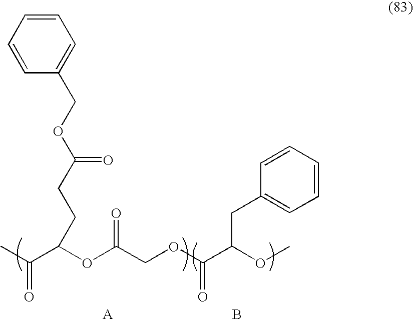

The average molecular weight of the obtained polyhydroxyalkanoate was evaluated in the same manner as in Preparation Example A-1. As a result, the number average molecular weight was Mn=37500 and the weight average molecular weight was Mw=53300.

In 100 ml of a mixed solvent of dioxane-ethanol (75:25) was dissolved 1.00 g of the polyhydroxyalkanoate copolymer containing units represented by the formula (83) obtained above. Thereto was added 0.22 g of a 5% palladium/carbon catalyst and the reaction system was filled with hydrogen and stirring was conducted at room temperature for 1 day. After completion of the reaction, filtration was conducted using a membrane filter of 0.25 μm to remove the catalyst and the reaction solution was recovered. The solution was concentrated and then dissolved in chloroform, followed by re-precipitation in methanol in an amount 10 times the amount of chloroform. The obtained polymer was recovered and dried under reduced pressure to give 0.75 g of a polymer. To identify the structure of the obtained polymer, NMR analysis was conducted under the same conditions as in Preparation Example A-1, and the polymer was confirmed to be a polyhydroxyalkanoate copolymer containing units represented by the following formula (84) as monomer units. The ratio of the monomer units was confirmed to be 12% by mole of unit C and 88% by mole of unit D.

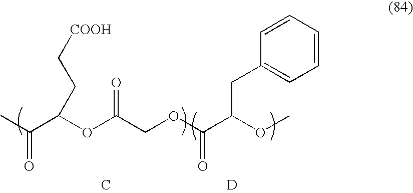

The average molecular weight of the obtained polyhydroxyalkanoate was evaluated by gel permeation chromatography (GPC: HLC-8220 (commercial name) available from Tosoh Corporation, column: TSK-GEL Super HM-H (commercial name) available from Tosoh Corporation, solvent: chloroform, converted to polystyrene) As a result, the number average molecular weight was Mn=31200 and the weight average molecular weight was Mw=46800.

### Preparation Example 2A-3

[Condensation reaction between polyhydroxyalkanoate containing units represented by the formula (84) synthesized in Preparation Example 2A-2 and 2-aminobenzenesulfonic acid)]

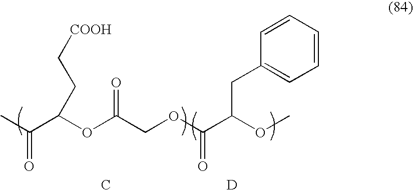

In a 100 ml three-neck flask were placed in a nitrogen atmosphere 0.40 g of the polyhydroxyalkanoate copolymer containing units represented by the formula (84) (C: 12% by mole, D: 88% by mole) obtained in Preparation Example 2A-2 and 0.27 g of 2-aminobenzenesulfonic acid. After adding 15.0 ml of pyridine thereto and stirring, 0.82 ml of triphenyl phosphite was added thereto, followed by stirring at 120° C. for 6 hours. After completion of the reaction, the resultant was re-precipitated in 150 ml of ethanol and recovered. The obtained polymer was washed by using 1N hydrochloric acid for 1 day and then washed by stirring in water for 1 day, followed by drying under reduced pressure to give 0.36 g of a polymer. To determine the structure of the obtained polymer, analysis was conducted by ¹H-NMR (FT-NMR: Bruker DPX400; resonance frequency: 400 MHz; measured nuclides: ¹H; solvent used: DMSO-d₆; measured temperature: room temperature) and Fourier transform infrared absorption (FT-IR) spectrum (Nicolet AVATAR360FT-IR). As a result of the IR measurement, the 1695 cm⁻¹ peak attributable to carboxylic acid was decreased, and a new peak attributable to amide groups was found at 1658 cm⁻¹.

From the result of ¹H-NMR, the obtained polymer was confirmed to be polyhydroxyalkanoate containing units represented by the following formula (85) as monomer units, because the peak attributable to the aromatic ring in the 2-aminobenzenesulfonic acid structure was shifted.

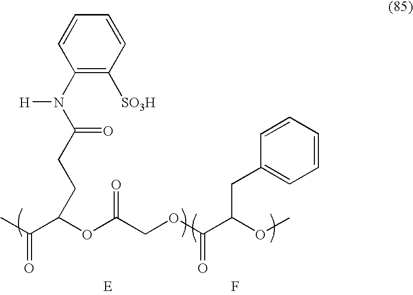

Regarding the unit ratio of the polyhydroxyalkanoate containing units represented by the formula (85), the polymer was confirmed to be a copolymer containing 11% by mole of unit E and 89% by mole of unit F. The average molecular weight of the obtained polymer was evaluated by gel permeation chromatography (GPC: HLC-8120 available from Tosoh Corporation, column: PLgel 5μ MIXED-C available from Polymer Laboratories, solvent: DMF/LiBr 0.1% (w/v), converted to polystyrene). As a result, the number average molecular weight was Mn=26800 and the weight average molecular weight was Mw=42900. The scales of these procedures were increased to produce a large amount of polyhydroxyalkanoate containing units represented by the formula (85), which was named as copolymer (2A).

### Preparation Example 2B-1

[synthesis of polyester using tetrahydro-3-(2-propenyl)-2H-pyran-2-one and phenyllactide(3,6-bis(phenylmethyl)-1,4-dioxane-2,5-dione)]

A polymerization ampoule was charged with 0.28 g (2.0 mmol) of tetrahydro-3-(2-propenyl)-2H-pyran-2-one, 2.96 g (10.0 mmol) of phenyllactide, 4.8 ml of a 0.01 M tin octylate (tin 2-ethylhexanoate)toluene solution and 4.8 ml of a 0.01 M p-tert-butylbenzyl alcohol toluene solution. After that, 2.06 g of a polymer were prepared in the same manner as in Preparation Example A-1. To identify the structure of the obtained polymer, NMR analysis was conducted under the same conditions as in Preparation Example A-1, and the polymer was confirmed to be a polyhydroxyalkanoate copolymer containing units represented by the following formula (86) as monomer units. The ratio of the monomer units was confirmed to be 13% by mole of unit A and 87% by mole of unit B.

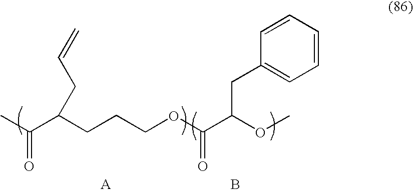

The average molecular weight of the obtained polyhydroxyalkanoate was evaluated in the same manner as in Preparation Example A-1. As a result, the number average molecular weight was Mn=32000 and the weight average molecular weight was Mw=56000.

### Preparation Example 2B-2

[Oxidation reaction of polyhydroxyalkanoate containing units represented by the formula (86) synthesized Preparation Example 2B-1]

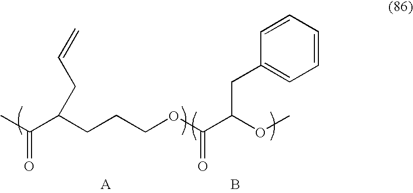

0.50 g of the polyhydroxyalkanoate copolymer containing units represented by the formula (86) (A: 13% by mole, B: 87% by mole) obtained in Preparation Example 2B-1 was put in a round-bottomed flask, and 30 ml of acetone was added thereto to dissolve the copolymer. The flask was put in an ice bath, and to the flask were added 5 ml of acetic acid and 0.35 g of 18-crown-6-ether, followed by stirring. Thereto was then gradually added 0.28 g of potassium permanganate in the ice bath, followed by stirring in the ice bath for 2 hours, and additional stirring was conducted at room temperature for 18 hours. After completion of the reaction, 0.45 g of a polymer was prepared in the same manner as in Preparation Example A-2. To identify the structure of the obtained polymer, NMR analysis was conducted under the same conditions as in Preparation Example A-1, and the polymer was confirmed to be a polyhydroxyalkanoate containing units represented by the following formula (87) as monomer units.

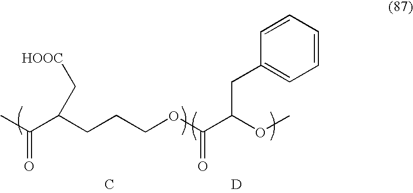

The average molecular weight of the obtained polyhydroxyalkanoate was evaluated in the same manner as in Preparation Example A-1. As a result, the number average molecular weight was Mn=30100 and the weight average molecular weight was Mw=54200.

Further, to calculate the unit of the obtained polyhydroxyalkanoate, 29 mg of the polyhydroxyalkanoate obtained in the same manner as in Preparation Example A-2 was subjected to NMR analysis by using the same procedure as in Preparation Example A-1. As a result, regarding the unit ratio of the polyhydroxyalkanoate containing units represented by the formula (87), the polymer was confirmed to be a copolymer containing 12% by mole of unit C and 88% by mole of unit D.

### Preparation Example 2B-3

[Condensation reaction of polyhydroxyalkanoate containing units represented by the formula (87) synthesized in Preparation Example 2B-2 and 4-methoxyaniline-2-sulfonic acid]

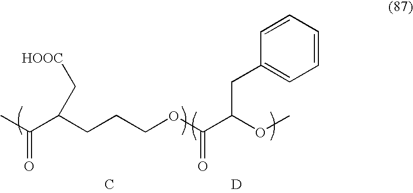

In a 100 ml three-neck flask were placed in a nitrogen atmosphere 0.40 g of the polyhydroxyalkanoate copolymer containing units represented by the formula (87) (C: 12% by mole, D: 88% by mole) obtained in Preparation Example 2B-2 and 0.33 g of 4-methoxyaniline-2-sulfonic acid. After adding 15.0 ml of pyridine thereto and stirring, 0.84 ml of triphenyl phosphite was added thereto, followed by heating at 120° C. for 6 hours. After completion of the reaction, 0.33 g of a polymer was prepared in the same manner as in Preparation Example A-3. To determine the structure of the obtained polymer, analysis was conducted as in Preparation Example A-3. As a result of the IR measurement, the 1695 cm⁻¹ peak attributable to carboxylic acid was decreased, and a new peak attributable to amide groups was found at 1658 cm⁻¹. From the result of ¹H-NMR, the obtained polymer was confirmed to be polyhydroxyalkanoate containing units represented by the following formula (88) as monomer units, because the peak attributable to the aromatic ring in the 4-methoxyaniline-2-sulfonic acid structure was shifted.

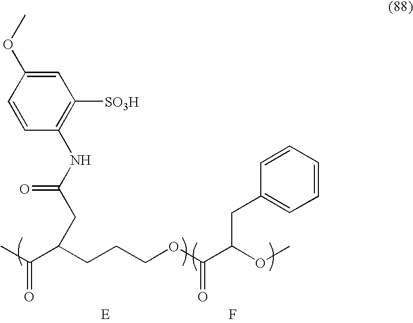

Regarding the unit ratio of the polyhydroxyalkanoate containing units represented by the formula (88), the polymer was confirmed to be a copolymer containing 11% by mole of unit E and 89% by mole of unit F. The average molecular weight of the obtained polymer was evaluated in the same manner as in Preparation Example A-3. As a result, the number average molecular weight was Mn=29500 and the weight average molecular weight was Mw=53700. The scales of these procedures were increased to produce a large amount of polyhydroxyalkanoate containing units represented by the formula (88), which was named as copolymer (2B).

### Preparation Example 2C-1

[synthesis of polyester using phenyllactide]

A polymerization ampoule was charged with 29.63 g (100.0 mmol) of phenyllactide, 4.0 ml of a 0.1 M tin octylate (tin 2-ethylhexanoate)toluene solution and 4.0 ml of a 0.1 M p-tert-butylbenzyl alcohol toluene solution. After drying under reduced pressure for 1 hour and replacing the inside air with nitrogen, heat sealing was conducted under reduced pressure and the system was heated to 180° C. to conduct ring-opening polymerization. After 10 hours, the reaction was terminated and the system was cooled. The obtained polymer was dissolved in chloroform and re-precipitated in methanol in an amount 10 times the amount of chloroform needed for dissolving the polymer. The precipitate was collected and dried under reduced pressure to give 24.00 g of a polymer. To identify the structure of the obtained compound, NMR analysis was conducted under the following conditions.

<measuring instrument> FT-NMR: Bruker DPX400

resonance frequency: ¹H=400 MHz

<measuring condition> measured nuclides: ¹H

solvent used: TMS/CDCl₃

measured temperature: room temperature

As a result, the obtained compound was confirmed to be polyhydroxyalkanoate containing units represented by the following formula (89) as monomer units.

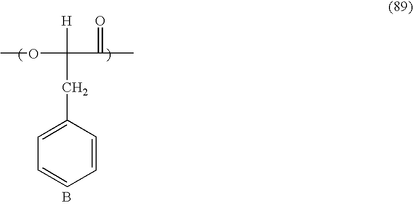

The average molecular weight of the obtained polyhydroxyalkanoate was evaluated by gel permeation chromatography (GPC: HLC-8220 available from Tosoh Corporation, column: TSK-GEL Super HM-H available from Tosoh Corporation, solvent: chloroform, converted to polystyrene). As a result, the number average molecular weight was Mn=35000, and the weight average molecular weight was Mw=49000.

### Preparation Example 2C-2

10.00 g of the polyhydroxyalkanoate containing units represented by the formula (89) obtained in Preparation Example 2C-1 was put in a round-bottomed flask and 500 ml of THF was added thereto to dissolve it. In a nitrogen atmosphere, stirring was conducted at −78° C. Thereto was then gradually added 33.75 ml (67.5 mmol) of a 2M lithium diisopropylamide solution in THF, followed by stirring at −78° C. for 30 minutes. Subsequently, 11.58 g (130.5 mmol) of benzyl chloroformate was added thereto and the mixture was stirred at room temperature for 30 minutes. After completion of the reaction, the reaction mixture was poured into 1000 ml of an aqueous ammonium chloride solution and then 500 ml of dichloromethane was added thereto to extract the organic layer. After washing with 250 ml of water three times, the organic layer was recovered. The solvent was removed to recover a crude polymer. The polymer was then dissolved in 60 ml of THF and re-precipitated in methanol in an amount 50 times the amount of THF needed for dissolving the polymer. The precipitate was collected and dried under reduced pressure to give 8.03 g of a polymer. To identify the structure of the obtained polymer, NMR analysis was conducted under the same conditions as in Preparation Example 2C-1, and the polymer was confirmed to be polyhydroxyalkanoate containing units represented by the following formula (90) as monomer units. The ratio of the monomer units was confirmed to be 11% by mole of unit A and 89% by mole of unit B.

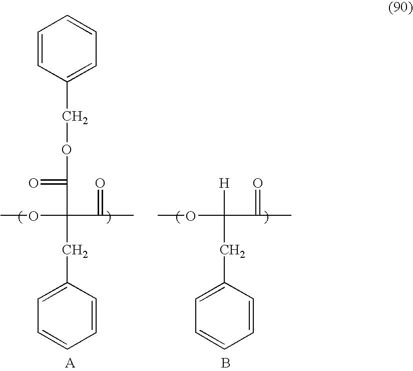

The average molecular weight of the obtained polyhydroxyalkanoate was evaluated by gel permeation chromatography (GPC: HLC-8220 available from Tosoh Corporation, column: TSK-GEL Super HM-H available from Tosoh Corporation, solvent: chloroform, converted to polystyrene). As a result, the number average molecular weight was Mn=28500, and the weight average molecular weight was Mw=41000.

In 500 ml of a mixed solvent of dioxane-ethanol (75:25) was dissolved 5.00 g of the polyhydroxyalkanoate copolymer containing units represented by the formula (90) obtained above. Thereto was added 1.10 g of a 5% palladium/carbon catalyst and the reaction system was filled with hydrogen and stirring was conducted at room temperature for 1 day. After completion of the reaction, filtration was conducted using a membrane filter of 0.25 μm to remove the catalyst and the reaction solution was recovered. The solution was concentrated and then dissolved in chloroform, followed by re-precipitation in methanol in an amount 10 times the amount of chloroform. The obtained polymer was recovered and dried under reduced pressure to give 3.66 g of a polymer. To identify the structure of the obtained polymer, NMR analysis was conducted under the same conditions as in Preparation Example 2C-1, and the polymer was confirmed to be a polyhydroxyalkanoate copolymer containing units represented by the following formula (91) as monomer units. The ratio of the monomer units was confirmed to be 11% by mole of unit C and 89% by mole of unit D.

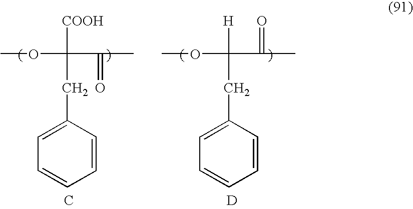

The average molecular weight of the obtained polyhydroxyalkanoate was evaluated by gel permeation chromatography (GPC: HLC-8220 available from Tosoh Corporation, column: TSK-GEL Super HM-H available from Tosoh Corporation, solvent: chloroform, converted to polystyrene). As a result, the number average molecular weight was Mn=22500, and the weight average molecular weight was Mw=33800.

Further, 30 mg of the polyhydroxyalkanoate herein obtained was put in a 100 ml round-bottomed flask, and 2.1 ml of chloroform and 0.7 ml of methanol were added thereto to dissolve it. Thereto was added 0.5 ml of a 2 mol/L hexane solution of trimethylsilyldiazomethane and stirring was conducted at room temperature for 1 hour. After completion of the reaction, the solvent was removed to recover the polymer. After washing the polymer with 50 ml of methanol, the polymer was recovered. Drying was conducted under reduced pressure to give 29 mg of polyhydroxyalkanoate.

The obtained polyhydroxyalkanoate was subjected to NMR analysis by using the same procedure as in Preparation Example 2C-1. As a result, it has been confirmed that the carboxyl group in unit C was converted to carboxylic acid methyl ester and the obtained polymer can be further esterified.

### Preparation Example 2C-3

In a 100 ml three-neck flask were placed in a nitrogen atmosphere 0.40 g of the polyhydroxyalkanoate copolymer containing units represented by the formula (91) (C: 11% by mole, D: 89% by mole) obtained in Preparation Example 2C-2 and 0.25 g (1.4 mmol) of 2-aminobenzenesulfonic acid. After adding 15.0 ml of pyridine thereto and stirring, 0.75 ml (2.8 mmol) of triphenyl phosphite was added thereto, followed by stirring at 120° C. for 6 hours. After completion of the reaction, the resultant was re-precipitated in 150 ml of ethanol and recovered. The obtained polymer was washed by using 1N hydrochloric acid for 1 day and then washed by stirring in water for 1 day, followed by drying under reduced pressure to give 0.35 g of a polymer. To determine the structure of the obtained polymer, analysis was conducted by ¹H-NMR (FT-NMR: Bruker DPX400; resonance frequency: 400 MHz; measured nuclides: ¹H; solvent used: DMSO-d₆; measured temperature: room temperature) and Fourier transform infrared absorption (FT-IR) spectrum (Nicolet AVATAR360FT-IR (commercial name)). As a result of the IR measurement, the 1695 cm⁻¹ peak attributable to carboxylic acid was decreased, and a new peak attributable to amide groups was found at 1658 cm⁻¹.

From the result of ¹H-NMR, the obtained polymer was confirmed to be polyhydroxyalkanoate containing units represented by the following formula (92) as monomer units, because the peak attributable to the aromatic ring in the 2-aminobenzenesulfonic acid structure was shifted.

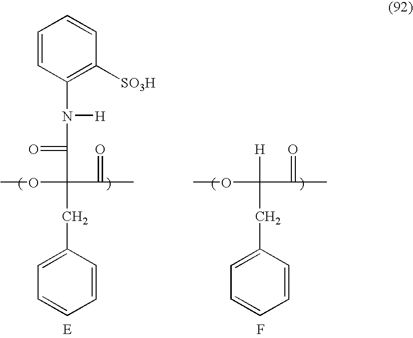

The polyhydroxyalkanoate containing units represented by the formula (92) was confirmed to be a copolymer containing 11% by mole of unit E. The average molecular weight of the obtained polymer was evaluated by gel permeation chromatography (GPC: HLC-8120 available from Tosoh Corporation, column: PLgel 5μ MIXED-C available from Polymer Laboratories, solvent: DMF/LiBr 0.1% (w/v), converted to polystyrene). As a result, the number average molecular weight was Mn=20500 and the weight average molecular weight was Mw=30800.

### Preparation Example 2C-4

0.30 g of the polyhydroxyalkanoate copolymer containing units represented by the formula (92) obtained in Preparation Example 2C-3 was put in a round-bottomed flask, and 21.0 ml of chloroform and 7.0 ml of methanol were added thereto to dissolve the copolymer, and the mixture was cooled to 0° C. Thereto was added 0.78 ml of a 2 mol/L hexane solution of trimethylsilyldiazomethane (available from Sigma-Aldrich Corporation), and stirring was conducted for 4 hours. After completion of the reaction, the solvent was removed by an evaporator to recover a polymer. Further, 21.0 ml of chloroform and 7.0 ml of methanol were added thereto to re-dissolve the polymer and the solvent was removed by an evaporator. This procedure was repeated three times. The polymer recovered at this stage was dried under reduced pressure to give 0.30 g of a polymer. The structure of the obtained polymer was determined by ¹H-NMR (FT-NMR: Bruker DPX400; resonance frequency: 400 MHz; measured nuclides: ¹H; solvent used: DMSO-d₆; measured temperature: room temperature). From the result of ¹H-NMR, the obtained polymer was confirmed to be polyhydroxyalkanoate containing units represented by the following formula (93) as monomer units, because a peak attributable to methyl sulfonate was found at 3 to 4 ppm.

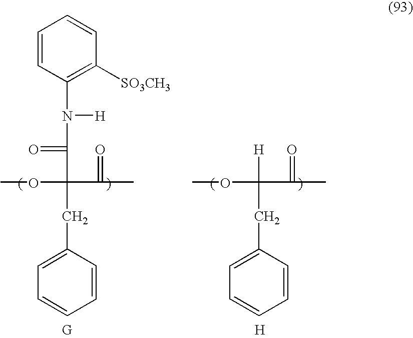

It has been confirmed that the polyhydroxyalkanoate represented by the formula (93) includes 11% by mole of unit G. No peak attributable to sulfonic acid was found by acid value titration using Automatic Potentiometric Titrator AT510 (made by Kyoto Electronics Manufacturing Co., Ltd.), which also proved that sulfonic acid was converted to methyl sulfonate. The average molecular weight of the obtained polymer was evaluated by gel permeation chromatography (GPC: HLC-8120 available from Tosoh Corporation, column: PLgel 5μ MIXED-C available from Polymer Laboratories, solvent: DMF/LiBr 0.1% (w/v), converted to polystyrene). As a result, the number average molecular weight was Mn=20000 and the weight average molecular weight was Mw=30400. The scales of these procedures were increased to produce a large amount of polyhydroxyalkanoate containing units represented by the formula (93), which was named as copolymer (2C).

### Preparation Example 2D-1

Using the polyhydroxyalkanoate containing units represented by the formula (89) obtained in Preparation Example 2C-1, and in the same manner as in Preparation Example 2C-2 except for using 14.41 g (130.5 mmol) of ethyl 5-bromovalerate instead of benzyl chloroformate, 8.02 g of a polymer was prepared. The obtained polymer was subjected to NMR analysis under the same conditions as in Preparation Example 2C-1 and as a result, confirmed to be polyhydroxyalkanoate containing units represented by the following formula (94), the ratio of the monomer units being 8% by mole of unit A and 92% by mole of unit B.

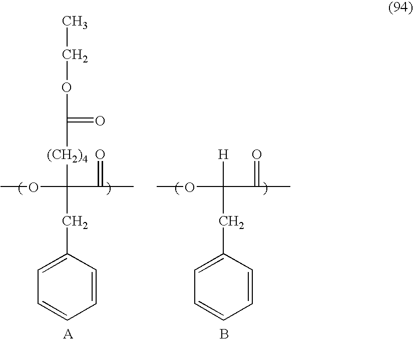

The average molecular weight of the obtained polyhydroxyalkanoate was measured under the same conditions as in Preparation Example 2C-1 and as a result, the number average molecular weight was Mn=28500 and the weight average molecular weight was Mw=39600.

Further, the above-mentioned polymer was subjected to hydrogenolysis in the same manner as in Preparation Example 2C-2 to give 3.94 g of a polymer. The obtained polymer was subjected to NMR analysis under the same conditions as in Preparation Example 2C-1 and as a result, confirmed to be a polyhydroxyalkanoate copolymer containing units represented by the following formula (95) as monomer units. The ratio of the monomer units was confirmed to be 8% by mole of unit C and 92% by mole of unit D.

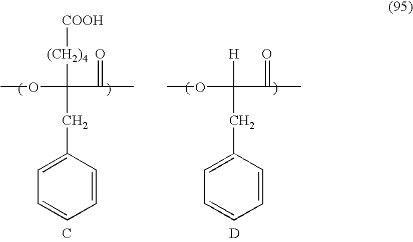

The average molecular weight of the obtained polyhydroxyalkanoate was measured under the same conditions as in Preparation Example 2C-1 and as a result, the number average molecular weight was Mn=24900 and the weight average molecular weight was Mw=35400.

### Preparation Example 2D-2

In a 100 ml three-neck flask were placed in a nitrogen atmosphere 0.40 g of the polyhydroxyalkanoate copolymer containing units represented by the formula (95) (C: 8% by mole, D: 92% by mole) obtained in Preparation Example 2D-1 and 0.13 g (1.0 mmol) of taurine. After adding 15.0 ml of pyridine thereto and stirring, 0.53 ml (2.0 mmol) of triphenyl phosphite was added thereto. After that, 0.31 g of a polymer was prepared in the same manner as in Preparation Example A-3. The obtained polymer was subjected to NMR analysis and Fourier transform infrared absorption spectrum analysis under the same conditions as in Preparation Example A-3, and as a result, confirmed to be polyhydroxyalkanoate containing units represented by the following formula (96), which was a copolymer containing 6% by mole of unit E.

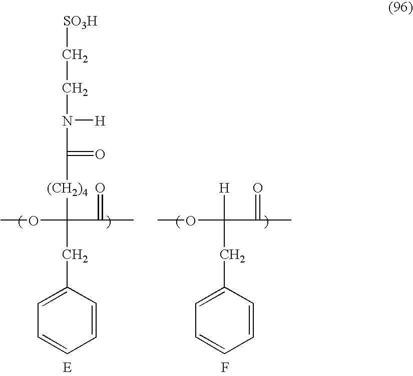

The average molecular weight of the obtained polymer was measured under the same conditions as in Preparation Example A-3 and as a result, the number average molecular weight was Mn=19800 and the weight average molecular weight was Mw=31700. The scales of these procedures were increased to produce a large amount of polyhydroxyalkanoate containing units represented by the formula (96), which was named as copolymer (2D).

### Preparation Example 2E-1

[synthesis of polyester using L-lactide]

A polymerization ampoule was charged with 14.41 g (100.0 mmol) of L-lactide, 4.0 ml of a 0.1 M tin octylate (tin 2-ethylhexanoate)toluene solution and 4.0 ml of a 0.1 M p-tert-butylbenzyl alcohol toluene solution. After drying under reduced pressure for 1 hour and replacing the inside air with nitrogen, heat sealing was conducted under reduced pressure and the system was heated to 160° C. to conduct ring-opening polymerization. After 10 hours, the reaction was terminated and the system was cooled. The obtained polymer was dissolved in chloroform and re-precipitated in methanol in an amount 10 times the amount of chloroform needed for dissolving the polymer. The precipitate was collected and dried under reduced pressure to give 12.68 g of a polymer. To identify the structure of the obtained compound, NMR analysis was conducted under the same conditions as in Preparation Example 2C-1, and the compound was confirmed to be polyhydroxyalkanoate containing units represented by the formula (97).

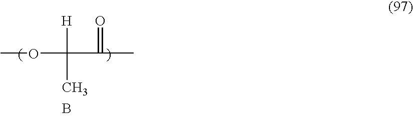

The average molecular weight of the obtained polyhydroxyalkanoate was measured under the same conditions as in Preparation Example 2C-1 and as a result, the number average molecular weight was Mn=42800 and the weight average molecular weight was Mw=59100.

### Preparation Example 2E-2

10.00 g of the polyhydroxyalkanoate containing units represented by the formula (97) obtained in Preparation Example 2E-1 was put in a round-bottomed flask and 500 ml of THF was added thereto to dissolve it. In a nitrogen atmosphere, stirring was conducted at −78° C. Thereto was then gradually added 69.38 ml (138.8 mmol) of a 2M lithium diisopropylamide solution in THF, followed by stirring at −78° C. for 30 minutes. Subsequently, 23.81 g (277.5 mmol) of benzyl chloroformate was added thereto, and 9.55 g of a polymer were prepared in the same manner as in Preparation Example 2C-2. The obtained polymer was subjected to NMR analysis under the same conditions as in Preparation Example 2C-1 and as a result, confirmed to be polyhydroxyalkanoate containing units represented by the following formula (98), the ratio of the monomer units being 12% by mole of unit A and 88% by mole of unit B.

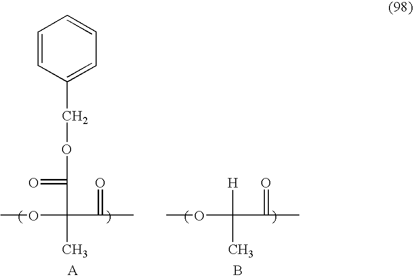

The average molecular weight of the obtained polyhydroxyalkanoate was measured under the same conditions as in Preparation Example 2C-1 and as a result, the number average molecular weight was Mn=32100 and the weight average molecular weight was Mw=46500. Further, the above-mentioned polymer was subjected to hydrogenolysis in the same manner as in Preparation Example 2C-2 to give 3.47 g of a polymer. The obtained polymer was subjected to NMR analysis under the same conditions as in Preparation Example 2C-1 and as a result, confirmed to be a polyhydroxyalkanoate copolymer containing units represented by the following formula (99) as monomer units. The ratio of the monomer units was confirmed to be 12% by mole of unit C and 88% by mole of unit D.

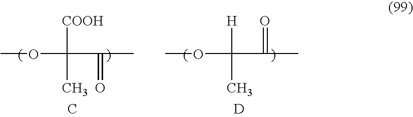

The average molecular weight of the obtained polyhydroxyalkanoate was measured under the same conditions as in Preparation Example 2C-1 and as a result, the number average molecular weight was Mn=30100 and the weight average molecular weight was Mw=45200.

### Preparation Example 2E-3

In a 100 ml three-neck flask were placed in a nitrogen atmosphere 0.40 g of the polyhydroxyalkanoate copolymer containing units represented by the formula (99) (C: 12% by mole, D: 88% by mole) obtained in Preparation Example 2E-2 and 0.69 g (3.1 mmol) of 2-amino-1-naphthalene sulfonic acid. After adding 15.0 ml of pyridine thereto and stirring, 1.62 ml (6.2 mmol) of triphenyl phosphite was added thereto. 0.37 g of a polymer was prepared in the same manner as in Preparation Example 2C-3. The obtained polymer was subjected to NMR analysis and Fourier transform infrared absorption spectrum analysis under the same conditions as in Preparation Example 2C-3, and as a result, the obtained polymer was confirmed to be polyhydroxyalkanoate containing units represented by the following formula (100), which was a copolymer containing 8% by mole of unit E.

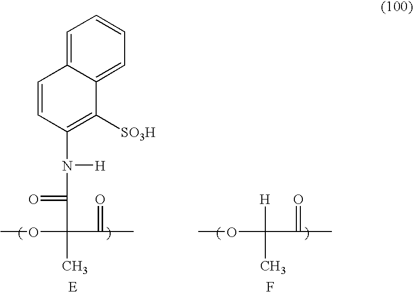

The average molecular weight of the obtained polymer was measured under the same conditions as in Preparation Example 2C-3 and as a result, the number average molecular weight was Mn=27200 and the weight average molecular weight was Mw=43000.

### Preparation Example 2E-4

0.30 g of the polyhydroxyalkanoate copolymer containing units represented by the formula (100) obtained in Preparation Example 2E-3 was put in a round-bottomed flask, and 21.0 ml of chloroform and 7.0 ml of methanol were added thereto to dissolve the copolymer, and the mixture was cooled to 0° C. Thereto was added 0.90 ml of a 2 mol/L hexane solution of trimethylsilyldiazomethane (available from Sigma-Aldrich Corporation), and stirring was conducted for 4 hours. After completion of the reaction, the solvent was removed by an evaporator to recover a polymer. Further, 21.0 ml of chloroform and 7.0 ml of methanol were added thereto to re-dissolve the polymer and the solvent was removed by an evaporator. This procedure was repeated three times. The polymer recovered at this stage was dried under reduced pressure to give 0.30 g of a polymer. The structure of the obtained polymer was determined by ¹H-NMR (FT-NMR: Bruker DPX400; resonance frequency: 400 MHz; measured nuclides: ¹H; solvent used: DMSO-d₆; measured temperature: room temperature). From the result of ¹H-NMR, the obtained polymer was confirmed to be polyhydroxyalkanoate containing units represented by the following formula (101) as monomer units, because a peak attributable to methyl sulfonate was found at 3 to 4 ppm.

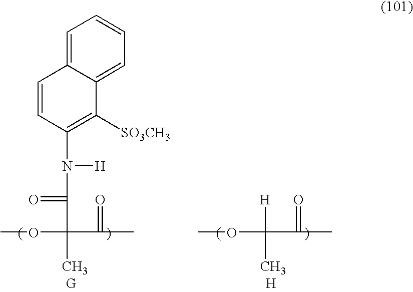

It has been confirmed that the polyhydroxyalkanoate represented by the formula (101) includes 8% by mole of unit G. No peak attributable to sulfonic acid was found by acid value titration using Automatic Potentiometric Titrator AT510 (made by Kyoto Electronics Manufacturing Co., Ltd.), which also proved that sulfonic acid was converted to methyl sulfonate. The average molecular weight of the obtained polymer was measured under the same conditions as those of Preparation Example 2C-4. As a result, the number average molecular weight was Mn=27000 and the weight average molecular weight was Mw=43700. The scales of these procedures were increased to produce a large amount of polyhydroxyalkanoate containing units represented by the formula (101), which was named as copolymer (2E).

### Preparation Example 2F-1

In the same manner as in Preparation Example 2E-2 except for using 34.85 g (277.5 mmol) of ethyl 8-bromooctanoate instead of benzyl chloroformate, 8.63 g of a polymer was prepared. The obtained polymer was subjected to NMR analysis under the same conditions as in Preparation Example 2C-1 and as a result, confirmed to be polyhydroxyalkanoate containing units represented by the following formula (102), the ratio of the monomer units being 7% by mole of unit A and 93% by mole of unit B.

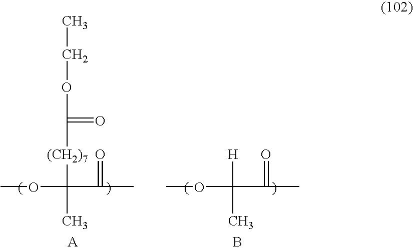

The average molecular weight of the obtained polyhydroxyalkanoate was measured under the same conditions as in Preparation Example 2C-1 and as a result, the number average molecular weight was Mn=35500 and the weight average molecular weight was Mw=52500.

Further, the above-mentioned polymer was subjected to hydrogenolysis in the same manner as in Preparation Example 2C-2 to give 4.10 g of a polymer. The obtained polymer was subjected to NMR analysis under the same conditions as in Preparation Example 2C-1 and as a result, confirmed to be a polyhydroxyalkanoate copolymer containing units represented by the following formula (103) as monomer units. The ratio of the monomer units was confirmed to be 7% by mole of unit C and 93% by mole of unit D.

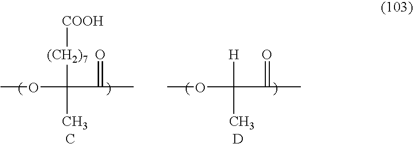

The average molecular weight of the obtained polyhydroxyalkanoate was measured under the same conditions as in Preparation Example 2C-1 and as a result, the number average molecular weight was Mn=31000 and the weight average molecular weight was Mw=48100.

### Preparation Example 2F-2

In a 100 ml three-neck flask were placed in a nitrogen atmosphere 0.40 g of the polyhydroxyalkanoate copolymer containing units represented by the formula (103) (C: 7% by mole, D: 93% by mole) obtained in Preparation Example 2F-1 and 0.43 g (1.7 mmol) of 2-aminobenzenesulfonic acid phenyl ester. After adding 15.0 ml of pyridine thereto and stirring, 0.89 ml (3.4 mmol) of triphenyl phosphite was added thereto. 0.39 g of a polymer was prepared in the same manner as in Preparation Example 2C-3. The obtained polymer was subjected to NMR analysis and Fourier transform infrared absorption spectrum analysis under the same conditions as in Preparation Example 2C-3, and as a result, confirmed to be polyhydroxyalkanoate containing units represented by the following formula (104), which was a copolymer containing 7% by mole of unit E.

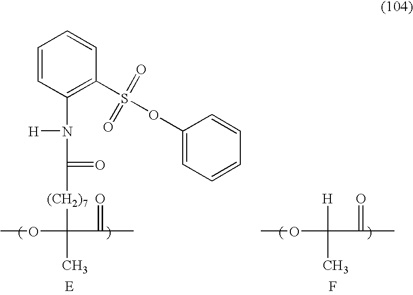

The average molecular weight of the obtained polymer was measured under the same conditions as in Preparation Example 2C-3 and as a result, the number average molecular weight was Mn=27500 and the weight average molecular weight was Mw=44600. The scales of these procedures were increased to produce a large amount of polyhydroxyalkanoate containing units represented by the formula (104), which was named as copolymer (2F).

### Preparation Example 2G-1

[Synthesis of polyester using diisopropylglycolide (3,6-diisopropyl-1,4-dioxane-2,5-dione)]

In the same manner as in Preparation Example 2E-1 except for using 22.83 g (100.0 mmol) of diisopropylglycolide instead of L-lactide, 14.15 g of a polymer was prepared. The obtained polymer was subjected to NMR analysis under the same conditions as in Preparation Example 2C-1 and as a result, confirmed to be polyhydroxyalkanoate containing units represented by the following formula (105).

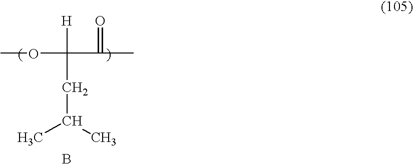

The average molecular weight of the obtained polyhydroxyalkanoate was measured under the same conditions as in Preparation Example 2C-1 and as a result, the number average molecular weight was Mn=32800 and the weight average molecular weight was Mw=48500.

### Preparation Example 2G-2

10.00 g of the polyhydroxyalkanoate containing units represented by the formula (105) obtained in Preparation Example 2G-1 was put in a round-bottomed flask and 500 ml of THF was added thereto to dissolve it. In a nitrogen atmosphere, stirring was conducted at −78° C. Thereto was then gradually added 43.81 ml (87.6 μmmol) of a 2M lithium diisopropylamide solution in THF, followed by stirring at −78° C. for 30 minutes. Subsequently, 18.32 g (175.2 mmol) of ethyl 5-bromovalerate was added thereto, and 7.64 g of a polymer were prepared in the same manner as in Preparation Example 2C-2. The obtained polymer was subjected to NMR analysis under the same conditions as in Preparation Example 2C-1 and as a result, confirmed to be polyhydroxyalkanoate containing units represented by the following formula (106), the ratio of the monomer units being 11% by mole of unit A and 89% by mole of unit B.

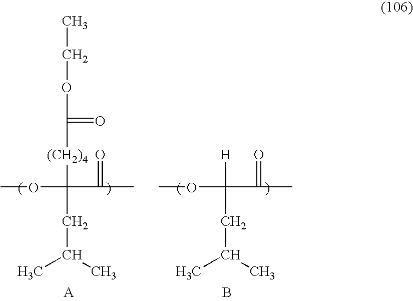

The average molecular weight of the obtained polyhydroxyalkanoate was measured under the same conditions as in Preparation Example 2C-1 and as a result, the number average molecular weight was Mn=26500 and the weight average molecular weight was Mw=41100.

Further, the above-mentioned polymer was subjected to hydrogenolysis in the same manner as in Preparation Example 2C-2 to give 4.05 g of a polymer. The obtained polymer was subjected to NMR analysis under the same conditions as in Preparation Example 2C-1 and as a result, confirmed to be a polyhydroxyalkanoate copolymer containing units represented by the following formula (107) as monomer units. The ratio of the monomer units was confirmed to be 11% by mole of unit C and 89% by mole of unit D.

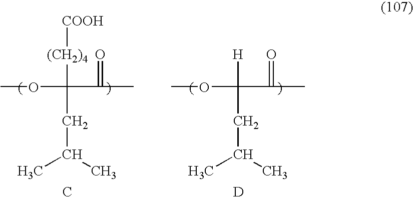

The average molecular weight of the obtained polyhydroxyalkanoate was measured under the same conditions as in Preparation Example 2C-1 and as a result, the number average molecular weight was Mn=22200 and the weight average molecular weight was Mw=33700.

### Preparation Example 2G-3

In a 100 ml three-neck flask were placed in a nitrogen atmosphere 0.40 g of the polyhydroxyalkanoate copolymer containing units represented by the formula (107) (C: 11% by mole, D: 89% by mole) obtained in Preparation Example 2G-2 and 0.27 g (1.8 mmol) of 2-amino-2-methylpropanesulfonic acid. After adding 15.0 ml of pyridine thereto and stirring, 0.92 ml (3.5 mmol) of triphenyl phosphite was added thereto. 0.33 g of a polymer was prepared in the same manner as in Preparation Example 2C-3. The obtained polymer was subjected to NMR analysis and Fourier transform infrared absorption spectrum analysis under the same conditions as in Preparation Example 2C-3, and as a result, confirmed to be polyhydroxyalkanoate containing units represented by the following formula (108), which was a copolymer containing 9% by mole of unit E.

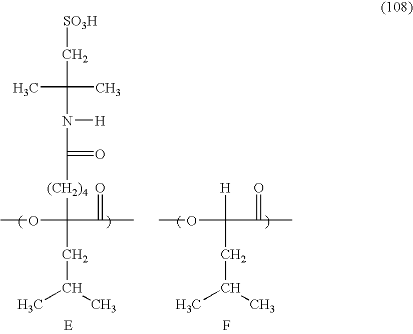

The average molecular weight of the obtained polymer was measured under the same conditions as in Preparation Example 2C-3 and as a result, the number average molecular weight was Mn=20900 and the weight average molecular weight was Mw=35500.

### Preparation Example 2G-4

In the same manner as in Preparation Example 2C-4 except for using the polyhydroxyalkanoate represented by the formula (108) obtained in Preparation Example 2G-3 instead of the polyhydroxyalkanoate represented by the formula (92) in Preparation Example 2C-4 and using 0.70 ml of a 2 mol/L hexane solution of trimethylsilyldiazomethane (available from Sigma-Aldrich Corporation), 0.29 g of a polymer was prepared. The obtained polymer was subjected to NMR analysis under the same conditions as in Preparation Example 2C-4 and as a result, confirmed to be polyhydroxyalkanoate containing units represented by the following formula (109), which was a copolymer containing 9% by mole of unit G.

No peak attributable to sulfonic acid was found by the same acid value titration as in Preparation Example 2C-4, which also proved that sulfonic acid was converted to methyl sulfonate.

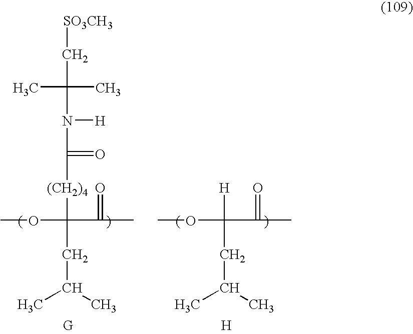

The average molecular weight of the obtained polymer was measured under the same conditions as in Preparation Example 2C-4 and as a result, the number average molecular weight was Mn=19500 and the weight average molecular weight was Mw=33200. The scales of these procedures were increased to produce a large amount of polyhydroxyalkanoate containing units represented by the formula (109), which was named as copolymer (2G)

### Preparation Example 2H-1

[synthesis of polyester using hexylglycolide(3,6-dihexyl-1,4-dioxane-2,5-dione)]

In the same manner as in Preparation Example 2E-1 except for using 25.63 g (100.0 mmol) of hexylglycolide instead of L-lactide, 16.66 g of a polymer was obtained. The obtained polymer was subjected to NMR analysis under the same conditions as in Preparation Example 2C-1, and confirmed to be polyhydroxyalkanoate containing units represented by the following formula (110).

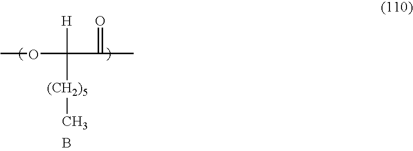

The average molecular weight of the obtained polyhydroxyalkanoate was measured under the same conditions as in Preparation Example 2C-1 and as a result, the number average molecular weight was Mn=28900 and the weight average molecular weight was Mw=42200.

### Preparation Example 2H-2

10.00 g of the polyhydroxyalkanoate containing units represented by the formula (110) obtained in Preparation Example 2H-1 was put in a round-bottomed flask and 500 ml of THF was added thereto to dissolve it. In a nitrogen atmosphere, stirring was conducted at −78° C. Thereto was then gradually added 39.01 ml (78.0 mmol) of a 2M lithium diisopropylamide solution in THF, followed by stirring at −78° C. for 30 minutes. Subsequently, 17.95 g (156.0 mmol) of benzyl bromoacetate was added thereto, 8.40 g of a polymer were prepared in the same manner as in Preparation Example 2C-2. The obtained polymer was subjected to NMR analysis under the same conditions as in Preparation Example 2C-1 and as a result, confirmed to be polyhydroxyalkanoate containing units represented by the following formula (111), the ratio of the monomer units being 9% by mole of unit A and 91% by mole of unit B.

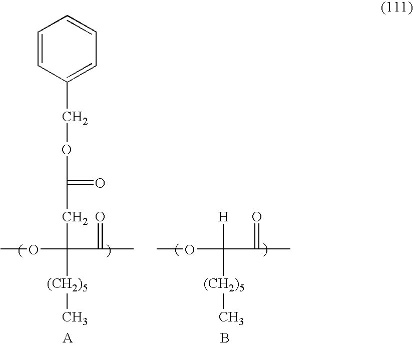

The average molecular weight of the obtained polyhydroxyalkanoate was measured under the same conditions as in Preparation Example 2C-1 and as a result, the number average molecular weight was Mn=23000 and the weight average molecular weight was Mw=34500.

Further, the above-mentioned polymer was subjected to hydrogenolysis in the same manner as in Preparation Example 2C-2 to give 3.68 g of a polymer. The obtained polymer was subjected to NMR analysis under the same conditions as in Preparation Example 2C-1 and as a result, confirmed to be a polyhydroxyalkanoate copolymer containing units represented by the following formula (112) as monomer units. The ratio of the monomer units was confirmed to be 9% by mole of unit C and 91% by mole of unit D.

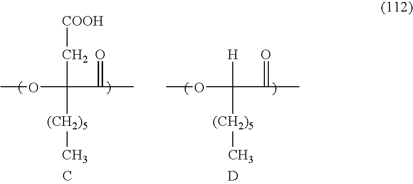

The average molecular weight of the obtained polyhydroxyalkanoate was measured under the same conditions as in Preparation Example 2C-1 and as a result, the number average molecular weight was Mn=19800 and the weight average molecular weight was Mw=30900.

### Preparation Example 2H-3

In a 100 ml three-neck flask were placed in a nitrogen atmosphere 0.40 g of the polyhydroxyalkanoate copolymer containing units represented by the formula (112) (C: 9% by mole, D: 91% by mole) obtained in Preparation Example 2H-2 and 0.23 g (1.3 mmol) of 2-aminobenzenesulfonic acid. After adding 15.0 ml of pyridine thereto and stirring, 0.70 ml (2.6 mmol) of triphenyl phosphite was added thereto. 0.35 g of a polymer was prepared in the same manner as in Preparation Example 2C-3. The obtained polymer was subjected to NMR analysis and Fourier transform infrared absorption spectrum analysis under the same conditions as in Preparation Example 2C-3, and as a result, confirmed to be polyhydroxyalkanoate containing units represented by the following formula (113), which was a copolymer containing 8% by mole of unit E.

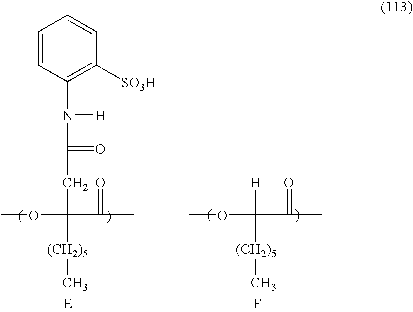

The average molecular weight of the obtained polymer was measured under the same conditions as in Preparation Example 2C-3 and as a result, the number average molecular weight was Mn=18900 and the weight average molecular weight was Mw=30400. The scales of these procedures were increased to produce a large amount of polyhydroxyalkanoate containing units represented by the formula (113), which was named as copolymer (2H).

### Preparation Example 2I-1

2.00 g of the polyhydroxyalkanoate containing units represented by the formula (89) obtained in Preparation Example 2C-1 was put in a round-bottomed flask and 100 ml of THF was added thereto to dissolve it. In a nitrogen atmosphere, stirring was conducted at −78° C. Thereto was then gradually added 18.9 ml of a 2M lithium diisopropylamide solution in THF, followed by stirring at −78° C. for 30 minutes. Subsequently, 5.91 g of methyl 2-acrylamido-2-methylpropanesulfonate was added thereto and the mixture was stirred at room temperature for 30 minutes. After completion of the reaction, the reaction mixture was poured into 400 ml of an aqueous ammonium chloride solution and then 200 ml of dichloromethane was added thereto to extract the organic layer. After washing with 100 ml of water three times, the organic layer was recovered. The solvent was removed to recover a crude polymer. The polymer was then dissolved in 12 ml of THF and re-precipitated in methanol in an amount 50 times the amount of THF needed for dissolving the polymer. The precipitate was collected and dried under reduced pressure to give 1.22 g of a polymer. The identification of the structure of the obtained polymer was conducted by ¹H-NMR (FT-NMR: Bruker DPX400; resonance frequency: 400 MHz; measured nuclides: ¹H; solvent used: DMSO-d₆; measured temperature: room temperature). As a result, the polymer was confirmed to be polyhydroxyalkanoate containing units represented by the following formula (114) as monomer units. The ratio of the monomer units was confirmed to be 7% by mole of unit E and 93% by mole of unit F.

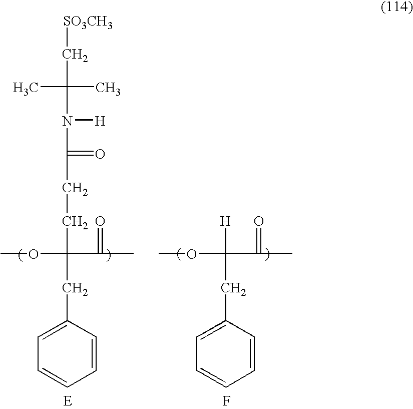

The average molecular weight of the resultant polymer was measured under the same conditions as those of Preparation Example 2C-3. As a result, the number average molecular weight was Mn=25500 and the weight average molecular weight was Mw=38200. The scales of these procedures were increased to produce a large amount of polyhydroxyalkanoate containing units represented by the formula (114), which was named as copolymer (2I).

### Preparation Example 2J-1

In this Preparation Example, polyhydroxyalkanoate is produced by using a microorganism. The microorganism used in this Preparation Example is Ralstoniaeutropha strain TB64 (disclosed in Japanese Patent Application Laid-Open No. 2000-166587). This microorganism is deposited at the International Patent Organism Depository, National Institute of Advanced Industrial Science and Technology.

The inorganic salt medium used in this

Preparation Example (M9 medium) has the following composition.

Composition of M9 medium (per 1 L):

| | |
|---|---|
| Na₂HPO₄ | 6.2 g |
| KH₂PO₄ | 3.0 g |
| NaCl | 0.5 g |
| NH₄Cl | 1.0 g |
| water | balance |
| (pH 7.0) | |

When culturing, about 0.3% (v/v) of a trace component solution described below is added to the above-mentioned inorganic salt medium for better proliferation of the microorganism and better production of polyhydroxyalkanoate.

(Composition of trace component solution: unit g/L) nitrilotriacetic acid:1.5; MgSO₄:3.0; MnSO₄: 0.5; NaCl:1.0; FeSO₄:0.1; CaCl₂:0.1; CoCl₂:0.1; ZnSO₄:0.1; CuSO₄:0.1; AlK(SO₄)₂:0.1; H₃BO₃:0.1; Na₂MoO₄:0.1; NiCl₂:0.1

(synthesis of poly-3-hydroxybutyric acid represented by the formula (115))

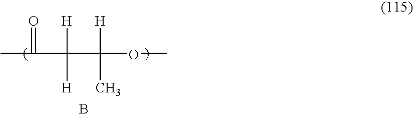

Poly-3-hydroxybutyric acid represented by the formula (115) was synthesized according to the method disclosed in Example 1 of Japanese Patent Application Laid-Open No. 2002-306190.

A colony of strain TB64 on a M9 agar medium containing 0.1% of sodium malate was inoculated to 50 mL of M9 medium containing 0.5% of sodium malate in a 500 mL shaking flask, followed by shaking culture at 30° C. After 24 hours, 5 mL of the culture solution was added to 1 L of the production medium which is M9 medium containing 0.5% of sodium malate, in which only NH₄Cl as a nitrogen source was adjusted to 1/10 concentration, and additional shaking was carried out to accumulate PHB in bacterial cells. After 48 hours, the PHB accumulated bacterial cells were collected by centrifugal separation, washed with methanol and then freeze-dried. The dried bacterial cells were weighed and chloroform was then added thereto, and stirring was conducted at 60° C. for 24 hours to extract the polymer. The chloroform mixture in which the polymer was extracted was filtrated and concentrated by an evaporator, and solidified precipitate was then collected with cold methanol and dried under reduced pressure to give 1.83 g of a polymer per 1 L of the production medium. To identify the structure of the obtained polymer, NMR analysis was conducted under the following conditions.

<measuring instrument> FT-NMR: Bruker DPX400

resonance frequency: ¹H=400 MHz

<measuring condition> measured nuclides: ¹H

solvent used: TMS/CDCl₃

measured temperature: room temperature

As a result, the polymer was confirmed to be polyhydroxyalkanoate containing 3-hydroxy butyric acid units represented by the formula (115). The average molecular weight of the obtained polyhydroxyalkanoate was evaluated by gel permeation chromatography (GPC: HLC-8220 available from Tosoh Corporation, column: TSK-GEL Super HM-H available from Tosoh Corporation, solvent: chloroform, converted to polystyrene). As a result, the number average molecular weight was Mn=549500 and the weight average molecular weight was Mw=1263900.

According to the above-mentioned method, 45.6 g of polyhydroxyalkanoate was prepared from 50 L of production medium, so as to be used in the following Preparation Examples.

### Preparation Example 2J-2

10.00 g of the polyhydroxyalkanoate containing units represented by the formula (115) obtained in Preparation Example 2J-1 was put in a round-bottomed flask and 500 ml of THF was added thereto to dissolve it. In a nitrogen atmosphere, stirring was conducted at −78° C. Thereto was then gradually added 58.08 ml (116.2 mmol) of a 2M lithium diisopropylamide solution in THF, followed by stirring at −78° C. for 30 minutes. Subsequently, 19.82 g (232.3 mmol) of benzyl chloroformate was added thereto and the mixture was stirred at room temperature for 30 minutes. After completion of the reaction, the reaction mixture was poured into 1000 ml of an aqueous ammonium chloride solution and then 500 ml of dichloromethane was added thereto to extract the organic layer. After washing with 250 ml of water three times, the organic layer was recovered. The solvent was removed to recover a crude polymer. The polymer was then dissolved in 60 ml of THF and re-precipitated in methanol in an amount 50 times the amount of THF needed for dissolving the polymer. The precipitate was collected and dried under reduced pressure to give 8.44 g of a polymer. To identify the structure of the obtained polymer, NMR analysis was conducted under the same conditions as in Preparation Example 2J-1, and the polymer was confirmed to be polyhydroxyalkanoate containing units represented by the following formula (116) as monomer units. The ratio of the monomer units was confirmed to be 10% by mole of unit A and 90% by mole of unit B.

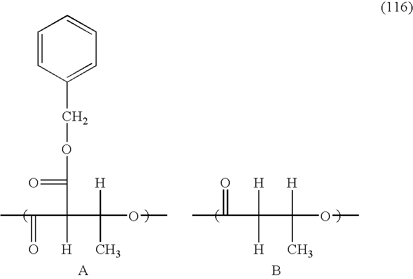

The average molecular weight of the obtained polyhydroxyalkanoate was evaluated by gel permeation chromatography (GPC: HLC-8220 available from Tosoh Corporation, column: TSK-GEL Super HM-H available from Tosoh Corporation, solvent: chloroform, converted to polystyrene). As a result, the number average molecular weight was Mn=325400 and the weight average molecular weight was Mw=764700.

In 500 ml of a mixed solvent of dioxane-ethanol (75:25) was dissolved 5.00 g of the polyhydroxyalkanoate copolymer containing units represented by the formula (116) obtained above. Thereto was added 1.10 g of a 5% palladium/carbon catalyst and the reaction system was filled with hydrogen and stirring was conducted at room temperature for 1 day. After completion of the reaction, filtration was conducted using a membrane filter of 0.25 μm to remove the catalyst and the reaction solution was recovered. The solution was concentrated and then dissolved in chloroform, followed by re-precipitation in methanol in an amount 10 times the amount of chloroform. The obtained polymer was recovered and dried under reduced pressure to give 3.59 g of a polymer. To identify the structure of the obtained polymer, NMR analysis was conducted under the same conditions as in Preparation Example 2J-1, and the polymer was confirmed to be a polyhydroxyalkanoate copolymer containing units represented by the following formula (117) as monomer units. The ratio of the monomer units was confirmed to be 10% by mole of unit C and 90% by mole of unit D.

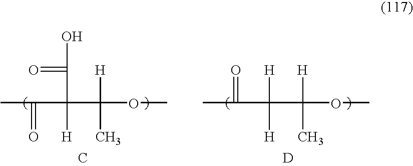

The average molecular weight of the obtained polyhydroxyalkanoate was evaluated by gel permeation chromatography (GPC: HLC-8220 available from Tosoh Corporation, column: TSK-GEL Super HM-H available from Tosoh Corporation, solvent: chloroform, converted to polystyrene). As a result, the number average molecular weight was Mn=298000 and the weight average molecular weight was Mw=715200.

Further, 30 mg of the polyhydroxyalkanoate herein obtained was put in a 100 ml round-bottomed flask, and 2.1 ml of chloroform and 0.7 ml of methanol were added thereto to dissolve it. Thereto was added 0.5 ml of a 2 mol/L hexane solution of trimethylsilyldiazomethane and stirring was conducted at room temperature for 1 hour. After completion of the reaction, the solvent was removed to recover the polymer. After washing the polymer with 50 ml of methanol, the polymer was recovered. Drying was conducted under reduced pressure to give 29 mg of polyhydroxyalkanoate.

The obtained polyhydroxyalkanoate was subjected to NMR analysis by using the same procedure as in Preparation Example 2J-1. As a result, it has been confirmed that the carboxyl group in unit C was converted to carboxylic acid methyl ester and the obtained polymer can be further esterified.

### Preparation Example 2J-3

In a 100 ml three-neck flask were placed in a nitrogen atmosphere 0.40 g of the polyhydroxyalkanoate copolymer containing units represented by the formula (117) (C: 10% by mole, D: 90% by mole) obtained in Preparation Example 2J-3 and 0.24 g (1.4 mmol) of 2-aminobenzenesulfonic acid. After adding 15.0 ml of pyridine thereto and stirring, 0.71 ml (2.7 mmol) of triphenyl phosphite was added thereto, followed by heating at 120° C. for 6 hours. After completion of the reaction, the resultant was re-precipitated in 150 ml of ethanol and recovered. The obtained polymer was washed by using 1N hydrochloric acid for 1 day and then washed by stirring in water for 1 day, followed by drying under reduced pressure to give 0.35 g of a polymer. To determine the structure of the obtained polymer, analysis was conducted by ¹H-NMR (FT-NMR: Bruker DPX400; resonance frequency: 400 MHz; measured nuclides: ¹H; solvent used: DMSO-d₆; measured temperature: room temperature) and Fourier transform infrared absorption (FT-IR) spectrum (Nicolet AVATAR360FT-IR (commercial name)). As a result of the IR measurement, the 1695 cm⁻¹ peak attributable to carboxylic acid was decreased, and a new peak attributable to amide groups was found at 1658 cm⁻¹.

From the result of ¹H-NMR, the obtained polymer was confirmed to be polyhydroxyalkanoate containing units represented by the following formula (118) as monomer units, because the peak attributable to the aromatic ring in the 2-aminobenzenesulfonic acid structure was shifted.

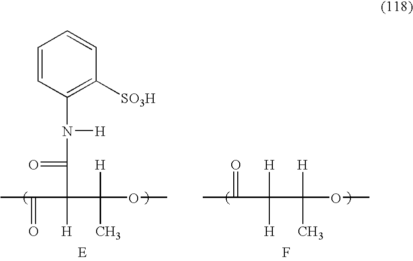

The polyhydroxyalkanoate containing units represented by the formula (118) was confirmed to be a copolymer containing 10% by mole of unit E. The average molecular weight of the obtained polymer was evaluated by gel permeation chromatography (GPC: HLC-8120 available from Tosoh Corporation, column: PLgel 5μ MIXED-C available from Polymer Laboratories, solvent: DMF/LiBr 0.1% (w/v), converted to polystyrene). As a result, the number average molecular weight was Mn=226000 and the weight average molecular weight was Mw=497200.

### Preparation Example 2J-4

0.30 g of the polyhydroxyalkanoate copolymer containing units represented by the formula (118) obtained in Preparation Example 2J-3 was put in a round-bottomed flask, and 21.0 ml of chloroform and 7.0 ml of methanol were added thereto to dissolve the copolymer, and the mixture was cooled to 0° C. Thereto was added 0.93 ml of a 2 mol/L hexane solution of trimethylsilyldiazomethane (available from Sigma-Aldrich Corporation), and stirring was conducted for 4 hours. After completion of the reaction, the solvent was removed by an evaporator to recover a polymer. Further, 21.0 ml of chloroform and 7.0 ml of methanol were added thereto to re-dissolve the polymer and the solvent was removed by an evaporator. This procedure was repeated three times. The polymer recovered at this stage was dried under reduced pressure to give 0.30 g of a polymer. The structure of the obtained polymer was determined by ¹H-NMR (FT-NMR: Bruker DPX400; resonance frequency: 400 MHz; measured nuclides: ¹H; solvent used: DMSO-d₆; measured temperature: room temperature). From the result of ¹H-NMR, the obtained polymer was confirmed to be polyhydroxyalkanoate containing units represented by the following formula (119) as monomer units, because a peak attributable to methyl sulfonate was found at 3 to 4 ppm.

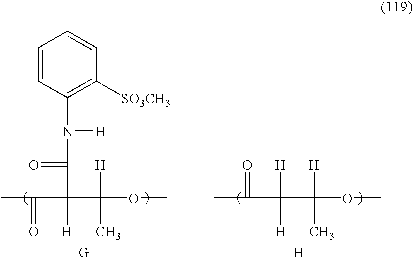

It has been confirmed that the polyhydroxyalkanoate represented by the formula (119) includes 10% by mole of unit G. No peak attributable to sulfonic acid was found by acid value titration using Automatic Potentiometric Titrator AT510 (made by Kyoto Electronics Manufacturing Co., Ltd.), which also proved that sulfonic acid was converted to methyl sulfonate. The average molecular weight of the obtained polymer was evaluated by gel permeation chromatography (GPC: HLC-8120 available from Tosoh Corporation, column: PLgel 5μ MIXED-C available from Polymer Laboratories, solvent: DMF/LiBr 0.1% (w/v), converted to polystyrene). As a result, the number average molecular weight was Mn=228000 and the weight average molecular weight was Mw=513000. The scales of these procedures were increased to produce a large amount of polyhydroxyalkanoate containing units represented by the formula (119), which was named as copolymer (2J).

### Preparation Example 2K-1

In the same manner as in Preparation Example 2J-2 except for using 26.61 g (232.3 mmol) of benzyl bromoacetate instead of benzyl chloroformate, 9.40 g of a polymer was prepared. The obtained polymer was subjected to NMR analysis under the same conditions as in Preparation Example 2J-1 and as a result, confirmed to be polyhydroxyalkanoate containing units represented by the following formula (120), the ratio of the monomer units being 11% by mole of unit A and 89% by mole of unit B.

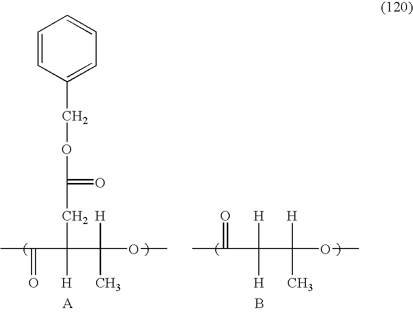

The average molecular weight of the obtained polyhydroxyalkanoate was measured under the same conditions as in Preparation Example 2J-1 and as a result, the number average molecular weight was Mn=300300 and the weight average molecular weight was Mw=723700.

Further, the above-mentioned polymer was subjected to hydrogenolysis in the same manner as in Preparation Example 2J-2 to give 3.66 g of a polymer. The obtained polymer was subjected to NMR analysis under the same conditions as in Preparation Example 2J-1 and as a result, confirmed to be a polyhydroxyalkanoate copolymer containing units represented by the following formula (121) as monomer units. The ratio of the monomer units was confirmed to be 11% by mole of unit C and 89% by mole of unit D.

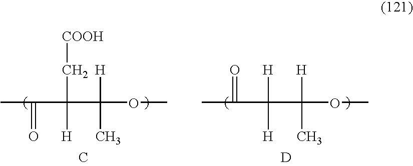

The average molecular weight of the obtained polyhydroxyalkanoate was measured under the same conditions as in Preparation Example 2J-1 and as a result, the number average molecular weight was Mn=286000 and the weight average molecular weight was Mw=700700.

### Preparation Example 2K-2

In a 100 ml three-neck flask were placed in a nitrogen atmosphere 0.40 g of the polyhydroxyalkanoate copolymer containing units represented by the formula (121) (C: 11% by mole, D: 89% by mole) obtained in Preparation Example 2K-1 and 0.23 g (1.5 mmol) of 2-amino-2-methylpropanesulfonic acid. After adding 15.0 ml of pyridine thereto and stirring, 0.78 ml (3.0 mmol) of triphenyl phosphite was added thereto. 0.31 g of a polymer was prepared in the same manner as in Preparation Example 2J-3. The obtained polymer was subjected to NMR analysis and Fourier transform infrared absorption spectrum analysis under the same conditions as in Preparation Example 2J-3, and as a result, confirmed to be polyhydroxyalkanoate containing units represented by the following formula (122), which was a copolymer containing 9% by mole of unit E.

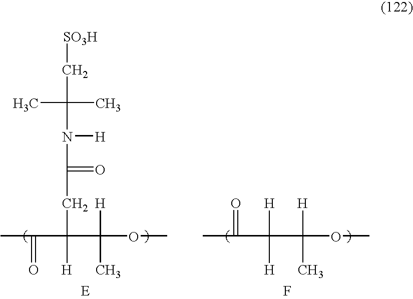

The average molecular weight of the obtained polymer was measured under the same conditions as in Preparation Example 2J-3 and as a result, the number average molecular weight was Mn=225000 and the weight average molecular weight was Mw=540000.

### Preparation Example 2K-3

In the same manner as in Preparation Example 2J-4 except for using the polyhydroxyalkanoate represented by the formula (122) obtained in Preparation Example 2K-2 instead of the polyhydroxyalkanoate represented by the formula (118) in Preparation Example 2J-4 and using 0.83 ml of a 2 mol/L hexane solution of trimethylsilyldiazomethane (available from Sigma-Aldrich Corporation), 0.29 g of a polymer was prepared. The obtained polymer was subjected to NMR analysis under the same conditions as in Preparation Example 2J-4 and as a result, confirmed to be polyhydroxyalkanoate containing units represented by the following formula (123), which was a copolymer containing 9% by mole of unit G.

No peak attributable to sulfonic acid was found by the same acid value titration as in Preparation Example 2J-4, which also proved that sulfonic acid was converted to methyl sulfonate.

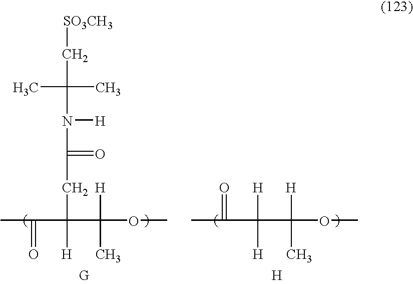

The average molecular weight of the obtained polymer was measured under the same conditions as in Preparation Example 2J-4 and as a result, the number average molecular weight was Mn=228500 and the weight average molecular weight was Mw=548400. The scales of these procedures were increased to produce a large amount of polyhydroxyalkanoate containing units represented by the formula (123), which was named as copolymer (2K).

### Preparation Example 2L-1

In the same manner as in Preparation Example 2J-2 except for using 29.17 g (232.3 mmol) of ethyl 8-bromooctanoate instead of benzyl chloroformate, 8.83 g of a polymer was prepared. The obtained polymer was subjected to NMR analysis under the same conditions as in Preparation Example 2J-1 and as a result, confirmed to be polyhydroxyalkanoate containing units represented by the following formula (124), the ratio of the monomer units being 9% by mole of unit A and 91% by mole of unit B.

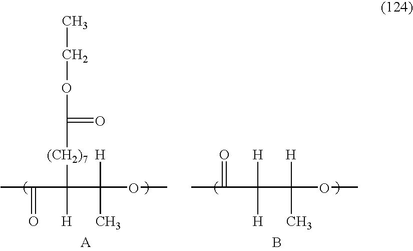

The average molecular weight of the obtained polyhydroxyalkanoate was measured under the same conditions as in Preparation Example 2J-1 and as a result, the number average molecular weight was Mn=321000 and the weight average molecular weight was Mw=776800.

Further, the above-mentioned polymer was subjected to hydrogenolysis in the same manner as in Preparation Example 2J-2 to give 3.85 g of a polymer. The obtained polymer was subjected to NMR analysis under the same conditions as in Preparation Example 2J-1 and as a result, confirmed to be a polyhydroxyalkanoate copolymer containing units represented by the following formula (125) as monomer units. The ratio of the monomer units was confirmed to be 9% by mole of unit C and 91% by mole of unit D.

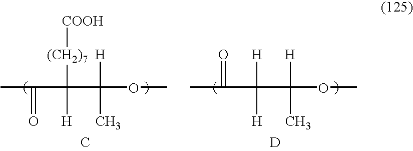

The average molecular weight of the obtained polyhydroxyalkanoate was measured under the same conditions as in Preparation Example 2J-1 and as a result, the number average molecular weight was Mn=298100 and the weight average molecular weight was Mw=715400.

### Preparation Example 2L-2

In a 100 ml three-neck flask were placed in a nitrogen atmosphere 0.40 g of the polyhydroxyalkanoate copolymer containing units represented by the formula (125) (C: 9% by mole, D: 91% by mole) obtained in Preparation Example 2L-1 and 0.22 g (1.2 mmol) of p-toluidine-2-sulfonic acid. After adding 15.0 ml of pyridine thereto and stirring, 0.60 ml (2.3 mmol) of triphenyl phosphite was added thereto. 0.32 g of a polymer was prepared in the same manner as in Preparation Example 2J-3. The obtained polymer was subjected to NMR analysis and Fourier transform infrared absorption spectrum analysis under the same conditions as in Preparation Example 2J-3, and as a result, confirmed to be polyhydroxyalkanoate containing units represented by the following formula (126), which was a copolymer containing 8% by mole of unit E.

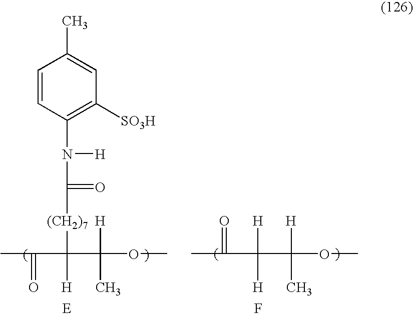

The average molecular weight of the obtained polymer was measured under the same conditions as in Preparation Example 2J-3 and as a result, the number average molecular weight was Mn=215500 and the weight average molecular weight was Mw=538800.

### Preparation Example 2L-3

In the same manner as in Preparation Example 2J-4 except for using the polyhydroxyalkanoate represented by the formula (126) obtained in Preparation Example 2L-2 instead of the polyhydroxyalkanoate represented by the formula (118) in Preparation Example 2J-4 and using 0.71 ml of a 2 mol/L hexane solution of trimethylsilyldiazomethane (available from Sigma-Aldrich Corporation), 0.30 g of a polymer was prepared. The obtained polymer was subjected to NMR analysis under the same conditions as in Preparation Example 2J-4 and as a result, confirmed to be polyhydroxyalkanoate containing units represented by the following formula (127), which was a copolymer containing 8% by mole of unit G.

No peak attributable to sulfonic acid was found by the same acid value titration as in Preparation Example 2J-4, which also proved that sulfonic acid was converted to methyl sulfonate.

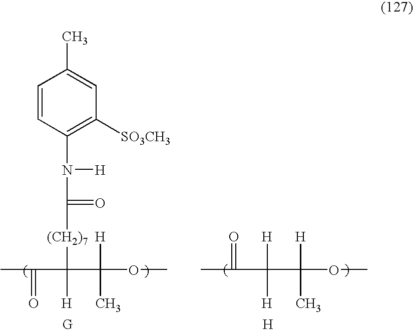

The average molecular weight of the obtained polymer was measured under the same conditions as in Preparation Example 2J-4 and as a result, the number average molecular weight was Mn=218000 and the weight average molecular weight was Mw=555900. The scales of these procedures were increased to produce a large amount of polyhydroxyalkanoate containing units represented by the formula (127), which was named as copolymer (2L)

### Preparation Example 2M-1

In this Preparation Example, polyhydroxyalkanoate is produced by using a microorganism. The microorganism used in this Preparation Example is Pseudomonas cichorii strain YN2 (FERM BP-7375, disclosed in Japanese Patent Application Laid-Open No. 2001-288256). This microorganism is deposited at the International Patent Organism Depository, National Institute of Advanced Industrial Science and Technology.

The inorganic salt medium (M9 medium) and the trace component solution used in this Preparation Example have the same compositions as those used in Preparation Example 2J-1.
(synthesis of poly(3-hydroxy-5-phenylvaleric acid) represented by the formula (128))

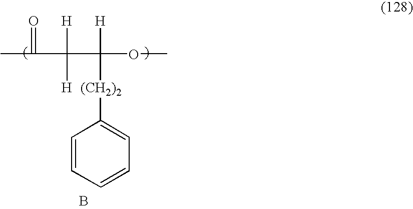

Poly(3-hydroxy-5-phenylvaleric acid) represented by the formula (128) was synthesized according to the method disclosed in Example 1 of Japanese Patent Application Laid-Open No. 2003-319792.

As production medium, 200 mL of M9 medium containing 0.5% (weight/volume (w/v)) of polypeptone (Wako Pure Chemical Industries, Ltd.) and 0.1% (w/v) of 5-phenylvaleric acid was prepared. Thereto was added 1 mL of a culture solution of Pseudomonas cichorii strain YN2, which was previously cultured by shaking for 8 hours at 30° C. in M9 medium containing 0.5% of polypeptone, and the mixture was cultured in a 500 mL shaking flask at 30° C. for 24 hours. After culturing, the bacterial cells were collected by centrifugal separation, washed with methanol and then freeze-dried. The dried bacterial cells were weighed and chloroform was added thereto, and stirring was conducted at 50° C. for 24 hours to extract the polymer. The chloroform mixture in which the polymer is extracted was filtrated and concentrated by an evaporator, and solidified precipitate was then collected with cold methanol and dried under reduced pressure to give 0.60 g of a polymer per 1 L of the production medium. To identify the structure of the obtained polymer, NMR analysis was conducted under the same conditions as in Preparation Example 2J-1, and as a result, the polymer was found to be substantially a homopolymer of poly(3-hydroxy-5-phenylvaleric acid) unit represented by the formula (128) as a monomer unit. The average molecular weight of the obtained polyhydroxyalkanoate was measured under the same conditions as in Preparation Example 2J-1, and as a result, the number average molecular weight was Mn=91000 and the weight average molecular weight was Mw=172900.

According to the above-mentioned method, 60.1 g of polyhydroxyalkanoate was prepared from 100 L of production medium, so as to be used in the following Preparation Examples.

### Preparation Example 2M-2

In the same manner as in Preparation Example 2J-2 except for using 10.00 g of the polyhydroxyalkanoate containing units represented by the formula (128) obtained in Preparation Example 2M-1 instead of the polyhydroxyalkanoate containing units represented by the formula (115) obtained in Preparation Example 2J-2, 28.38 ml (56.8 mmol) of a 2M lithium diisopropylamide solution in THF and 9.68 g (113.5 mmol) of benzyl chloroformate, 8.51 g of a polymer was obtained. The obtained polymer was subjected to NMR analysis under the same conditions as in Preparation Example 2J-1 and as a result, confirmed to be polyhydroxyalkanoate containing units represented by the following formula (129), the ratio of the monomer units being 12% by mole of unit A and 88% by mole of unit B.

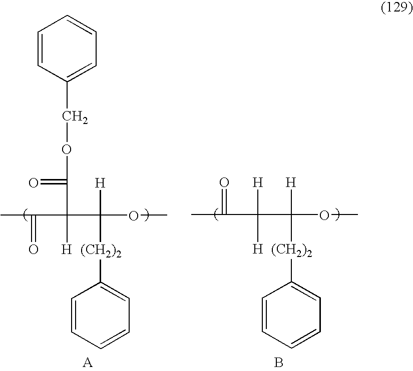

The average molecular weight of the obtained polyhydroxyalkanoate was measured under the same conditions as in Preparation Example 2J-1 and as a result, the number average molecular weight was Mn=72500 and the weight average molecular weight was Mw=141400.

Further, the above-mentioned polymer was subjected to hydrogenolysis in the same manner as in Preparation Example 2J-2 to give 3.72 g of a polymer. The obtained polymer was subjected to NMR analysis under the same conditions as in Preparation Example 2J-1 and as a result, confirmed to be a polyhydroxyalkanoate copolymer containing units represented by the following formula (130) as monomer units. The ratio of the monomer units was confirmed to be 12% by mole of unit C and 88% by mole of unit. D.

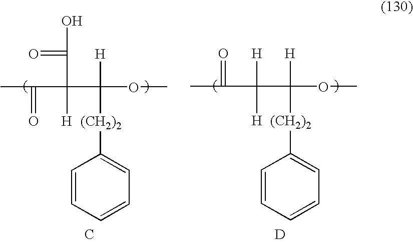

The average molecular weight of the obtained polyhydroxyalkanoate was measured under the same conditions as in Preparation Example 2J-1 and as a result, the number average molecular weight was Mn=69500 and the weight average molecular weight was Mw=139700.

### Preparation Example 2M-3

In a 100 ml three-neck flask were placed in a nitrogen atmosphere 0.40 g of the polyhydroxyalkanoate copolymer containing units represented by the formula (130) (C: 12% by mole, D: 88% by mole) obtained in Preparation Example 2M-2 and 0.23 g (1.3 mmol) of 2-aminobenzenesulfonic acid. After adding 15.0 ml of pyridine thereto and stirring, 0.69 ml (2.6 mmol) of triphenyl phosphite was added thereto. 0.33 g of a polymer was prepared in the same manner as in Preparation Example 2J-3. The obtained polymer was subjected to NMR analysis and Fourier transform infrared absorption spectrum analysis under the same conditions as in Preparation Example 2J-3, and as a result, confirmed to be polyhydroxyalkanoate containing units represented by the following formula (131), which was a copolymer containing 11% by mole of unit E.

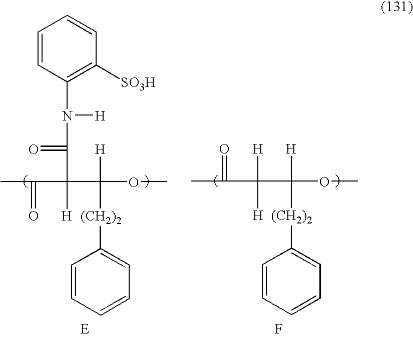

The average molecular weight of the obtained polymer was measured under the same conditions as in Preparation Example 2J-3 and as a result, the number average molecular weight was Mn=55300 and the weight average molecular weight was Mw=113400.

### Preparation Example 2M-4

In the same manner as in Preparation Example 2J-4 except for using the polyhydroxyalkanoate represented by the formula (131) obtained in Preparation Example 2M-3 instead of the polyhydroxyalkanoate represented by the formula (118) in Preparation Example 2J-4 and using 0.83 ml of a 2 mol/L hexane solution of trimethylsilyldiazomethane (available from Sigma-Aldrich Corporation), 0.29 g of a polymer was prepared. The obtained polymer was subjected to NMR analysis under the same conditions as in Preparation Example 2J-4 and as a result, confirmed to be polyhydroxyalkanoate containing units represented by the following formula (132), which was a copolymer containing 11% by mole of unit G.

No peak attributable to sulfonic acid was found by the same acid value titration as in Preparation Example 2J-4, which also proved that sulfonic acid was converted to methyl sulfonate.

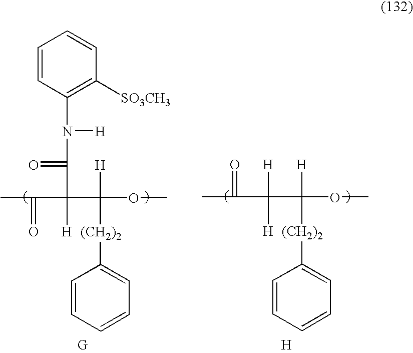

The average molecular weight of the obtained polymer was measured under the same conditions as in Preparation Example 2J-4 and as a result, the number average molecular weight was Mh=54500 and the weight average molecular weight was Mw=114500. The scales of these procedures were increased to produce a large amount of polyhydroxyalkanoate containing units represented by the formula (132), which was named as copolymer (2M).

### Preparation Example 2N-1

In the same manner as in Preparation Example 2M-2 except for using 12.86 g (113.5 mmol) of ethyl 6-bromohexanoate instead of benzyl chloroformate, 7.87 g of a polymer was prepared. The obtained polymer was subjected to NMR analysis under the same conditions as in Preparation Example 2J-1 and as a result, confirmed to be polyhydroxyalkanoate containing units represented by the following formula (133), the ratio of the monomer units being 8% by mole of unit A and 92% by mole of unit B.

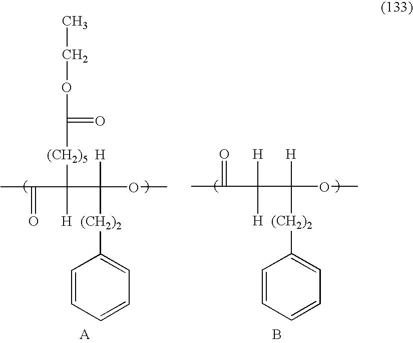

The average molecular weight of the obtained polyhydroxyalkanoate was measured under the same conditions as in Preparation Example 2J-1 and as a result, the number average molecular weight was Mn=71000 and the weight average molecular weight was Mw=134900.

Further, the above-mentioned polymer was subjected to hydrogenolysis in the same manner as in Preparation Example 2J-2 to give 3.95 g of a polymer. The obtained polymer was subjected to NMR analysis under the same conditions as in Preparation Example 2J-1 and as a result, confirmed to be a polyhydroxyalkanoate copolymer containing units represented by the following formula (134) as monomer units. The ratio of the monomer units was confirmed to be 8% by mole of unit C and 92% by mole of unit D.

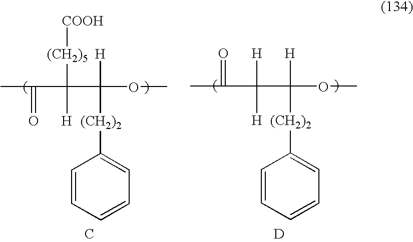

The average molecular weight of the obtained polyhydroxyalkanoate was measured under the same conditions as in Preparation Example 2J-1 and as a result, the number average molecular weight was Mn=68500 and the weight average molecular weight was Mw=133600.

### Preparation Example 2N-2

In a 100 ml three-neck flask were placed in a nitrogen atmosphere 0.40 g of the polyhydroxyalkanoate copolymer containing units represented by the formula (134) (C: 8% by mole, D: 92% by mole) obtained in Preparation Example 2N-1 and 0.15 g (0.9 mmol) of 2-aminobenzenesulfonic acid. After adding 15.0 ml of pyridine thereto and stirring, 0.45 ml (1.7 mmol) of triphenyl phosphite was added thereto. 0.34 g of a polymer was prepared in the same manner as in Preparation Example 2J-3. The obtained polymer was subjected to NMR analysis and Fourier transform infrared absorption spectrum analysis under the same conditions as in Preparation Example 2J-3, and as a result, confirmed to be polyhydroxyalkanoate containing units represented by the following formula (135), which was a copolymer containing 7% by mole of unit E.

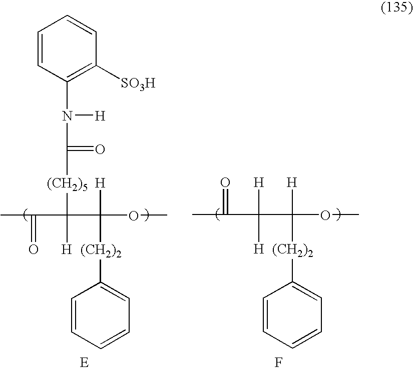

The average molecular weight of the obtained polymer was measured under the same conditions as in Preparation Example 2J-3 and as a result, the number average molecular weight was Mn=54200 and the weight average molecular weight was Mw=108400.

### Preparation Example 2N-3

In the same manner as in Preparation Example 2J-4 except for using the polyhydroxyalkanoate represented by the formula (135) obtained in Preparation Example 2N-2 instead of the polyhydroxyalkanoate represented by the formula (118) in Preparation Example 2J-4 and using 0.54 ml of a 2 mol/L hexane solution of trimethylsilyldiazomethane (available from Sigma-Aldrich Corporation), 0.30 g of a polymer was prepared. The obtained polymer was subjected to NMR analysis under the same conditions as in Preparation Example 2J-4 and as a result, confirmed to be polyhydroxyalkanoate containing units represented by the following formula (136), which was a copolymer containing 7% by mole of unit G.

No peak attributable to sulfonic acid was found by the same acid value titration as in Preparation Example 2J-4, which also proved that sulfonic acid was converted to methyl sulfonate.

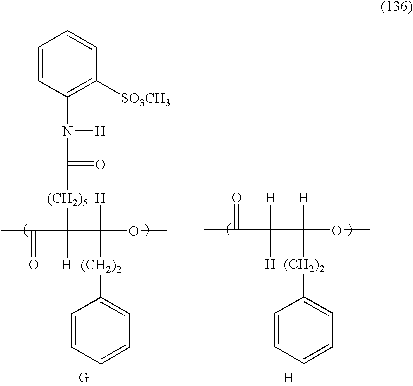

The average molecular weight of the obtained polymer was measured under the same conditions as in Preparation Example 2J-4 and as a result, the number average molecular weight was Mn=52500 and the weight average molecular weight was Mw=110300. The scales of these procedures were increased to produce a large amount of polyhydroxyalkanoate containing units represented by the formula (136), which was named as copolymer (2N)

### Preparation Example 2O-1

(synthesis of poly(3-hydroxy-5-phenoxyvaleric acid) represented by the formula (137))

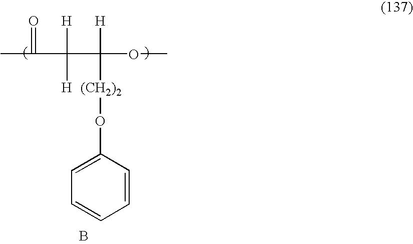

Poly(3-hydroxy-5-phenoxyvaleric acid) represented by the formula (137) was synthesized according to the method disclosed in Example 4 of Japanese Patent Application Laid-Open No. 2003-319792.

To 200 mL of M9 medium containing 0.5% (w/v) of polypeptone and 0.1% (w/v) of 5-phenoxyvaleric acid, which was a production medium, was added 1 mL of a culture solution of Pseudomonas cichorii strain YN2, which was previously cultured by shaking for 8 hours at 30° C. in M9 medium containing 0.5% of polypeptone, and the mixture was cultured in a 500 mL shaking flask at 30° C. for 45 hours. After culturing, the bacterial cells were collected by centrifugal separation, washed with methanol and then freeze-dried. The dried bacterial cells were weighed and chloroform was added thereto, and stirring was conducted at 50° C. for 24 hours to extract the polymer. The chloroform mixture in which the polymer was extracted was filtrated and concentrated by an evaporator, and solidified precipitate was then collected with cold methanol and dried under reduced pressure to give 0.36 g of a polymer per 1 L of the production medium. To identify the structure of the obtained polymer, NMR analysis was conducted under the same conditions as in Preparation Example 2J-1, and as a result, in view of the monomer unit, the polymer was found to be substantially a homopolymer of poly(3-hydroxy-5-phenoxyvaleric acid) represented by the formula (137). The average molecular weight of the obtained polyhydroxyalkanoate was measured under the same conditions as in Preparation Example 2J-1, and as a result, the number average molecular weight was Mn=201000 and the weight average molecular weight was Mw=422100.

According to the above-mentioned method, 44.8 g of polyhydroxyalkanoate was prepared from 125 L of production medium, so as to be used in the following Preparation Examples.

### Preparation Example 2O-2

In the same manner as in Preparation Example 2J-2 except for using 10.00 g of the polyhydroxyalkanoate containing units represented by the formula (137) obtained in Preparation Example 20-1 instead of the polyhydroxyalkanoate containing units represented by the formula (115) obtained in Preparation Example 2J-2, 26.01 ml (52.0 mmol) of a 2M lithium diisopropylamide solution in THF and 8.88 g (104.1 mmol) of benzyl chloroformate, 8.29 g of a polymer was obtained. The obtained polymer was subjected to NMR analysis under the same conditions as in Preparation Example 2J-1 and as a result, confirmed to be polyhydroxyalkanoate containing units represented by the following formula (138), the ratio of the monomer units being 11% by mole of unit A and 89% by mole of unit B.

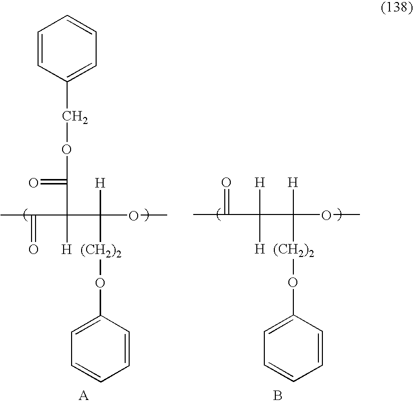

The average molecular weight of the obtained polyhydroxyalkanoate was measured under the same conditions as in Preparation Example 2J-1 and as a result, the number average molecular weight was Mn=131500 and the weight average molecular weight was Mw=282700.

Further, the above-mentioned polymer was subjected to hydrogenolysis in the same manner as in Preparation Example 2J-2 to give 3.75 g of a polymer. The obtained polymer was subjected to NMR analysis under the same conditions as in Preparation Example 2J-1 and as a result, confirmed to be a polyhydroxyalkanoate copolymer containing units represented by the following formula (139) as monomer units, the ratio of the monomer units being 11% by mole of unit C and 89% by mole of unit D.

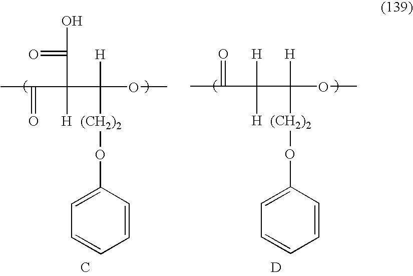

The average molecular weight of the obtained polyhydroxyalkanoate was measured under the same conditions as in Preparation Example 2J-1 and as a result, the number average molecular weight was Mn=121000 and the weight average molecular weight was Mw=260200.

### Preparation Example 20-3

In a 100 ml three-neck flask were placed in a nitrogen atmosphere 0.40 g of the polyhydroxyalkanoate copolymer containing units represented by the formula (139) (C: 11% by mole, D: 89% by mole) obtained in Preparation Example 20-2 and 0.19 g (1.1 mmol) of 2-aminobenzenesulfonic acid. After adding 15.0 ml of pyridine thereto and stirring, 0.58 ml (2.2 mmol) of triphenyl phosphite was added thereto. The subsequent procedures were carried out as in Preparation Example 2J-3 to give 0.33 g of a polymer. The obtained polymer was subjected to NMR analysis and Fourier transform infrared absorption spectrum analysis under the same conditions as in Preparation Example 2J-3, and as a result, confirmed to be polyhydroxyalkanoate containing units represented by the following formula (140), which was a copolymer containing 10% by mole of unit E.

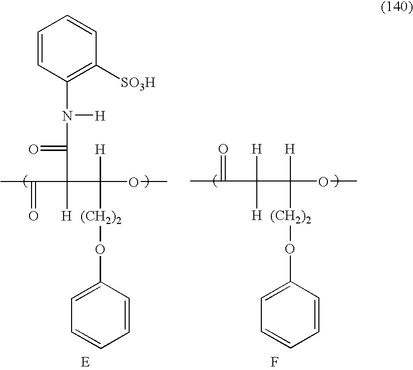

The average molecular weight of the obtained polymer was measured under the same conditions as in Preparation Example 2J-3 and as a result, the number average molecular weight was Mn=100500 and the weight average molecular weight was Mw=221100.

### Preparation Example 2O-4

In the same manner as in Preparation Example 2J-4 except for using the polyhydroxyalkanoate represented by the formula (140) obtained in Preparation Example 2O-3 instead of the polyhydroxyalkanoate represented by the formula (118) in Preparation Example 2J-4 and using 0.71 ml of a 2 mol/L hexane solution of trimethylsilyldiazomethane (available from Sigma-Aldrich Corporation), 0.30 g of a polymer was prepared. The obtained polymer was subjected to NMR analysis under the same conditions as in Preparation Example 2J-4 and as a result, confirmed to be polyhydroxyalkanoate containing units represented by the following formula (141), which was a copolymer containing 10% by mole of unit G.

No peak attributable to sulfonic acid was found by the same acid value titration as in Preparation Example 2J-4, which also proved that sulfonic acid was converted to methyl sulfonate.

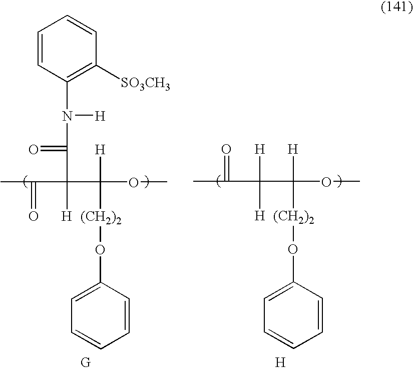

The average molecular weight of the obtained polymer was measured under the same conditions as in Preparation Example 2J-4 and as a result, the number average molecular weight was Mn=101000 and the weight average molecular weight was Mw=227300. The scales of these procedures were increased to produce a large amount of polyhydroxyalkanoate containing units represented by the formula (141), which was named as copolymer (20).

### Preparation Example 2P-1

(synthesis of poly(3-hydroxy-4-cyclohexylbutyric acid) represented by the formula (142))

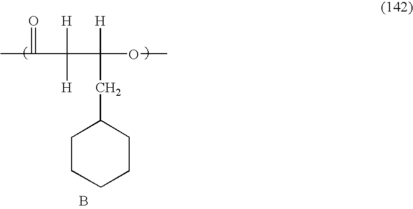

Poly(3-hydroxy-4-cyclohexylbutyric acid) represented by the formula (142) was synthesized according to the method disclosed in Example 9 of Japanese Patent Application Laid-Open No. 2003-319792.

To 200 mL of M9 medium containing 0.5% (w/v) of polypeptone and 0.1% (w/v) of 4-cyclohexylbutyric acid, which was a production medium, was added 1 mL of a culture solution of Pseudomonas cichorii strain YN2, which was previously cultured by shaking for 8 hours at 30° C. in M9 medium containing 0.5% of polypeptone, and the mixture was cultured in a 500 mL shaking flask at 30° C. for 48 hours. After culturing, the bacterial cells were collected by centrifugal separation, washed with methanol and then freeze-dried. The dried bacterial cells were weighed and chloroform was added thereto, and stirring was conducted at 50° C. for 24 hours to extract the polymer. The chloroform mixture in which the polymer was extracted was filtrated and concentrated by an evaporator, and solidified precipitate was then collected with cold methanol and dried under reduced pressure to give 0.48 g of a polymer per 1 L of the production medium. To identify the structure of the obtained polymer, NMR analysis was conducted under the same conditions as in Preparation Example 2J-1, and as a result, the polymer was found to be substantially a homopolymer of poly(3-hydroxy-4-cyclohexylbutyric acid) represented by the formula (142) as a monomer unit. The average molecular weight of the obtained polyhydroxyalkanoate was measured under the same conditions as in Preparation Example 2J-1, and as a result, the number average molecular weight was Mn=70500 and the weight average molecular weight was Mw=155100.

According to the above-mentioned method, 47.9 g of polyhydroxyalkanoate was prepared from 100 L of production medium, so as to be used in the following Preparation Examples.

### Preparation Example 2P-2

In the same manner as in Preparation Example 2J-2 except for using 10.00 g of the polyhydroxyalkanoate containing units represented by the formula (142) obtained in Preparation Example 2P-1 instead of the polyhydroxyalkanoate containing units represented by the formula (115) obtained in Preparation Example 2J-2, 29.72 ml (59.4 mmol) of a 2M lithium diisopropylamide solution in THF and 10.14 g (118.9 mmol) of benzyl chloroformate, 7.66 g of a polymer was obtained. The obtained polymer was subjected to NMR analysis under the same conditions as in Preparation Example 2J-1 and as a result, confirmed to be polyhydroxyalkanoate containing units represented by the following formula (143), the ratio of the monomer units being 10% by mole of unit A and 90% by mole of unit B.

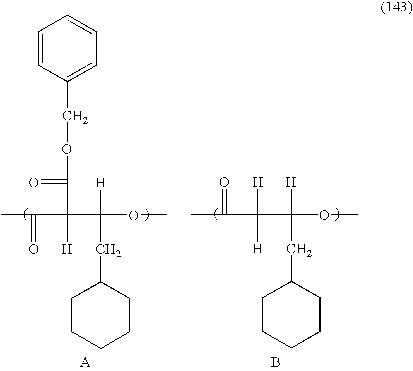

The average molecular weight of the obtained polyhydroxyalkanoate was measured under the same conditions as in Preparation Example 2J-1 and as a result, the number average molecular weight was Mn=54400 and the weight average molecular weight was Mw=110700.

Further, the above-mentioned polymer was subjected to hydrogenolysis in the same manner as in Preparation Example 2J-2 to give 3.85 g of a polymer. The obtained polymer was subjected to NMR analysis under the same conditions as in Preparation Example 2J-1 and as a result, confirmed to be a polyhydroxyalkanoate copolymer containing units represented by the following formula (144) as monomer units. The ratio of the monomer units was confirmed to be 10% by mole of unit C and 90% by mole of unit D.

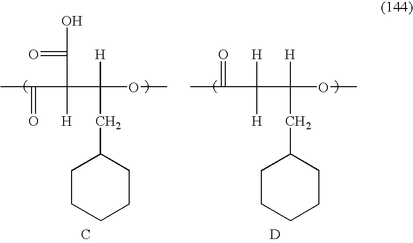

The average molecular weight of the obtained polyhydroxyalkanoate was measured under the same conditions as in Preparation Example 2J-1 and as a result, the number average molecular weight was Mn=47500 and the weight average molecular weight was Mw=103600.

### Preparation Example 2P-3

In a 100 ml three-neck flask were placed in a nitrogen atmosphere 0.40 g of the polyhydroxyalkanoate copolymer containing units represented by the formula (144) (C: 10% by mole, D: 90% by mole) obtained in Preparation Example 2P-2 and 0.26 g (1.2 mmol) of 2-amino-1-naphthalene sulfonic acid. After adding 15.0 ml of pyridine thereto and stirring, 0.60 ml (2.3 mmol) of triphenyl phosphite was added thereto. The subsequent procedures were carried out as in Preparation Example 2J-3 to give 0.36 g of a polymer. The obtained polymer was subjected to NMR analysis and Fourier transform infrared absorption spectrum analysis under the same conditions as in Preparation Example 2J-3, and as a result, confirmed to be polyhydroxyalkanoate containing units represented by the following formula (145), which was a copolymer containing 9% by mole of unit E.

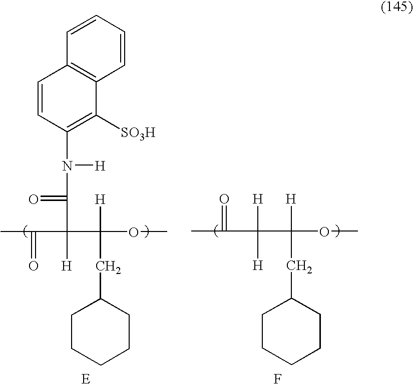

The average molecular weight of the obtained polymer was measured under the same conditions as in Preparation Example 2J-3 and as a result, the number average molecular weight was Mn=30500 and the weight average molecular weight was Mw=65600.

### Preparation Example 2P-4

In the same manner as in Preparation Example 2J-4 except for using the polyhydroxyalkanoate represented by the formula (145) obtained in Preparation Example 2P-3 instead of the polyhydroxyalkanoate represented by the formula (118) in Preparation Example 2J-4 and using 0.71 ml of a 2 mol/L hexane solution of trimethylsilyldiazomethane (available from Sigma-Aldrich Corporation), 0.28 g of a polymer was prepared. The obtained polymer was subjected to NMR analysis under the same conditions as in Preparation Example 2J-4 and as a result, confirmed to be polyhydroxyalkanoate containing units represented by the following formula (146), which was a copolymer containing 9% by mole of unit G.

No peak attributable to sulfonic acid was found by the same acid value titration as in Preparation Example 2J-4, which also proved that sulfonic acid was converted to methyl sulfonate.

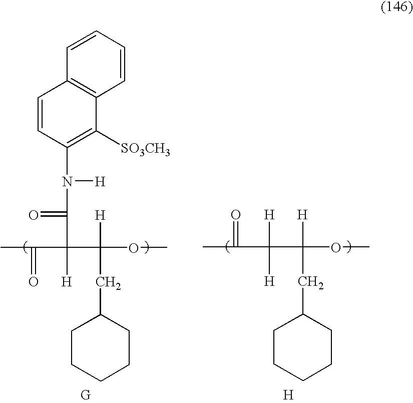

The average molecular weight of the obtained polymer was measured under the same conditions as in Preparation Example 2J-4 and as a result, the number average molecular weight was Mn=31000 and the weight average molecular weight was Mw=68200. The scales of these procedures were increased to produce a large amount of polyhydroxyalkanoate containing units represented by the formula (146), which was named as copolymer (2P)

### Preparation Example 2Z-1

[synthesis of 3,6-di(3-butenyl)-1,4-dioxane-2,5-dione represented by the formula (147) in which m=2, from 2-hydroxy-5-hexenoic acid] 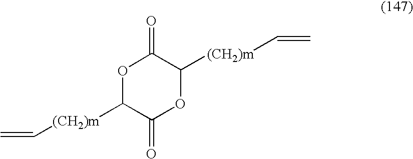
(m is an integer selected from 2 to 8.)

3,6-di(3-butenyl)-1,4-dioxane-2,5-dione used in Preparation Example A-1 is synthesized as follows.

To a 1 L flask equipped with a reflux condenser and a Dean-Stark trap were added 3.0 g of 2-hydroxy-5-hexenoic acid, 400 ml of toluene and 30 mg of p-toluene sulfonic acid, and the mixture was refluxed in a nitrogen atmosphere. Water collected in the trap was occasionally removed. After refluxing for 72 hours, the system was cooled. Washing with 10 ml of a saturated aqueous sodium hydrogen carbonate solution was conducted twice and the obtained crude product was then distilled under reduced pressure in the presence of zinc oxide to give 1.06 g of the intended 3,6-di(3-butenyl)-1,4-dioxane-2,5-dione (yield 41%).

To identify the structure of the obtained compound, NMR analysis was conducted under the following conditions.

<measuring instrument> FT-NMR: Bruker DPX400

resonance frequency: ¹H=400 MHz

<measuring condition> measured nuclides: ¹H

solvent used: DMSO-d₆

measured temperature: room temperature

As a result, the obtained compound was confirmed to be the intended 3,6-di(3-butenyl)-1,4-dioxane-2,5-dione.

### Preparation Example 2Z-2

7-(3-butenyl)-2-oxepanone used in Preparation Example B-1 was prepared with reference to the method described in Japanese Patent Laid-Open No. H05-310721. More specifically, 7-(3-butenyl)-2-oxepanone was prepared by using 2-(3-butenyl)cyclohexanone instead of 2-allylcyclohexanone which is the raw material disclosed in Example 43 of the publication.

### Preparation Example 2Z-3

[synthesis of 3-(9-decenyl)-2-oxetanone described in Preparation Example E-1]

3-(9-decenyl)-2-oxetanone can be synthesized by using β-propiolactone instead of γ-butyrolactone and 10-bromo-1-decene instead of allyl bromide in the synthesis of dihydro-3-(2-propenyl)furan-2(3H)-one described in Journal of American Chemical Society 1995, 117, 3705-3716 (described therein as compound (6a) in Non-patent Document).

Specifically, 7.20 g (100.0 mmol) of β-propiolactone was placed in a round-bottomed flask and 55 ml of THF was added thereto to dissolve it. In a nitrogen atmosphere, stirring was conducted at −78° C. Thereto was then gradually added 55 ml of a 2M lithium diisopropylamide solution in THF, followed by stirring at −78° C. for 20 minutes. Subsequently, 26.30 g (110.0 mmol) of 10-bromo-1-decene dissolved in 38 ml of hexamethylphosphoramide (HMPA) was added thereto and the mixture was stirred at −30° C. for 3 hours. After completion of the reaction, the reaction mixture was poured into an aqueous ammonium chloride solution and then dichloromethane was added thereto to extract the organic layer. After washing with water three times, the organic layer was recovered. The recovered organic layer was dried over anhydrous sodium sulfate. After removing sodium sulfate, the solution was removed to recover crude 3-(9-decenyl)-2-oxetanone. The substance was then purified by silica gel column chromatography and distilled under reduced pressure to give 15.14 g of the intended 3-(9-decenyl)-2-oxetanone. To identify the structure of the obtained compound, NMR analysis was conducted under the following conditions.

<measuring instrument> FT-NMR: Bruker DPX400

resonance frequency: ¹H=400 MHz

<measuring condition> measured nuclides: ¹H

solvent used: CDCl₃

measured temperature: room temperature

As a result, the obtained compound was confirmed to be the intended 3-(9-decenyl)-2-oxetanone.

### Preparation Example 2Z-4

[synthesis of tetrahydro-3-(2-propenyl)-2H-pyran-2-one described in Preparation Examples D-1 and 2B-1]

In the same manner as in Preparation Example 2Z-3 except for using 10.01 g (100.0 mmol) of δ-valerolactone instead of β-propiolactone described in Preparation Example 2Z-3 and 14.52 g (110.0 mmol) of allyl bromide instead of 10-bromo-1-decene described in Preparation Example 2Z-3, 9.81 g of the intended tetrahydro-3-(2-propenyl)-2H-pyran-2-one was prepared.

### Preparation Example 2Z-5

[synthesis of 3-(2-propenyl)-2-oxepanone described in Preparation Example F-1]

In the same manner as in Preparation Example 2Z-3 except for using 11.41 g (100.0 mmol) of ε-caprolactone instead of β-propiolactone described in Preparation Example 2Z-3 and 14.52 g (110.0 mmol) of allyl bromide instead of 10-bromo-1-decene described in Preparation Example 2Z-3, 10.02 g of the intended 3-(2-propenyl)-2-oxepanone was prepared.

### Example 1

1 part by weight of carbon black

9 parts by weight of crystalline graphite

25 parts by weight of copolymer (A)

65 parts by weight of toluene

The above-described materials were charged with 1 mm-diameter zirconia beads as media particles, and the resulting mixture was dispersed for 2 hours using a sand mill. The beads were then separated off using a sieve, to thereby yield a coating solution. Using this coating solution, a coating layer was formed on a NP-6035 (model name, manufactured by Canon Inc.) developing sleeve surface by spraying. This layer was subsequently cured by heating at 150° C. for 30 minutes using a hot-air drying furnace, to thereby produce a developer carrying member according to the present example having a resin layer on the sleeve. The resin layer composition of the obtained developer carrying member is shown in Table 1. In addition, the developer carrying member according to the present example was evaluated by the below-described method and criteria. The results are shown in Tables 3 and 4.

During evaluation a toner was employed that had been produced using the following raw materials. 100 parts by weight of styrene-acrylic resin (Tg 56° C.)

80 parts by weight of magnetite

2 parts by weight of positive charge control agent

4 parts by weight of low-molecular weight polypropylene

The above-described constituent materials were melt-kneaded, pulverized and dispersed to yield a positively-charged toner having a 6 μm weight average particle diameter, to which was added 0.9% by weight of colloidal silica, which had been subjected to coupling treatment using trimethoxysilyl-γ-propylnenzylamine, as a positively-charged additive. A positively-charged one-component magnetic toner A was thus obtained.

Using the developer carrying member according to the present example and the above-described toner A, an imaging test was carried out using an NP-6035 (model name) under conditions of H/H (high temperature and high humidity, 32.5° C./80%) and N/L (normal temperature and low humidity, 22.5° C./10%). The evaluation results under the N/L environment are shown in Table 3, and the evaluation results under the H/H environment are shown in Table 4.

[Evaluation]

(1) Image Density

Using a reflection densitometer RD918 (model name, manufactured by Macbeth), the density of the black solid portion of the obtained image was measured, and the decrease in image density was evaluated at that value.

(2) Triboelectricity

The triboelectricity of the developer on the developer carrying member was measured using the following suction method. The measurement of the triboelectric value using a suction method involves first attaching a suction port made of a metal that fits the shape of the developer carrying member surface to a measuring vessel having a thimble, and adjusting the suction pressure so that an appropriate amount of the developer layer on the developer carrying member surface can be uniformly sucked (preferably no longer than 5 minutes) to suck up the developer. The developer charge Q that was sucked up at this time was measured using a 616 Digital Electrometer (model name, manufactured by Keithley Instruments Inc.). Taking M as the weight, the triboelectric value was calculated from Q/M (mC/kg).

(3) Inversion Fog

The reflectance of a solid white image in a suitable image was measured, and also measured was the reflectance of a virgin transfer paper sheet. The inversion fog density is represented by the difference between “the minimum reflectance of the solid white image” and “the maximum reflectance of the virgin transfer paper sheet”. Both images were visually observed for evaluation according to the below-described criteria. A 127.9 g/m² cardboard was used as the transfer paper, and the reflectance was measured using a TC-6DS (model name, manufactured by Tokyo Denshoku K.K.).

⊚: A inversion fog density of 1.5 or less, fogging hardly detectable.

◯: A inversion fog density of above 1.5 to 2.5 or less, fogging detectable only with careful examination.

Δ: A inversion fog density of more than 2.5 to 3.5 or less, fogging more detectable as the image was formed.

Δx: A inversion fog density of more than 3.5 to 4.0 or less, the limit for practical use, fogging detectable at a glance.

x: A inversion fog density of more than 4.0 to 5.0 or less, significant fogging.

(4) Image Defects (Streaks, Unevenness, Blotches)

Various kinds of images such as black solid, half-tone, and line images were confirmed. Toner coating defects on the developing sleeve, such as streaks, wave-like unevenness and blotch (dot-like unevenness), at the time of image formation were visually observed. These results were used as a reference for evaluation under the following criteria.

⊚: No defects could be confirmed on either the image or on the sleeve.

◯: Defects could be slightly confirmed on the sleeve, but hardly any detected on the image.

◯Δ: Defects could be confirmed by looking through an image for one sheet out of about every several to several ten sheets.

Δ◯: Defects could be confirmed in the first sheet of a half-tone image or black solid image and also detected at a first rotation of the sleeve cycle.

Δ: Defects could be confirmed on the half-tone image or black solid image. Lower limit for practical use.

Δx: Image defects could be confirmed over the whole black solid image. Below the level required for practical use.

x: Defects could also be confirmed on the white solid image.

(5) Conductive Resin Layer Scraping Amount (Shaving)

After the images had been formed and evaluated under the respective environments, the developing sleeve was removed for measurement of its outside diameter using the laser length-measuring machine Y-CTF (model name, manufactured by Magara Keisoku Kaihatsu). The conductive resin layer scraping amount was calculated from this measured value and the outside diameter measured value of the developing sleeve prior to imaging, whereby a 30-point average value was taken as shaving (μm).

### Example 2

The developer carrying member according to the present example was produced using the same procedures as those in Example 1, except that the copolymer (B) was used in place of the copolymer (A) of Example 1. The resin layer composition of the obtained developer carrying member is shown in Table 1. In addition, using the obtained developer carrying member, an imaging test was carried out while supplying toner A in the same manner as in Example 1 for evaluation. The results are shown in Tables 3 and 4.

### Example 3

The developer carrying member according to the present example was produced using the same procedures as those in Example 1, except that the copolymer (C) was used in place of the copolymer (A) of Example 1. The resin layer composition of the obtained developer carrying member is shown in Table 1. In addition, using the obtained developer carrying member, an imaging test was carried out while supplying toner A in the same manner as in Example 1 for evaluation. The results are shown in Tables 3 and 4.

### Example 4

The same materials as those of Example 1 were dispersed using the same procedures as those in Example 1, and subsequently charged with 5 parts of conductive spherical carbon particles having a number average particle diameter of 5 μm. The resulting mixture was dispersed for 1 hour using 3 mm-diameter glass beads, and the beads were then separated off using a sieve, to thereby yield a coating solution. Next, a resin layer was formed using the same procedures as those in Example 1, to thereby produce the developer carrying member according to the present example. The resin layer composition of the obtained developer carrying member is shown in Table 1.

In addition, using the obtained developer carrying member, an imaging test was carried out while supplying toner A in the same manner as in Example 1 for evaluation. The results are shown in Tables 3 and 4.

The conductive spherical carbon particles used in the present example were obtained by evenly coating 14 parts by weight of coal bulk mesophase pitch powder having a number average particle diameter of 1.5 μm or less onto the surface of 100 parts by weight of spherical phenol resin particles having a number average particle diameter of 5.5 μm using a grinding machine (automatic mortar, manufactured by Ishikawa Kojo), heat-stabilizing the resulting particles in an oxidizing atmosphere, and then graphitizing the particles by baking at 2,200° C. The obtained conductive spherical carbon particles had a number average particle diameter of 5 μm, a true density of 1.50 g/cm³, a volume resistivity of 7.5×10⁻² Ω·cm, and a major axis/minor axis ratio of 1.15.

### Example 5

1 part by weight of carbon black

9 parts by weight of crystalline graphite

25 parts by weight of PMMA resin

5 parts by weight of copolymer (A)

65 parts by weight of toluene

Using the above-described material, the developer carrying member according to the present example was produced by dispersing and then forming a resin layer using the same procedures as those in Example 1. In addition, using the obtained developer carrying member, an imaging test was carried out while supplying toner A in the same manner as in Example 1 for evaluation. The results are shown in Tables 3 and 4.

### Example 6

The developer carrying member according to the present example was produced by forming a resin layer using the same procedures as those in Example 5, except that the copolymer (B) was used in place of the copolymer (A) of Example 5. The resin layer composition of the obtained developer carrying member is shown in Table 1. In addition, using the obtained developer carrying member, an imaging test was carried out while supplying toner A in the same manner as in Example 1 for evaluation. The results are shown in Tables 3 and 4.

### Example 7

The developer carrying member according to the present example was produced by forming a resin layer using the same procedures as those in Example 5, except that the copolymer (C) was used in place of the copolymer (A) of Example 5. The resin layer composition of the obtained developer carrying member is shown in Table 1. In addition, using the obtained developer carrying member, an imaging test was carried out while supplying toner A in the same manner as in Example 1 for evaluation. The results are shown in Tables 3 and 4.

### Example 8

The same materials as those of Example 5 were subjected to dispersion using the same procedures as those in Example 5, and subsequently charged with 5 parts of conductive spherical carbon particles having a number average particle diameter of 5 μm. The resulting mixture was dispersed for 1 hour using 3 mm-diameter-glass beads, and the beads were then separated off using a sieve, to thereby yield a coating solution. Next, a resin layer was formed using the same procedures as those in Example 1, to thereby produce the developer carrying member according to the present example. The resin layer composition of the obtained developer carrying member is shown in Table 1.

In addition, using the obtained developer carrying member, an imaging test was carried out while supplying toner A in the same manner as in Example 1 for evaluation. The results are shown in Tables 3 and 4.

The conductive spherical carbon particles used in the present example were obtained by evenly coating 14 parts by weight of coal bulk mesophase pitch powder having a number average particle diameter of 1.5 μm or less onto the surface of 100 parts by weight of spherical phenol resin particles having a number-average particle diameter of 5.5 μm using a grinding machine (automatic mortar, manufactured by Ishikawa Kojo), heat-stabilizing the resulting particles in an oxidizing atmosphere, and then graphitizing the particles by baking at 2,200° C. The obtained conductive spherical carbon particles had a number average particle diameter of 5 μm, a true density of 1.50 g/cm³, a volume resistivity of 7.5×10⁻² Ω·cm, and a major axis/minor axis ratio of 1.15.

### Example 9

The developer carrying member according to the present example was produced by forming a resin layer using the same procedures as those in Example 8, except that 7.5 parts of conductive spherical carbon particles having a number average particle diameter of 2 μm were used in place of the conductive spherical carbon particles having a number average particle diameter of 5 μm used in Example 8. The resin layer composition of the obtained developer carrying member is shown in Table 1. In addition, using the obtained developer carrying member, an imaging test was carried out while supplying toner A in the same manner as in Example 1 for evaluation. The results are shown in Tables 3 and 4.

The conductive spherical carbon particles having a number average particle diameter of 2 μm used in the present example were obtained by evenly coating 14 parts of coal bulk mesophase pitch powder having a number average particle diameter of 0.3 μm or less onto the surface of 100 parts of spherical phenol resin particles having a number-average particle diameter of 2.3 μm using a grinding machine (automatic mortar, manufactured by Ishikawa Kojo), heat-stabilizing the resulting particles in an oxidizing atmosphere, and then graphitizing the particles by baking at 2,200° C. The obtained conductive spherical carbon particles had a true density of 1.52 g/cm³, a volume resistivity of 7.2×10⁻² Ω·cm, and a major axis/minor axis ratio of 1.12.

### Example 10

The developer carrying member according to the present example was produced by forming a resin layer using the same procedures as those in Example 8, except that 2.5 parts of conductive spherical carbon particles having a number average particle diameter of 20 μm were used in place of the conductive spherical carbon particles having a number average particle diameter of 5 μm used in Example 8. The resin layer composition of the obtained developer carrying member is shown in Table 1. In addition, using the obtained developer carrying member, an imaging test was carried out while supplying toner A in the same manner as in Example 1 for evaluation. The results are shown in Tables 3 and 4.

The conductive spherical carbon particles having a number average particle diameter of 20 μm used in the present example were obtained by evenly coating 14 parts of coal bulk mesophase pitch powder having a number average particle diameter of 3 μm or less onto the surface of 100 parts of spherical phenol resin particles having a number average particle diameter of 24 μm using a grinding machine (automatic mortar, manufactured by Ishikawa Kojo), heat-stabilizing the resulting particles in an oxidizing atmosphere, and then graphitizing the particles by baking at 2,200° C. The obtained conductive spherical carbon particles had a true density of 1.45 g/cm³, a volume resistivity of 9.6×10⁻² Ω·cm, and a major axis/minor axis ratio of 1.18.

### Example 11

The developer carrying member according to the present example was produced by forming a resin layer using the same procedures as those in Example 8, except that carbon black-coated PMMA particles having a number average particle diameter of 5 μm were used in place of the conductive spherical carbon particles having a number average particle diameter of 5 μm used in Example 8. The resin layer composition of the obtained developer carrying member is shown in Table 1. In addition, using the obtained developer carrying member, an imaging test was carried out while supplying toner A in the same manner as in Example 1 for evaluation. The results are shown in Tables 3 and 4.

The carbon black-coated PMMA particles having a number average particle diameter of 5 μm that were used were conductive spherical PMMA particles obtained by coating 5 parts of conductive carbon black onto 100 parts of spherical PMMA particles having a number average particle diameter of 4.8 μm using a hybridizer (manufactured by Nara Machinery Co., Ltd.). These particles had a true density of 1.20 g/cm³, a volume resistivity of 6.8×10⁻¹ Ω·cm, and a major axis/minor axis ratio of 1.06.

### Example 12

The developer carrying member according to the present example was produced by forming a resin layer using the same procedures as those in Example 8, except that carbon black dispersed resin particles having a number average particle diameter of 5 μm were used in place of the conductive spherical carbon particles having a number average particle diameter of 5 μm used in Example 8. The resin layer composition of the obtained developer carrying member is shown in Table 1. In addition, using the obtained developer carrying member, an imaging test was carried out while supplying toner A in the same manner as in Example 1 for evaluation. The results are shown in Tables 3 and 4.

The carbon black resin particles having a number average particle diameter of 5 μm that were used were obtained by subjecting the below-described material to mixing, pulverizing and classification to thereby yield conductive resin particles having a number average particle diameter of 5.3 μm, and then using a hybridizer (manufactured by Nara Machinery Co., Ltd.) to make spherical. The obtained spherical conductive carbon particles had a true density of 1.21 g/cm³, a volume resistivity of 5.2 Ω·cm, and a major axis/minor axis ratio of 1.20.

100 parts by weight of styrene-dimethylaminoethylmethacrylate-divinylbenzene copolymer (copolymer ratio=90:10:0.05)

25 parts by weight of carbon black

### Example 13

The developer carrying member according to the present example was produced by forming a resin layer using the same procedures as those in Example 8, except that PMMA particles having a number average particle diameter of 5 μm were used in place of the conductive spherical carbon particles having a number average particle diameter of 5 μm used in Example 8. The resin layer composition of the obtained developer carrying member is shown in Table 1. In addition, using the obtained developer carrying member, an imaging test was carried out while supplying toner A in the same manner as in Example 1 for evaluation. The results are shown in Tables 3 and 4.

### Example 14

The developer carrying member according to the present example was produced by forming a resin layer using the same procedures as those in Example 8, except that a silicone resin was used in place of the PMMA resin used in Example 8. The resin layer composition of the obtained developer carrying member is shown in Table 1. In addition, using the obtained developer carrying member, an imaging test was carried out while supplying toner A in the same manner as in Example 1 for evaluation. The results are shown in Tables 3 and 4.

### Example 15

The developer carrying member according to the present example was produced by forming a resin layer using the same procedures as those in Example 8, except that a styrene-acrylic resin was used in place of the PMMA resin used in Example 8. The resin layer composition of the obtained developer carrying member is shown in Table 1. In addition, using the obtained developer carrying member, an imaging test was carried out while supplying toner A in the same manner as in Example 1 for evaluation. The results are shown in Tables 3 and 4.

### Example 16

The developer carrying member according to the present example was produced by forming a resin layer using the same procedures as those in Example 8, except that a polyester resin was used in place of the PMMA resin used in Example 8. The resin layer composition of the obtained developer carrying member is shown in Table 1. In addition, using the obtained developer carrying member, an imaging test was carried out while supplying toner A in the same manner as in Example 1 for evaluation. The results are shown in Tables 3 and 4.

### Comparative Example 1

The developer carrying member according to the present comparative example was produced in the same manner as that in Example 1, except that rather than forming a resin layer as in Example 1, an FGB sleeve was employed that had its substrate surface sandblasted using particle diameter #300 glass beads. The resin layer composition of the obtained developer carrying member is shown in Table 2. In addition, using the obtained developer carrying member, an imaging test was carried out while supplying toner A in the same manner as in Example 1 for evaluation. The results are shown in Tables 3, 4, 6 and 7.

### Comparative Example 2

The developer carrying member according to the present comparative example was produced by forming a resin layer in the same manner as in Example 5, except for omitting the copolymer (A) used in Example 5. The resin layer composition of the obtained developer carrying member is shown in Table 2. In addition, using the obtained developer carrying member, an imaging test was carried out while supplying toner A in the same manner as in Example 1 for evaluation. The results are shown in Tables 3, 4, 6 and 7.

### Comparative Example 3

The developer carrying member according to the present comparative example was produced by forming a resin layer in the same manner as in Example 14, except for omitting the copolymer (A) and the conductive spherical carbon particles used in Example 14. The resin layer composition of the obtained developer carrying member is shown in Table 2. In addition, using the obtained developer carrying member, an imaging test was carried out while supplying toner A in the same manner as in Example 1 for evaluation. The results are shown in Tables 3, 4, 6 and 7.

### Comparative Example 4

The developer carrying member according to the present comparative example was produced by forming a resin layer in the same manner as in Example 16, except for omitting the copolymer (A) and the conductive spherical carbon particles used in Example 16. The resin layer composition of the obtained developer carrying member is shown in Table 2. In addition, using the obtained developer carrying member, an imaging test was carried out while supplying toner A in the same manner as in Example 1 for evaluation. The results are shown in Tables 3, 4, 6 and 7.

### Comparative Example 5

The developer carrying member according to the present comparative example was produced by forming a resin layer in the same manner as in Example 4, except that PMMA was used in place of the copolymer (A) of Example 4 and that a chromium complex (S) of chlorophenol-containing azonaphthol was used in place of the conductive spherical carbon particles. The resin layer composition of the obtained developer carrying member is shown in Table 2. In addition, using the obtained developer carrying member, an imaging test was carried out while supplying toner A in the same manner as in Example 1 for evaluation. The results are shown in Tables 3, 4, 6 and 7.

### Comparative Example 6

The developer carrying member according to the present comparative example was produced by forming a resin layer in the same manner as in Example 5, except that a quaternary ammonium salt was used in place of the copolymer (A) of Example 5. The resin layer composition of the obtained developer carrying member is shown in Table 2. In addition, using the obtained developer carrying member, an imaging test was carried out while supplying toner A in the same manner as in Example 1 for evaluation. The results are shown in Tables 3, 4, 6 and 7.

TABLE 1
Resin Layer Composition of the Developing sleeve Surface

| | | Roughness Ra | Binder resin | | Added Spherical Particles |
|---|---|---|---|---|---|
| Example | P/B/CA/R Ratio*¹ | (μm) | Copolymer | Other Resin | (number average particle diameter) |
| 1 | 1/0.0/2.5/0.0 | 0.57 | (A) | none | none |
| 2 | 1/0.0/2.5/0.0 | 0.57 | (B) | none | none |
| 3 | 1/0.0/2.5/0.0 | 0.57 | (C) | none | none |
| 4 | 1/0.0/2.5/0.5 | 0.60 | (A) | none | conductive spherical carbon particles (5 μm) |
| 5 | 1/2.5/0.5/0.0 | 0.62 | (A) | PMMA | none |
| 6 | 1/2.5/0.5/0.0 | 0.61 | (B) | PMMA | none |
| 7 | 1/2.5/0.5/0.0 | 0.62 | (C) | PMMA | none |
| 8 | 1/2.5/0.5/0.5 | 0.71 | (A) | PMMA | conductive spherical carbon particles (5 μm) |
| 9 | 1/2.5/0.5/0.75 | 0.62 | (A) | PMMA | conductive spherical carbon particles (2 μm) |
| 10 | 1/2.5/0.5/0.25 | 1.03 | (A) | PMMA | conductive spherical carbon particles (20 μm) |
| 11 | 1/2.5/0.5/0.5 | 0.77 | (A) | PMMA | carbon black-coated PMMA spherical particles |
| | | | | | (5 μm) |
| 12 | 1/2.5/0.5/0.5 | 0.72 | (A) | PMMA | carbon black dispersed spherical resin |
| | | | | | particles (5 μm) |
| 13 | 1/2.5/0.5/0.5 | 0.66 | (A) | PMMA | PMMA spherical particles (5 μm) |
| 14 | 1/2.5/0.5/0.5 | 0.79 | (A) | silicone | conductive spherical carbon particles (5 μm) |
| 15 | 1/2.5/0.5/0.5 | 0.74 | (A) | St-Ac*² | conductive spherical carbon particles (5 μm) |
| 16 | 1/2.5/0.5/0.5 | 0.72 | (A) | polyester | conductive spherical carbon particles (5 μm) |

*¹P: fine conductive powder (CB/GF = 1/9, where CB is carbon black and GF is crystalline graphite) B: Other resin, CA: copolymer, R: spherical particles
*²St-Ac: styrene-acrylic resin

TABLE 2
Resin Layer Composition of the Developing sleeve

| Comparative | | Roughness Ra | Binder resin | |
|---|---|---|---|---|
| Example | P/B/CA/R Ratio*¹ | (μm) | Other Resin | Added Particles |
| 1 | no resin layer, substance used had been sandblasted using particle | | | |
| | diameter #300 glass beads, wherein Ra = 0.55 | | | |
| 2 | 1/2.5/0.0/0.0 | 0.52 | PMMA | None |
| 3 | 1/2.5/0.0/0.0 | 0.51 | silicone | None |
| 4 | 1/2.5/0.0/0.0 | 0.59 | Polyester | None |
| 5 | 1/2.5/0.0/0.5 | 0.64 | PMMA | chlorophenol-containing azonaphthol |
| | | | | chromium medium |
| 6 | 1/2.5/0.0/0.5 | 0.66 | PMMA | quaternary ammonium salt compound |

*¹P: fine conductive powder (CB/GF = 1/9, where CB is carbon black and GF is crystalline graphite) B: Other resin, CA: copolymer, R: spherical particles

TABLE 3
Evaluation Results Under an N/L Environment

| | | Initial (after 1k) | | | | | Durability (after 100k) | | | | | |
|---|---|---|---|---|---|---|---|---|---|---|---|---|
| | | Image | Inversion | Q/M | Streaks/ | | Image | Inversion | Q/M | Streaks/ | | Scraping |
| | | Density | Fog | (mC/kg) | Unevenness | Blotches | Density | Fog | (mC/kg) | Unevenness | Blotches | Amount (μm) |
| Example | 1 | 1.36 | ◯ | 17.8 | ⊚ | ◯ | 1.38 | ⊚ | 17.4 | ◯ | ⊚ | −3.0 |
| | 2 | 1.36 | ◯ | 17.4 | ◯ | ◯ | 1.37 | ⊚ | 17.3 | ◯ | ⊚ | −3.3 |
| | 3 | 1.36 | ◯ | 17.6 | ⊚ | ◯ | 1.38 | ⊚ | 17.2 | ◯ | ⊚ | −3.0 |
| | 4 | 1.36 | ◯ | 17.4 | ⊚ | ⊚ | 1.36 | ⊚ | 16.5 | ⊚ | ⊚ | −2.0 |
| | 5 | 1.36 | ◯ | 15.1 | ⊚ | ⊚ | 1.36 | ⊚ | 14.8 | ◯ | ⊚ | −2.1 |
| | 6 | 1.35 | ◯ | 14.9 | ⊚ | ⊚ | 1.36 | ⊚ | 14.4 | ◯ | ⊚ | −2.4 |
| | 7 | 1.36 | ◯ | 15.2 | ⊚ | ⊚ | 1.36 | ⊚ | 14.7 | ◯ | ⊚ | −2.1 |
| | 8 | 1.38 | ⊚ | 15.9 | ⊚ | ⊚ | 1.39 | ⊚ | 15.6 | ⊚ | ⊚ | −1.4 |
| | 9 | 1.35 | ◯ | 15.8 | ⊚ | ⊚ | 1.36 | ⊚ | 15.5 | ◯ | ⊚ | −2.1 |
| | 10 | 1.32 | ◯ | 14.9 | ◯ | ◯ | 1.33 | ⊚ | 14.8 | ◯ | ◯ | −1.9 |
| | 11 | 1.35 | ◯ | 14.6 | ◯ | ⊚ | 1.34 | ⊚ | 14.1 | ◯ | ⊚ | −2.4 |
| | 12 | 1.32 | ◯ | 14.4 | ◯ | ⊚ | 1.35 | ⊚ | 14.5 | ◯ | ⊚ | −2.4 |
| | 13 | 1.29 | Δ | 13.6 | ◯Δ | ◯ | 1.29 | ◯ | 13.8 | ◯Δ | ◯ | −3.3 |
| | 14 | 1.35 | ◯ | 15.4 | ⊚ | ◯ | 1.39 | ⊚ | 14.7 | ⊚ | ⊚ | −1.7 |
| | 15 | 1.34 | ◯ | 14.9 | ⊚ | ⊚ | 1.36 | ⊚ | 14.9 | ⊚ | ⊚ | −2.2 |
| | 16 | 1.26 | Δ | 13.7 | ◯Δ | ◯ | 1.28 | ◯ | 13.5 | ◯Δ | ◯ | −3.5 |
| Comparative | 1 | 1.25 | X | 7.6 | Δ | ΔX | 1.19 | Δ | 6.5 | ΔX | X | — |
| Example | 2 | 1.25 | ΔX | 7.8 | Δ | Δ◯ | 1.17 | Δ | 7.2 | Δ | Δ | −2.9 |
| | 3 | 1.26 | ΔX | 7.2 | Δ | Δ◯ | 1.19 | Δ | 6.6 | ΔX | Δ | −2.6 |
| | 4 | 1.24 | ΔX | 7.4 | Δ | Δ◯ | 1.18 | Δ | 6.9 | ΔX | Δ | −2.8 |
| | 5 | 1.26 | ΔX | 7.7 | Δ | Δ◯ | 1.15 | Δ | 7.1 | ΔX | Δ | −5.7 |
| | 6 | 1.25 | ΔX | 7.9 | Δ | Δ◯ | 1.17 | Δ | 7.2 | ΔX | Δ | −6.5 |

TABLE 4
Evaluation Results Under an H/H Environment

| | | Initial (after 1k) | | | | | Durability (after 100k) | | | | | |
|---|---|---|---|---|---|---|---|---|---|---|---|---|
| | | Image | Inversion | Q/M | Streaks/ | | Image | Inversion | Q/M | Streaks/ | | Scraping |
| | | Density | Fog | (mC/kg) | Unevenness | Blotches | Density | Fog | (mC/kg) | Unevenness | Blotches | Amount (μm) |
| Example | 1 | 1.33 | ⊚ | 16.5 | ◯ | ◯ | 1.35 | ⊚ | 16.0 | ◯ | ⊚ | −3.2 |
| | 2 | 1.31 | ⊚ | 16.4 | ◯ | ◯ | 1.35 | ⊚ | 16.0 | ◯ | ⊚ | −3.3 |
| | 3 | 1.33 | ⊚ | 16.5 | ◯ | ◯ | 1.36 | ⊚ | 16.1 | ◯ | ⊚ | −3.2 |
| | 4 | 1.33 | ⊚ | 16.1 | ⊚ | ⊚ | 1.35 | ⊚ | 15.9 | ⊚ | ⊚ | −2.0 |
| | 5 | 1.32 | ◯ | 14.5 | ◯ | ⊚ | 1.36 | ⊚ | 14.0 | ◯ | ⊚ | −2.6 |
| | 6 | 1.31 | ◯ | 14.2 | ◯ | ⊚ | 1.35 | ⊚ | 13.8 | ◯ | ⊚ | −2.8 |
| | 7 | 1.33 | ◯ | 14.4 | ◯ | ⊚ | 1.36 | ⊚ | 13.9 | ◯ | ⊚ | −2.7 |
| | 8 | 1.35 | ⊚ | 14.9 | ⊚ | ⊚ | 1.35 | ⊚ | 14.5 | ⊚ | ⊚ | −1.9 |
| | 9 | 1.34 | ⊚ | 14.6 | ⊚ | ⊚ | 1.33 | ⊚ | 14.1 | ⊚ | ⊚ | −2.1 |
| | 10 | 1.32 | ◯ | 13.8 | ◯ | ◯ | 1.33 | ⊚ | 13.5 | ⊚ | ◯ | −2.0 |
| | 11 | 1.31 | ◯ | 13.0 | ◯Δ | ⊚ | 1.32 | ⊚ | 12.7 | ◯Δ | ⊚ | −2.8 |
| | 12 | 1.29 | ◯ | 13.1 | ◯Δ | ⊚ | 1.32 | ⊚ | 12.9 | ◯Δ | ⊚ | −3.1 |
| | 13 | 1.26 | ◯ | 12.7 | Δ◯ | ◯ | 1.29 | ⊚ | 12.0 | Δ◯ | ◯ | −3.9 |
| | 14 | 1.33 | ◯ | 14.4 | ◯ | ⊚ | 1.35 | ⊚ | 13.9 | ◯ | ⊚ | −2.1 |
| | 15 | 1.30 | ◯ | 13.6 | ⊚ | ⊚ | 1.30 | ⊚ | 13.4 | ⊚ | ⊚ | −2.4 |
| | 16 | 1.20 | Δ | 10.9 | ◯Δ | ◯ | 1.25 | ◯ | 10.6 | Δ | ◯Δ | −5.4 |
| Comparative | 1 | 1.07 | ΔX | 6.6 | Δ | Δ | 1.03 | Δ | 6.1 | ΔX | ΔX | — |
| Example | 2 | 1.10 | Δ | 6.4 | ◯Δ | ◯Δ | 1.04 | ◯ | 6.0 | Δ◯ | Δ◯ | −3.4 |
| | 3 | 1.12 | Δ | 6.6 | ◯Δ | ◯Δ | 1.07 | ◯ | 6.2 | Δ◯ | ◯Δ | −3.0 |
| | 4 | 1.09 | Δ | 6.5 | ◯Δ | ◯Δ | 1.05 | ◯ | 6.1 | Δ | Δ◯ | −3.1 |
| | 5 | 1.11 | Δ | 6.9 | Δ◯ | ◯Δ | 1.06 | ◯ | 6.4 | Δ | Δ◯ | −6.1 |
| | 6 | 1.10 | Δ | 7.1 | Δ◯ | ◯Δ | 1.05 | ◯ | 6.5 | Δ | Δ◯ | −6.8 |

### Example 17

The developer carrying member according to the present example was produced in the same manner as that in Example 1, except that a resin layer was formed using the copolymer (d) in place of the copolymer (A) of Example 1. The resin layer composition of the obtained developer carrying member is shown in Table 5. In addition, using the obtained developer carrying member, an imaging test was carried out while supplying toner A in the same manner as in Example 1 for evaluation. The results are shown in Tables 6 and 7.

### Example 18

The developer carrying member according to the present example was produced using the same procedures as those in Example 17, except that a resin layer was formed using the copolymer (E) in place of the copolymer (D) of Example 17. The resin layer composition of the obtained developer carrying member is shown in Table 5. In addition, using the obtained developer carrying member, an imaging test was carried out while supplying toner A in the same manner as in Example 1 for evaluation. The results are shown in Tables 6 and 7.

### Example 19

The developer carrying member according to the present example was produced using the same procedures as those in Example 17, except that a resin layer was formed using the copolymer (F) in place of the copolymer (d) of Example 17. The resin layer composition of the obtained developer carrying member is shown in Table 5. In addition, using the obtained developer carrying member, an imaging test was carried out while supplying toner A in the same manner as in Example 1 for evaluation. The results are shown in Tables 6 and 7.

### Example 20

The same materials as those of Example 17 were dispersed using the same procedures as those in Example 17, and subsequently charged with 5 parts of conductive spherical carbon particles having a number average particle diameter of 5 μm. The resulting mixture was dispersed for 1 hour using 3 mm-diameter glass beads, and the beads were then separated off using a sieve, to thereby yield a coating solution. Next, a resin layer was formed using the same procedures as those in Example 17, to thereby produce the developer carrying member according to the present example. The resin layer composition of the obtained developer carrying member is shown in Table 5.

In addition, using the obtained developer carrying member, an imaging test was carried out while supplying toner A in the same manner as in Example 1 for evaluation. The results are shown in Tables 6 and 7.

Particles prepared in exactly the same manner as in Example 4 were used as the conductive spherical carbon particles to be used in the present example.

### Example 21

The developer carrying member according to the present example was produced in the same manner as in Example 5, except that a resin layer was formed using the copolymer (D) in place of the copolymer (A) of Example 5. The resin layer composition of the obtained developer carrying member is shown in Table 5. In addition, using the obtained developer carrying member, an imaging test was carried out while supplying toner A in the same manner as in Example 1 for evaluation. The results are shown in Tables 6 and 7.

### Example 22

The developer carrying member according to the present example was produced by forming a resin layer using the same procedures as those in Example 21, except that the copolymer (E) was used in place of the copolymer (D) of Example 21. The resin layer composition of the obtained developer carrying member is shown in Table 5. In addition, using the obtained developer carrying member, an imaging test was carried out while supplying toner A in the same manner as in Example 1 for evaluation. The results are shown in Tables 6 and 7.

### Example 23

The developer carrying member according to the present example was produced by forming a resin layer using the same procedures as those in Example 21, except that the copolymer (F) was used in place of the copolymer (D) of Example 21. The resin layer composition of the obtained developer carrying member is shown in Table 5. In addition, using the obtained developer carrying member, an imaging test was carried out while supplying toner A in the same manner as in Example 1 for evaluation. The results are shown in Tables 6 and 7.

### Example 24

The same materials as those of Example 21 were dispersed using the same procedures as those in Example 21, and subsequently charged with 5 parts of conductive spherical carbon particles having a number average particle diameter of 5 μm. The resulting mixture was dispersed for 1 hour using 3 mm-diameter glass beads, and the beads were then separated off using a sieve, to thereby yield a coating solution. Next, a resin layer was formed using the same procedures as those in Example 17, to thereby produce the developer carrying member according to the present example. The resin layer composition of the obtained developer carrying member is shown in Table 5.

In addition, using the obtained developer carrying member, an imaging test was carried out while supplying toner A in the same manner as in Example 1 for evaluation. The results are shown in Tables 6 and 7.

Particles prepared in exactly the same manner as in Example 8 were used as the conductive spherical carbon particles to be used in the present example.

### Example 25

The developer carrying member according to the present example was produced by forming a resin layer using the same procedures as those in Example 24, except that 7.5 parts of conductive spherical carbon particles having a number average particle diameter of 2 μm were used in place of the conductive spherical carbon particles having a number average particle diameter of 5 μm used in Example 24. The resin layer composition of the obtained developer carrying member is shown in Table 5.

In addition, using the obtained developer carrying member, an imaging test was carried out while supplying toner A in the same manner as in Example 1 for evaluation. The results are shown in Tables 6 and 7.

Particles prepared in exactly the same manner as in Example 9 were used as the conductive spherical carbon particles having a number average particle diameter of 2 μm to be used in the present example.

### Example 26

The developer carrying member according to the present example was produced by forming a resin layer using the same procedures as those in Example 24, except that 2.5 parts of conductive spherical carbon particles having a number average particle diameter of 20 μm were used in place of the conductive spherical carbon particles having a number average particle diameter of 5 μm used in Example 24. The resin layer composition of the obtained developer carrying member is shown in Table 5.

In addition, using the obtained developer carrying member, an imaging test was carried out while supplying toner A in the same manner as in Example 1 for evaluation. The results are shown in Tables 6 and 7.

Particles prepared in exactly the same manner as in Example 10 were used as the conductive spherical carbon particles having a number average particle diameter of 20 μm to be used in the present example.

### Example 27

The developer carrying member according to the present example was produced by forming a resin layer using the same procedures as those in Example 24, except that carbon black-coated PMMA particles having a number average particle diameter of 5 μm were used in place of the conductive spherical carbon particles having a number average particle diameter of 5 μm used in Example 24. The resin layer composition of the obtained developer carrying member is shown in Table 5.

In addition, using the obtained developer carrying member, an imaging test was carried out while supplying toner A in the same manner as in Example 1 for evaluation. The results are shown in Tables 6 and 7.

Particles prepared in exactly the same manner as in Example 11 were used as the carbon black-coated PMMA particles having a number average particle diameter of 5 μm to be used in the present example.

### Example 28

The developer carrying member according to the present example was produced by forming a resin layer using the same procedures as those in Example 24, except that carbon black dispersed resin particles having a number average particle diameter of 5 μm were used in place of the conductive spherical carbon particles having a number average particle diameter of 5 μm used in Example 24. The resin layer composition of the obtained developer carrying member is shown in Table 5.

In addition, using the obtained developer carrying member, an imaging test was carried out while supplying toner A in the same manner as in Example 1 for evaluation. The results are shown in Tables 6 and 7.

Particles prepared in exactly the same manner as in Example 12 were used as the carbon black resin particles having a number average particle diameter of 5 μm to be used in the present example.

### Example 29

The developer carrying member according to the present example was produced by forming a resin layer using the same procedures as those in Example 24, except that PMMA particles having a number average particle diameter of 5 μm were used in place of the conductive spherical carbon particles having a number average particle diameter of 5 μm used in Example 24. The resin layer composition of the obtained developer carrying member is shown in Table 5.

In addition, using the obtained developer carrying member, an imaging test was carried out while supplying toner A in the same manner as in Example 1 for evaluation. The results are shown in Tables 6 and 7.

### Example 30

The developer carrying member according to the present example was produced by forming a resin layer using the same procedures as those in Example 24, except that a silicone resin was used in place of the PMMA resin used in Example 24. The resin layer composition of the obtained developer carrying member is shown in Table 5.

In addition, using the obtained developer carrying member, an imaging test was carried out while supplying toner A in the same manner as in Example 1 for evaluation. The results are shown in Tables 6 and 7.

### Example 31

The developer carrying member according to the present example was produced by forming a resin layer using the same procedures as those in Example 24, except that a styrene-acrylic resin was used in place of the PMMA resin used in Example 24. The resin layer composition of the obtained developer carrying member is shown in Table 5.

In addition, using the obtained developer carrying member, an imaging test was carried out while supplying toner A in the same manner as in Example 1 for evaluation. The results are shown in Tables 6 and 7.

### Example 32

The developer carrying member according to the present example was produced by forming a resin layer using the same procedures as those in Example 24, except that a polyester resin was used in place of the PMMA resin used in Example 24. The resin layer composition of the obtained developer carrying member is shown in Table 5.

In addition, using the obtained developer carrying member, an imaging test was carried out while supplying toner A in the same manner as in Example 1 for evaluation. The results are shown in Tables 6 and 7.

TABLE 5
Resin Layer Composition of the Developing sleeve Surface

| | | Rough-ness Ra | Binder resin | | Added Spherical Particles |
|---|---|---|---|---|---|
| Example | P/B/CA/R Ratio*¹ | (μm) | Copolymer | Other Resin | (number average particle diameter) |
| 17 | 1/0.0/2.5/0.0 | 0.55 | (D) | none | None |
| 18 | 1/0.0/2.5/0.0 | 0.57 | (E) | none | None |
| 19 | 1/0.0/2.5/0.0 | 0.55 | (F) | none | None |
| 20 | 1/0.0/2.5/0.5 | 0.60 | (D) | none | conductive spherical carbon particles (5 μm) |
| 21 | 1/2.5/0.5/0.0 | 0.62 | (D) | PMMA | None |
| 22 | 1/2.5/0.5/0.0 | 0.60 | (E) | PMMA | None |
| 23 | 1/2.5/0.5/0.0 | 0.61 | (F) | PMMA | None |
| 24 | 1/2.5/0.5/0.5 | 0.72 | (D) | PMMA | conductive spherical carbon particles (5 μm) |
| 25 | 1/2.5/0.5/0.75 | 0.63 | (D) | PMMA | conductive spherical carbon particles (2 μm) |
| 26 | 1/2.5/0.5/0.25 | 1.02 | (D) | PMMA | conductive spherical carbon particles (20 μm) |
| 27 | 1/2.5/0.5/0.5 | 0.75 | (D) | PMMA | carbon black-coated PMMA spherical particles (5 μm) |
| 28 | 1/2.5/0.5/0.5 | 0.72 | (D) | PMMA | carbon black dispersed spherical particles (5 μm) |
| 29 | 1/2.5/0.5/0.5 | 0.66 | (D) | PMMA | PMMA spherical particles (5 μm) |
| 30 | 1/2.5/0.5/0.5 | 0.77 | (D) | silicone | conductive spherical carbon particles (5 μm) |
| 31 | 1/2.5/0.5/0.5 | 0.72 | (D) | St-Ac*² | conductive spherical carbon particles (5 μm) |
| 32 | 1/2.5/0.5/0.5 | 0.72 | (D) | polyester | conductive spherical carbon particles (5 μm) |

*¹P: fine conductive powder (CB/GF = 1/9, where CB is carbon black and GF is crystalline graphite) B: Other resin, CA: copolymer, R: spherical particles
*²St-Ac: styrene-acrylic resin

TABLE 6
Evaluation Results Under an N/L Environment

| | | Initial (after 1k) | | | | | Durability (after 100k) | | | | | |
|---|---|---|---|---|---|---|---|---|---|---|---|---|
| | | Image | Inversion | Q/M | Streaks/ | | Image | Inversion | Q/M | Streaks/ | | Scraping |
| | | Density | fog | (mC/kg) | Unevenness | Blotches | Density | fog | (mC/kg) | Unevenness | Blotches | Amount (μm) |
| Example | 17 | 1.36 | ◯ | 17.4 | ⊚ | ◯ | 1.37 | ⊚ | 17.0 | ◯ | ⊚ | −3.3 |
| | 18 | 1.34 | ◯ | 17.1 | ◯ | ◯ | 1.35 | ◯ | 16.6 | ◯ | ⊚ | −3.6 |
| | 19 | 1.36 | ◯ | 17.4 | ⊚ | ◯ | 1.37 | ⊚ | 16.9 | ◯ | ⊚ | −3.2 |
| | 20 | 1.36 | ◯ | 17.0 | ⊚ | ⊚ | 1.35 | ⊚ | 16.1 | ⊚ | ⊚ | −2.0 |
| | 21 | 1.36 | ◯ | 15.0 | ⊚ | ⊚ | 1.37 | ⊚ | 14.5 | ◯ | ⊚ | −2.3 |
| | 22 | 1.34 | ◯ | 14.5 | ◯ | ⊚ | 1.34 | ⊚ | 14.0 | ◯ | ⊚ | −2.5 |
| | 23 | 1.36 | ◯ | 14.9 | ⊚ | ⊚ | 1.36 | ⊚ | 14.4 | ◯ | ⊚ | −2.2 |
| | 24 | 1.38 | ⊚ | 15.6 | ⊚ | ⊚ | 1.38 | ⊚ | 15.3 | ⊚ | ⊚ | −1.6 |
| | 25 | 1.34 | ◯ | 15.4 | ⊚ | ⊚ | 1.35 | ⊚ | 15.2 | ◯ | ⊚ | −2.2 |
| | 26 | 1.31 | ◯ | 14.6 | ◯ | ◯ | 1.30 | ⊚ | 14.5 | ◯ | ◯ | −1.9 |
| | 27 | 1.33 | ◯ | 14.2 | ◯ | ⊚ | 1.33 | ⊚ | 14.0 | ◯ | ⊚ | −2.5 |
| | 28 | 1.31 | ◯ | 14.1 | ◯ | ⊚ | 1.34 | ⊚ | 14.5 | ◯ | ⊚ | −2.7 |
| | 29 | 1.27 | Δ | 13.4 | ◯Δ | ◯ | 1.27 | ◯ | 13.3 | ◯Δ | ◯ | −3.1 |
| | 30 | 1.35 | ◯ | 15.1 | ⊚ | ◯ | 1.38 | ⊚ | 14.5 | ⊚ | ⊚ | −1.9 |
| | 31 | 1.35 | ◯ | 14.7 | ⊚ | ⊚ | 1.36 | ⊚ | 14.4 | ⊚ | ⊚ | −2.4 |
| | 32 | 1.25 | Δ | 13.3 | ◯Δ | ◯ | 1.26 | ◯ | 13.3 | ◯Δ | ◯ | −3.5 |
| Comparative | 1 | 1.25 | X | 7.6 | Δ | ΔX | 1.19 | Δ | 6.5 | ΔX | X | — |
| Example | 2 | 1.25 | ΔX | 7.8 | Δ | Δ◯ | 1.17 | Δ | 7.2 | Δ | Δ | −2.9 |
| | 3 | 1.26 | ΔX | 7.2 | Δ | Δ◯ | 1.19 | Δ | 6.6 | ΔX | Δ | −2.6 |
| | 4 | 1.24 | ΔX | 7.4 | Δ | Δ◯ | 1.18 | Δ | 6.9 | ΔX | Δ | −2.8 |
| | 5 | 1.26 | ΔX | 7.7 | Δ | Δ◯ | 1.15 | Δ | 7.1 | ΔX | Δ | −5.7 |
| | 6 | 1.25 | ΔX | 7.9 | Δ | Δ◯ | 1.17 | Δ | 7.2 | ΔX | Δ | −6.5 |

TABLE 7
Evaluation Results Under an H/H Environment

| | | Initial (after 1k) | | | | | Durability (after 100k) | | | | | |
|---|---|---|---|---|---|---|---|---|---|---|---|---|
| | | Image | Inversion | Q/M | Streaks/ | | Image | Inversion | Q/M | Streaks/ | | Scraping |
| | | Density | fog | (mC/kg) | Unevenness | Blotches | Density | fog | (mC/kg) | Unevenness | Blotches | Amount (μm) |
| Example | 17 | 1.31 | ⊚ | 16.2 | ◯ | ◯ | 1.33 | ⊚ | 15.7 | ◯ | ⊚ | −3.4 |
| | 18 | 1.29 | ◯ | 15.8 | ◯ | ◯ | 1.30 | ⊚ | 15.4 | ◯ | ⊚ | −3.6 |
| | 19 | 1.31 | ⊚ | 16.1 | ◯ | ◯ | 1.32 | ⊚ | 15.7 | ◯ | ⊚ | −3.3 |
| | 20 | 1.33 | ⊚ | 16.0 | ⊚ | ⊚ | 1.33 | ⊚ | 15.7 | ⊚ | ⊚ | −2.3 |
| | 21 | 1.30 | ◯ | 14.0 | ◯ | ⊚ | 1.33 | ⊚ | 13.5 | ◯ | ⊚ | −2.8 |
| | 22 | 1.29 | ◯ | 13.8 | ◯ | ⊚ | 1.32 | ⊚ | 13.0 | ◯ | ⊚ | −2.9 |
| | 23 | 1.30 | ◯ | 14.1 | ◯ | ⊚ | 1.33 | ⊚ | 13.4 | ◯ | ⊚ | −2.8 |
| | 24 | 1.33 | ⊚ | 14.5 | ⊚ | ⊚ | 1.33 | ⊚ | 14.2 | ⊚ | ⊚ | −2.0 |
| | 25 | 1.31 | ⊚ | 14.2 | ⊚ | ⊚ | 1.30 | ⊚ | 13.7 | ⊚ | ⊚ | −2.4 |
| | 26 | 1.29 | ◯ | 13.3 | ◯ | ◯ | 1.30 | ⊚ | 13.1 | ⊚ | ◯ | −2.3 |
| | 27 | 1.30 | ◯ | 12.7 | ◯Δ | ⊚ | 1.30 | ⊚ | 12.2 | ◯Δ | ⊚ | −2.9 |
| | 28 | 1.27 | ◯ | 12.7 | ◯Δ | ⊚ | 1.29 | ⊚ | 12.5 | ◯Δ | ⊚ | −3.2 |
| | 29 | 1.23 | ◯ | 12.6 | Δ◯ | ◯ | 1.27 | ⊚ | 11.8 | Δ◯ | ◯ | −3.8 |
| | 30 | 1.31 | ◯ | 14.0 | ◯ | ⊚ | 1.31 | ⊚ | 13.6 | ◯ | ⊚ | −2.2 |
| | 31 | 1.28 | ◯ | 13.1 | ⊚ | ⊚ | 1.28 | ⊚ | 13.0 | ⊚ | ⊚ | −2.7 |
| | 32 | 1.19 | Δ | 10.5 | ◯Δ | ◯ | 1.20 | ◯ | 10.2 | Δ | ◯Δ | −5.4 |
| Comparative | 1 | 1.07 | ΔX | 6.6 | Δ | Δ | 1.03 | Δ | 6.1 | ΔX | ΔX | — |
| Example | 2 | 1.10 | Δ | 6.4 | ◯Δ | ◯Δ | 1.04 | ◯ | 6.0 | Δ◯ | Δ◯ | −3.4 |
| | 3 | 1.12 | Δ | 6.6 | ◯Δ | ◯Δ | 1.07 | ◯ | 6.2 | Δ◯ | ◯Δ | −3.0 |
| | 4 | 1.09 | Δ | 6.5 | ◯Δ | ◯Δ | 1.05 | ◯ | 6.1 | Δ | Δ◯ | −3.1 |
| | 5 | 1.11 | Δ | 6.9 | Δ◯ | ◯Δ | 1.06 | ◯ | 6.4 | Δ | Δ◯ | −6.1 |
| | 6 | 1.10 | Δ | 7.1 | Δ◯ | ◯Δ | 1.05 | ◯ | 6.5 | Δ | Δ◯ | −6.8 |

### Examples 33 to 40

The developer carrying members according to these examples were produced using the same procedures as those in Example 1, except that the copolymer (2A), copolymer (2B), copolymer (2C), copolymer (2D), copolymer (2E), copolymer (2F), copolymer (2G), and copolymer (2H) were used in place of the copolymer (A) of Example 1. The resin layer composition of the obtained developer carrying members is shown in Table 8. In addition, using the obtained developer carrying members, imaging tests were carried out while supplying toner A in the same manner as in Example 1 for evaluation. The results are shown in Tables 9 and 10.

### Examples 41 to 48

The developer carrying members according to these examples were produced using the same procedures as those in Example 5, except that the copolymer (2I), copolymer (2J), copolymer (2K), copolymer (2L), copolymer (2M), copolymer (2N), copolymer (20), and copolymer (2P) were used in place of the copolymer (A) of Example 5. The resin layer composition of the obtained developer carrying members is shown in Table 8. In addition, using the obtained developer carrying members, imaging tests were carried out while supplying toner A in the same manner as in Example 1 for evaluation. The results are shown in Tables 9 and 10.

TABLE 8
Resin Layer Composition of the Developing sleeve Surface

| | | | | | Added Spherical |
|---|---|---|---|---|---|
| | | | | | Particles |
| | | | Binder resin | | (number average |
| Example | P/B/CA/R Ratio*¹ | Roughness Ra (μm) | Copolymer | Other Resin | particle diameter) |
| 33 | 1/0.0/2.5/0.0 | 0.57 | (2A) | none | none |
| 34 | 1/0.0/2.5/0.0 | 0.58 | (2B) | none | none |
| 35 | 1/0.0/2.5/0.0 | 0.57 | (2C) | none | none |
| 36 | 1/0.0/2.5/0.0 | 0.57 | (2D) | none | none |
| 37 | 1/0.0/2.5/0.0 | 0.56 | (2E) | none | none |
| 38 | 1/0.0/2.5/0.0 | 0.58 | (2F) | none | none |
| 39 | 1/0.0/2.5/0.0 | 0.57 | (2G) | none | none |
| 40 | 1/0.0/2.5/0.0 | 0.57 | (2H) | none | none |
| 41 | 1/2.5/0.5/0.0 | 0.60 | (2I) | none | none |
| 42 | 1/2.5/0.5/0.0 | 0.61 | (2J) | none | none |
| 43 | 1/2.5/0.5/0.0 | 0.60 | (2K) | none | none |
| 44 | 1/2.5/0.5/0.0 | 0.61 | (2L) | none | none |
| 45 | 1/2.5/0.5/0.0 | 0.59 | (2M | none | none |
| 46 | 1/2.5/0.5/0.0 | 0.60 | (2N) | none | none |
| 47 | 1/2.5/0.5/0.0 | 0.61 | (2O) | none | none |
| 48 | 1/2.5/0.5/0.0 | 0.59 | (2P) | none | none |

*¹P: fine conductive powder (CB/GF = 1/9, where CB is carbon black and GF is crystalline graphite) B: Other resin, CA: copolymer, R: spherical particles

TABLE 9
Evaluation Results Under an N/L Environment

| | Initial (after 1k) | | | | | Durability (after 100k) | | | | | |
|---|---|---|---|---|---|---|---|---|---|---|---|
| | Image | Inversion | Q/M | Streaks/ | | Image | Inversion | Q/M | Streaks/ | | Scraping |
| | Density | fog | (mC/kg) | Unevenness | Blotches | Density | fog | (mC/kg) | Unevenness | Blotches | Amount (μm) |
| 33 | 1.36 | ◯ | 16.3 | ⊚ | ◯ | 1.36 | ⊚ | 15.9 | ◯ | ⊚ | −2.8 |
| 34 | 1.37 | ◯ | 16.7 | ⊚ | ◯ | 1.36 | ⊚ | 16.6 | ◯ | ⊚ | −3.0 |
| 35 | 1.38 | ◯ | 17.5 | ⊚ | ◯ | 1.37 | ⊚ | 17.5 | ◯ | ⊚ | −3.0 |
| 36 | 1.31 | ◯ | 14.2 | ⊚ | ◯ | 1.32 | ⊚ | 13.7 | ◯ | ⊚ | −2.7 |
| 37 | 1.37 | ◯ | 17.3 | ⊚ | ◯ | 1.37 | ⊚ | 17.0 | ◯ | ⊚ | −2.8 |
| 38 | 1.38 | ◯ | 18.2 | ⊚ | ◯ | 1.37 | ⊚ | 18.3 | ◯ | ⊚ | −3.1 |
| 39 | 1.33 | ◯ | 14.5 | ⊚ | ◯ | 1.32 | ⊚ | 14.0 | ◯ | ⊚ | −2.9 |
| 40 | 1.38 | ◯ | 16.6 | ⊚ | ◯ | 1.38 | ⊚ | 16.7 | ◯ | ⊚ | −2.8 |
| 41 | 1.34 | ◯ | 16.0 | ⊚ | ⊚ | 1.33 | ⊚ | 15.7 | ◯ | ⊚ | −2.7 |
| 42 | 1.37 | ◯ | 16.9 | ⊚ | ⊚ | 1.38 | ⊚ | 16.6 | ◯ | ⊚ | −3.0 |
| 43 | 1.33 | ◯ | 15.5 | ⊚ | ⊚ | 1.34 | ⊚ | 15.2 | ◯ | ⊚ | −3.1 |
| 44 | 1.38 | ◯ | 17.8 | ⊚ | ⊚ | 1.38 | ⊚ | 17.8 | ◯ | ⊚ | −2.8 |
| 45 | 1.37 | ◯ | 17.2 | ⊚ | ⊚ | 1.38 | ⊚ | 17.3 | ◯ | ⊚ | −3.0 |
| 46 | 1.37 | ◯ | 17.3 | ⊚ | ⊚ | 1.37 | ⊚ | 17.4 | ◯ | ⊚ | −3.0 |
| 47 | 1.36 | ◯ | 17.4 | ⊚ | ⊚ | 1.37 | ⊚ | 17.4 | ◯ | ⊚ | −2.9 |
| 48 | 1.37 | ◯ | 17.6 | ⊚ | ⊚ | 1.37 | ⊚ | 17.4 | ◯ | ⊚ | −3.5 |

TABLE 10
Evaluation Results Under an H/H Environment

| | Initial (after 1k) | | | | | Durability (after 100k) | | | | | |
|---|---|---|---|---|---|---|---|---|---|---|---|
| | Image | Inversion | Q/M | Streaks/ | | Image | Inversion | Q/M | Streaks/ | | Scraping |
| | Density | fog | (mC/kg) | Unevenness | Blotches | Density | fog | (mC/kg) | Unevenness | Blotches | Amount (μm) |
| 33 | 1.33 | ⊚ | 15.3 | ◯ | ◯ | 1.35 | ⊚ | 14.9 | ◯ | ⊚ | −3.1 |
| 34 | 1.35 | ⊚ | 15.8 | ◯ | ◯ | 1.34 | ⊚ | 15.3 | ◯ | ⊚ | −3.3 |
| 35 | 1.35 | ⊚ | 16.3 | ◯ | ◯ | 1.37 | ⊚ | 16.0 | ◯ | ⊚ | −3.3 |
| 36 | 1.23 | ⊚ | 12.7 | ◯ | ◯ | 1.27 | ⊚ | 11.9 | ◯ | ⊚ | −3.0 |
| 37 | 1.34 | ⊚ | 16.3 | ◯ | ◯ | 1.35 | ⊚ | 16.0 | ◯ | ⊚ | −3.2 |
| 38 | 1.36 | ⊚ | 17.0 | ◯ | ◯ | 1.37 | ⊚ | 16.6 | ◯ | ⊚ | −3.3 |
| 39 | 1.30 | ⊚ | 13.3 | ◯ | ◯ | 1.32 | ⊚ | 12.5 | ◯ | ⊚ | −3.2 |
| 40 | 1.36 | ⊚ | 15.6 | ◯ | ◯ | 1.37 | ⊚ | 15.0 | ◯ | ⊚ | −3.2 |
| 41 | 1.31 | ◯ | 14.9 | ◯ | ⊚ | 1.33 | ⊚ | 14.1 | ◯ | ⊚ | −3.0 |
| 42 | 1.35 | ◯ | 15.8 | ◯ | ⊚ | 1.37 | ⊚ | 15.5 | ◯ | ⊚ | −3.3 |
| 43 | 1.30 | ◯ | 14.3 | ◯ | ⊚ | 1.33 | ⊚ | 13.8 | ◯ | ⊚ | −3.5 |
| 44 | 1.37 | ◯ | 16.6 | ◯ | ⊚ | 1.39 | ⊚ | 16.2 | ◯ | ⊚ | −3.1 |
| 45 | 1.35 | ◯ | 16.1 | ◯ | ⊚ | 1.36 | ⊚ | 15.8 | ◯ | ⊚ | −3.2 |
| 46 | 1.34 | ◯ | 16.0 | ◯ | ⊚ | 1.37 | ⊚ | 15.8 | ◯ | ⊚ | −3.3 |
| 47 | 1.34 | ◯ | 16.4 | ◯ | ⊚ | 1.34 | ⊚ | 16.0 | ◯ | ⊚ | −3.1 |
| 48 | 1.35 | ◯ | 16.5 | ◯ | ⊚ | 1.37 | ⊚ | 16.0 | ◯ | ⊚ | −3.7 |

This application claims priority from Japanese Patent Application No. 2004-188893 filed on Jun. 25, 2004, which is hereby incorporated by reference herein.

What is claimed is:

1. A developer carrying member for use in a development apparatus for visualizing an image by developing a latent image formed on an electrostatic latent image bearing member by a developer carried and transported by the developer carrying member, comprising at least a substrate and a resin layer formed on the surface of the substrate, the resin layer employing a binder resin containing a polyhydroxyalkanoate containing, per molecule, at least one unit represented by the formula (1): 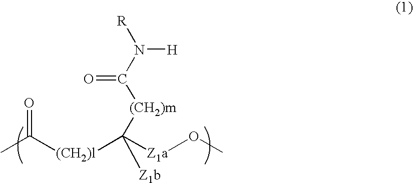
(in the formula:
R represents -A₁-SO₂R₁;
R₁ represents OH, a halogen atom, ONa, OK, or OR₁ₐ; and
R₁ₐ and A₁ each independently represent a group having a substituted or unsubstituted aliphatic hydrocarbon structure, a substituted or unsubstituted aromatic ring structure, or a substituted or unsubstituted heterocyclic structure;
in addition, with regard to l, m, Z₁ₐ, and Z_{1b} in the formula:
when l represents an integer selected from 2 to 4, Z₁ₐ represents nothing or a linear alkylene chain having 1 to 4 carbon atoms, Z_{1b} represents a hydrogen atom, and m represents an integer selected from 0 to 8;
when 1 represents 1 and Z₁ₐ represents a linear alkylene chain having 1 to 4 carbon atoms, Z_{1b} represents a hydrogen atom and m represents an integer selected from 0 to 8;
when l represents 1 and Z₁ₐ represents nothing, Z_{1b} represents a hydrogen atom and m represents 0;
when l represents 0 and Z₁ₐ represents a linear alkylene chain having 1 to 4 carbon atoms, the linear alkylene chain may be substituted by a linear or branched alkyl group, or an alkyl group containing a residue having any one of a phenyl structure, a thienyl structure, and a cyclohexyl structure at a terminal thereof, Z_{1b} represents a hydrogen atom, or a linear or branched alkyl group, aryl group, or aralkyl group which may be substituted by an aryl group, and m represents an integer selected from 0 to 8; and
when l represents 0 and Z₁ₐ represents nothing, Z_{1b} represents a hydrogen atom, or a linear or branched alkyl group, aryl group, or aralkyl group which may be substituted by an aryl group, and m represents an integer selected from 0 to 8;
in addition, when multiple units exist, R, R₁, R₁ₐ, A₁, Z₁ₐ, Z_{1b}, l, and m each independently have the above meaning for each unit).

2. The developer carrying member according to claim 1, wherein the unit represented by the formula (1) is a unit represented by the formula (2): 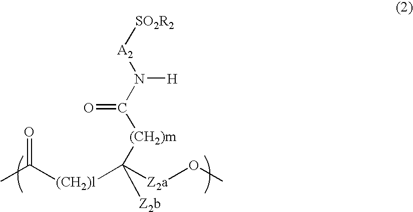
(in the formula:
R₂ represents OH, a halogen atom, ONa, OK, or OR₂ₐ; and
R₂ₐ represents a linear or branched alkyl group having 1 to 8 carbon atoms, or a substituted or unsubstituted phenyl group, and A₂ represents a linear or branched alkylene group having 1 to 8 carbon atoms;
in addition, with regard to l, m, Z₂ₐ, and Z_{2b} in the formula:
when l represents an integer selected from 2 to 4, Z₂ₐ represents nothing or a linear alkylene chain having 1 to 4 carbon atoms, Z_{2b} represents a hydrogen atom, and m represents an integer selected from 0 to 8;
when l represents 1 and Z₂ₐ represents a linear alkylene chain having 1 to 4 carbon atoms, Z_{2b} represents a hydrogen atom and m represents an integer selected from 0 to 8;
when l represents 1 and Z₂ₐ represents nothing, Z_{2b} represents a hydrogen atom and m represents 0;
when l represents 0 and Z₂ₐ represents a linear alkylene chain having 1 to 4 carbon atoms, the linear alkylene chain may be substituted by a linear or branched alkyl group, or an alkyl group containing a residue having any one of a phenyl structure, a thienyl structure, and a cyclohexyl structure at a terminal thereof, Z_{2b} represents a hydrogen atom, or a linear or branched alkyl group, aryl group, or aralkyl group which may be substituted by an aryl group, and m represents an integer selected from 0 to 8; and
when l represents 0 and Z₂ₐ represents nothing, Z_{2b} represents a hydrogen atom, or a linear or branched alkyl group, aryl group, or aralkyl group which may be substituted by an aryl group, and m represents an integer selected from 0 to 8;
in addition, when multiple units exist, R₂, R₂ₐ, A₂, Z₂ₐ, Z_{2b}, l, and m each independently have the above meaning for each unit).

3. The developer carrying member according to claim 1, wherein the unit represented by the formula (1) is a unit represented by the formula (3): 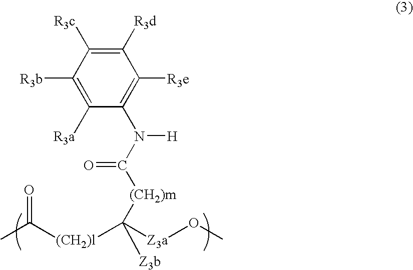
(in the formula, at least one of R₃ₐ, R_{3b}, R_{3c}, R_{3d}, and R₃ₑ represents SO₂R_{3f} (R_{3f} represents OH, a halogen atom, ONa, OK, or OR_{3f1}; and R_{3f1} represents a linear or branched alkyl group having 1 to 8 carbon atoms, or a substituted or unsubstituted phenyl group), and the others each independently represent a hydrogen atom, a halogen atom, an alkyl group having 1 to 20 carbon atoms, an alkoxy group having 1 to 20 carbon atoms, an OH group, an NH₂ group, an NO₂ group, COOR_{3g} (R_{3g} represents an H atom, an Na atom, or a K atom), an acetamide group, an OPh group (Ph indicating a phenyl group), an NHPh group, a CF₃ group, a C₂F₅ group, or a C₃F₇ group;
in addition, with regard to l, m, Z₃ₐ, and Z_{3b} in the formula:
when l represents an integer selected from 2 to 4, Z₃ₐ represents nothing or a linear alkylene chain having 1 to 4 carbon atoms, Z_{3b} represents a hydrogen atom, and m represents an integer selected from 0 to 8;
when l represents 1 and Z₃ₐ represents a linear alkylene chain having 1 to 4 carbon atoms, Z_{3b} represents a hydrogen atom and m represents an integer selected from 0 to 8;
when l represents 1 and Z₃ₐ represents nothing, Z_{3b} represents a hydrogen atom and m represents 0;
when l represents 0 and Z₃ₐ represents a linear alkylene chain having 1 to 4 carbon atoms, the linear alkylene chain may be substituted by a linear or branched alkyl group, or an alkyl group containing a residue having any one of a phenyl structure, a thienyl structure, and a cyclohexyl structure at a terminal thereof, Z_{3b} represents a hydrogen atom, or a linear or branched alkyl group, aryl group, or aralkyl group which may be substituted by an aryl group, and m represents an integer selected from 0 to 8; and
when l represents 0 and Z₃ₐ represents nothing, Z_{3b} represents a hydrogen atom, or a linear or branched alkyl group, aryl group, or aralkyl group which may be substituted by an aryl group, and m represents an integer selected from 0 to 8;
in addition, when multiple units exist, R₃ₐ, R_{3b}, R_{3c}, R_{3d}, R₃ₑ, R_{3f}, R_{3f1}, R_{3g}, Z₃ₐ, Z_{3b}, l, and m each independently have the above meaning for each unit.)

4. The developer carrying member according to claim 1, wherein the unit represented by the formula (1) is a unit represented either by the formula (4A): 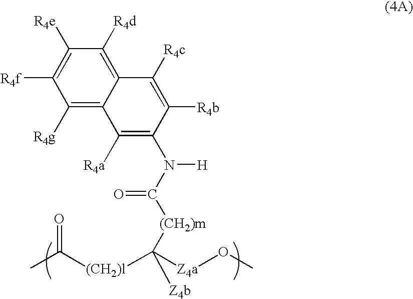
(in the formula, at least one of R₄ₐ, R_{4b}, R_{4c}, R_{4d}, R₄ₑ, R_{4f}, and R_{4g} represents SO₂R₄, (R₄ₒ represents OH, a halogen atom, ONa, OK, or OR₄ₒ₁; and R₄ₒ₁ represents a linear or branched alkyl group having 1 to 8 carbon atoms, or a substituted or unsubstituted phenyl group), and the others each independently represent a hydrogen atom, a halogen atom, an alkyl group having 1 to 20 carbon atoms, an alkoxy group having 1 to 20 carbon atoms, an OH group, an NH₂ group, an NO₂ group, COOR₄ₚ (R₄ₚ represents an H atom, an Na atom, or a K atom), an acetamide group, an OPh group, an NHPh group, a CF₃ group, a C₂F₅ group, or a C₃F₇ group;
in addition, with regard to l, m, Z₄ₐ, and Z_{4b} in the formula:
when l represents an integer selected from 2 to 4, Z₄ₐ represents nothing or a linear alkylene chain having 1 to 4 carbon atoms, Z_{4b} represents a hydrogen atom, and m represents an integer selected from 0 to 8;
when l represents 1 and Z₄ₐ represents a linear alkylene chain having 1 to 4 carbon atoms, Z_{4b} represents a hydrogen atom and m represents an integer selected from 0 to 8;
when l represents 1 and Z₄ₐ represents nothing, Z_{4b} represents a hydrogen atom and m represents 0;
when l represents 0 and Z₄ₐ represents a linear alkylene chain having 1 to 4 carbon atoms, the linear alkylene chain may be substituted by a linear or branched alkyl group, or an alkyl group containing a residue having any one of a phenyl structure, a thienyl structure, and a cyclohexyl structure at a terminal thereof, Z_{4b} represents a hydrogen atom, or a linear or branched alkyl group, aryl group, or aralkyl group which may be substituted by an aryl group, and m represents an integer selected from 0 to 8; and
when l represents 0 and Z₄ₐ represents nothing, Z_{4b} represents a hydrogen atom, or a linear or branched alkyl group, aryl group, or aralkyl group which may be substituted by an aryl group, and m represents an integer selected from 0 to 8;
in addition, when multiple units exist, R₄ₐ, R_{4b}, R_{4c}, R_{4d}, R₄ₑ, R_{4f}, R_{4g}, R₄ₒ, R₄ₒ₁, R₄ₚ, Z₄ₐ, Z_{4b}, l, and m each independently have the above meaning for each unit) or by the formula (4B): 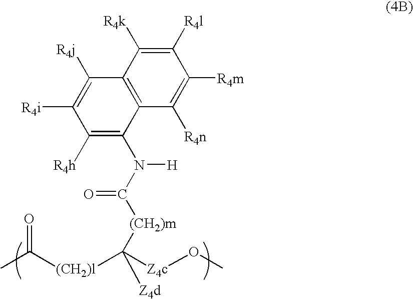
(in the formula, at least one of R₄ₕ, R₄ᵢ, R₄ⱼ, R₄ₖ, R₄ₗ, R₄ₘ, and R₄ₙ represents SO₂R₄, (R₄ₒ represents OH, a halogen atom, ONa, OK, or OR₄ₒ₁; and R₄ₒ₁ represents a linear or branched alkyl group having 1 to 8 carbon atoms, or a substituted or unsubstituted phenyl group), and the others each independently represent a hydrogen atom, a halogen atom, an alkyl group having 1 to 20 carbon atoms, an alkoxy group having 1 to 20 carbon atoms, an OH group, an NH₂ group, an NO₂ group, COOR₄ₚ (R₄ₚ represents an H atom, an Na atom, or a K atom), an acetamide group, an OPh group, an NHPh group, a CF₃ group, a C₂F₅ group, or a C₃F₇ group;
in addition, with regard to l, m, Z_{4c}, and Z_{4d} in the formula:
when l represents an integer selected from 2 to 4, Z_{4c} represents nothing or a linear alkylene chain having 1 to 4 carbon atoms, Z_{4d} represents a hydrogen atom, and m represents an integer selected from 0 to 8;
when l represents 1 and Z_{4c} represents a linear alkylene chain having 1 to 4 carbon atoms, Z_{4d} represents a hydrogen atom and m represents an integer selected from 0 to 8;
when l represents 1 and Z_{4c} represents nothing, Z_{4d} represents a hydrogen atom and m represents 0;
when l represents 0 and Z_{4c} represents a linear alkylene chain having 1 to 4 carbon atoms, the linear alkylene chain may be substituted by a linear or branched alkyl group, or an alkyl group containing a residue having any one of a phenyl structure, a thienyl structure, and a cyclohexyl structure at a terminal thereof, Z_{4d} represents a hydrogen atom, or a linear or branched alkyl group, aryl group, or aralkyl group which may be substituted by an aryl group, and m represents an integer selected from 0 to 8; and
when l represents 0 and Z_{4c} represents nothing, Z_{4d} represents a hydrogen atom, or a linear or branched alkyl group, aryl group, or aralkyl group which may be substituted by an aryl group, and m represents an integer selected from 0 to 8;
in addition, when multiple units exist, R₄ₕ, R₄ᵢ, R₄ⱼ, R₄ₖ, R₄ₗ, R₄ₘ, R₄ₙ, R₄ₒ, R₄ₒ₁, R₄ₚ, Z_{4c}, Z_{4d}, l, and m each independently have the above meaning for each unit).

5. A developer carrying member for use in a development apparatus for visualizing an image by developing a latent image formed on an electrostatic latent image bearing member by a developer carried and transported by the developer carrying member, comprising at least a substrate and a resin layer formed on the surface of the substrate, the resin layer employing a binder resin containing a polyhydroxyalkanoate containing, per molecule, at least one unit represented by the formula (5): 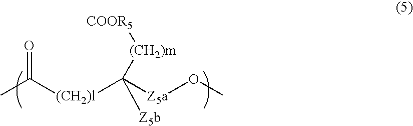
(in the formula, R₅ represents hydrogen, a group for forming a salt, or R₅ₐ, and R₅ₐ represents a linear or branched alkyl group having 1 to 12 carbon atoms, or aralkyl group;
in addition, with regard to l, m, Z₅ₐ, and Z_{5b} in the formula:
when l represents an integer selected from 2 to 4, Z₅ₐ represents nothing or a linear alkylene chain having 1 to 4 carbon atoms, Z_{5b} represents a hydrogen atom, and m represents an integer selected from 0 to 8;
when l represents 1 and Z₅ₐ represents a linear alkylene chain having 1 to 4 carbon atoms, Z_{5b} represents a hydrogen atom and m represents an integer selected from 0 to 8;
when l represents 1 and Z₅ₐ represents nothing, Z_{5b} represents a hydrogen atom and m represents 0;
when l represents 0 and Z₅ₐ represents a linear alkylene chain having 1 to 4 carbon atoms, the linear alkylene chain may be substituted by a linear or branched alkyl group, or an alkyl group containing a residue having any one of a phenyl structure, a thienyl structure, and a cyclohexyl structure at a terminal thereof, Z_{5b} represents a hydrogen atom, or a linear or branched alkyl group, aryl group, or aralkyl group which may be substituted by an aryl group, and m represents an integer selected from 0 to 8; and
when l represents 0 and Z₅ₐ represents nothing, Z_{5b} represents a hydrogen atom, or a linear or branched alkyl group, aryl group, or aralkyl group which may be substituted by an aryl group, and m represents an integer selected from 0 to 8;
in addition, when multiple units exist, R₅, R₅ₐ, Z₅ₐ, Z_{5b}, l, and m each independently have the above meaning for each unit).

6. The developer carrying member according to claim 1, wherein the polyhydroxyalkanoate contains a unit represented by the formula (7): 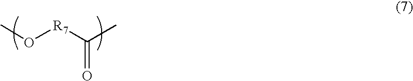
(in the formula, R₇ represents a linear or branched alkylene group having 1 to 11 carbon atoms, an alkyleneoxyalkylene group each alkylene of which has 1 to 2 carbon atoms, or an alkylidene group having 1 to 5 carbon atoms which may be substituted by aryl as desired;
in addition, when multiple units exist, R₇'s each independently have the above meaning for each unit).

7. The developer carrying member according to claim 1, wherein the polyhydroxyalkanoate has a number average molecular weight selected within the range of 1,000 to 1,000,000.

8. A development apparatus for visualizing an image by placing a developer contained in a developer container on a developer carrying member, transporting the developer to a development region facing to a latent image bearing member while forming a thin layer of the developer on the developer carrying member by a developer layer thickness regulating member, and developing the latent image on the latent image bearing member by the developer in the developing region, wherein the developer carrying member comprises at least a substrate and a resin layer formed on the surface of the substrate, and the resin layer employs a binder resin containing a polyhydroxyalkanoate containing, per molecule, at least one unit represented either by the formula (1): 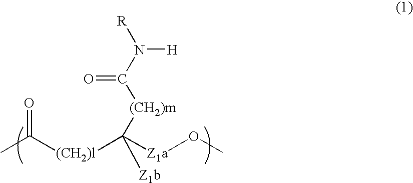
(in the formula:
R represents -A₁-SO₂R₁;
R₁ represents OH, a halogen atom, ONa, OK, or OR₁ₐ; and
R₁ₐ and A₁ each independently represent a group having a substituted or unsubstituted aliphatic hydrocarbon structure, a substituted or unsubstituted aromatic ring structure, or a substituted or unsubstituted heterocyclic structure;
in addition, with regard to l, m, Z₁ₐ, and Z_{1b} in the formula:
when l represents an integer selected from 2 to 4, Z₁ₐ represents nothing or a linear alkylene chain having 1 to 4 carbon atoms, Z_{1b} represents a hydrogen atom, and m represents an integer selected from 0 to 8;
when l represents 1 and Z₁ₐ represents a linear alkylene chain having 1 to 4 carbon atoms, Z_{1b} represents a hydrogen atom and m represents an integer selected from 0 to 8;
when l represents 1 and Z₁ₐ represents nothing, Z_{1b} represents a hydrogen atom and m represents 0;
when l represents 0 and Z₁ₐ represents a linear alkylene chain having 1 to 4 carbon atoms, the linear alkylene chain may be substituted by a linear or branched alkyl group, or an alkyl group containing a residue having any one of a phenyl structure, a thienyl structure, and a cyclohexyl structure at a terminal thereof, Z_{1b} represents a hydrogen atom, or a linear or branched alkyl group, aryl group, or aralkyl group which may be substituted by an aryl group, and m represents an integer selected from 0 to 8; and
when l represents 0 and Z₁ₐ represents nothing, Z_{1b} represents a hydrogen atom, or a linear or branched alkyl group, aryl group, or aralkyl group which may be substituted by an aryl group, and m represents an integer selected from 0 to 8;
in addition, when multiple units exist, R, R₁, R₁ₐ, A₁, Z₁ₐ, Z_{1b}, l, and m each independently have the above meaning for each unit).
or by the formula (5): 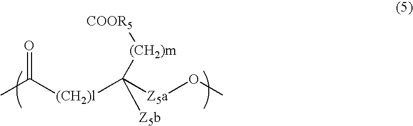
(in the formula, R₅ represents hydrogen, a group for forming a salt, or R₅ₐ, and R₅ₐ represents a linear or branched alkyl group having 1 to 12 carbon atoms, or aralkyl group;
in addition, with regard to l, m, Z₅ₐ, and Z_{5b} in the formula:
when l represents an integer selected from 2 to 4, Z₅ₐ represents nothing or a linear alkylene chain having 1 to 4 carbon atoms, Z_{5b} represents a hydrogen atom, and m represents an integer selected from 0 to 8;
when l represents 1 and Z₅ₐ represents a linear alkylene chain having 1 to 4 carbon atoms, Z_{5b} represents a hydrogen atom and m represents an integer selected from 0 to 8;
when l represents 1 and Z₅ₐ represents nothing, Z_{5b} represents a hydrogen atom and m represents 0;
when l represents 0 and Z₅ₐ represents a linear alkylene chain having 1 to 4 carbon atoms, the linear alkylene chain may be substituted by a linear or branched alkyl group, or an alkyl group containing a residue having any one of a phenyl structure, a thienyl structure, and a cyclohexyl structure at a terminal thereof, Z_{5b} represents a hydrogen atom, or a linear or branched alkyl group, aryl group, or aralkyl group which may be substituted by an aryl group, and m represents an integer selected from 0 to 8; and
when l represents 0 and Z₅ₐ represents nothing, Z_{5b} represents a hydrogen atom, or a linear or branched alkyl group, aryl group, or aralkyl group which may be substituted by an aryl group, and m represents an integer selected from 0 to 8;
in addition, when multiple units exist, R₅, R₅ₐ, Z₅ₐ, Z_{5b}, l, and m each independently have the above meaning for each unit).
